(19) United States
(12) Patent Application Publication
(10) Pub. No.: US 2015/0065682 A1
(43) Pub. Date: Mar. 5, 2015

(54) ALIPHATIC POLYESTERS AND COPOLYESTERS DERIVED FROM NATURAL OILS AND THEIR RELATED PHYSICAL PROPERTIES

(71) Applicant: Elevance Renewable Sciences, Inc., Woodridge, IL (US)

(72) Inventors: Suresh Narine, Peterborough (CA); Laziz Bouzidi, Peterborough (CA); Shaojun Li, Peterborough (CA); Jesmy Jose, Peterborough (CA); Ghazaleh Pourfallah, South Perth (AU)

(21) Appl. No.: 14/473,079

(22) Filed: Aug. 29, 2014

Related U.S. Application Data
(60) Provisional application No. 61/872,594, filed on Aug. 30, 2013.

(51) Int. Cl. C08G 63/06

(52) U.S. Cl. CPC C08G 63/06
USPC 528/361; 554/213

(57) ABSTRACT

The synthesis of certain medium and long chain ω-hydroxy esters and certain ω-hydroxy fatty acids is disclosed. Such ω-hydroxy esters and ω-hydroxy fatty acids are derived from natural oils, and their corresponding polymers were obtained by melt polycondensation. Additionally, the present effort investigates the effects of structural and molecular parameters on the thermal and mechanical properties of ω-hydroxy ester based polymers. Additionally, the present effort investigates the co-polymerization of ω-hydroxy ester based polymers.

### CROSS REFERENCE TO RELATED APPLICATIONS

A claim of priority for this application under 35 U.S.C. §119(e) is hereby made to the following U.S. provisional patent application: U.S. Ser. No. 61/872,594 filed Aug. 30, 2013; and this application is incorporated herein by reference in its entirety.

### FIELD OF THE INVENTION

This application relates to aliphatic polyesters derived from medium and long chain ω-hydroxy fatty acids (ω-OHFA) and their respective methyl esters (Me-ω-OHFA), which arise from the functionalization of natural oils. Such ω-hydroxy fatty acids and their respective methyl esters undergo melt polycondensation to produce aliphatic polyesters.

### BACKGROUND OF THE INVENTION

Growing concerns over the environmental impacts of non-biodegradable plastic waste and the need for sustainability have stimulated research efforts on biodegradable polymers from renewable resources. Rising costs and dwindling petrochemical feedstocks also make renewable resource-based materials attractive alternatives to their petroleum-based counterparts. Many of these efforts have concerned ester containing polymers such as polyesters, polyester amides, and polyester urethanes, where the polar ester groups (—COO—) offer biodegradability through hydrolytic and/or enzymatic degradation, and hydrophobicity through the long aliphatic segments.

Linear aliphatic polyesters of the [—(CH₂)ₙ—COO—]ₓ homologue series, synthesized from lactones or hydroxyl acid/ester monomers derived from renewable carbon sources, have gained considerable attention because of their potential suitability in biomedical applications. The medium chain homologue poly(nonane lactone) derived from natural oils has been shown to exhibit improved thermal properties compared to poly(ε-caprolactone) (PCL) and has been suggested as potential replacement for petroleum derived PCL in drug delivery applications. Most of the earlier reported polyesters in this series, however, are short chain homologues, such as poly (glycolic acid), poly(3-hydroxy propionic acid), poly(4-hydroxy butyrate) etc., which suffer from poor thermal stability, low melting points, and consequently, poor melt processibility.

Long chain polyester homologues have recently attracted significant interest as potential new degradable analogues of linear polyethylene (PE, (—CH₂—)ₙ). Linear PE is one of the best-known commodity polymers, but due to its hydrophobicity and molecular size, is non-biodegradable. PE is used in large volumes for household products and packaging applications because of its adequate mechanical properties and its relatively lower cost compared to engineering polymers. Recent efforts have indicated that the PE-like properties of the long chain polyester homologues, along with biodegradability, present ecological advantages by offering alternative solutions to the PE commodity waste problem.

In some instances, ω-hydroxyl fatty ester monomers derived from triglycerides of natural oils are an inexpensive renewable feedstock which can be used as efficient routes to prepare the long chain homologues of the [—(CH₂)ₙ—COO—]ₓ series. The natural oil triglycerides can be transformed chemically into different long chain w-hydroxy fatty acids by functionalization reactions such as, oxidation, reduction, epoxidation, hydroformylation, metathesis, etc., at the fatty acid double bonds. The various structure—property correlations for P(ω-OHFA)s are discussed in light of the PE-like behavior for [—(CH₂)ₙ—COO—]ₓ aliphatic polyesters homologous series.

Long chain polyester homologues exhibit the orthorhombic crystalline structure reminiscent of linear PE. Recent studies comparing the crystallographic data of linear PE with poly(11-undecalactone) (PUDL, n=10), poly(12-dodecalactone) (PDDL, n=11), poly(15-pentadecalactone) (PPDL, n=14) and poly(16-hexadecalactone) (PHDL, n=15)—all obtained by ring opening polymerization from their corresponding non-renewable lactone monomers—found that the unit cell parameter along the fiber axis (c) increases with n. This was attributed to the molecular chains trying to achieve an all-trans planar zig-zag conformation, similarly to linear PE. Studies on PPDL derived from petroleum and poly(ω-hydroxyl tetradecanoic acid) derived from vegetable oil indicated that the effects of crystallinity and molecular weight on Young's modulus were similar to what was observed for linear PE. The variation of elongation at break with molecular weight was, however, different for the long chain homologues.

There are relatively few studies relating the physical properties to structure and molecular parameters for the long chain polyester homologues of [—(CH₂)ₙ—COO—]ₓ despite their promising prospective applications, particularly in the biomedical sector. This type of knowledge is important to provide a realistic set of optimum attainable performance and trade-offs for these materials. Their use as PE analogues and for other targeted applications such as tissue engineering and drug delivery systems is tributary of a comprehensive understanding of the structure-function relationships as well as interrelationships between various properties.

The present effort details the synthesis of a group of certain medium and long chain ω-hydroxy esters having the general formula [HO—(CH₂)ₙ—COOCH₃], namely methyl-9-hydroxynonanoate, [Me-ω-OHC9, (n=8)], methyl-13-hydroxytridecanoate, [Me-ω-OHC13, (n=12)], and methyl-18-hydroxyoctadecanoate, [Me-ω-OHC18 (n=17)], and certain ω-hydroxy fatty acids having the general formula [HO—(CH₂)ₙ—COOH], namely 9-hydroxynonanoic acid [(ω-OHC9), (n=8)], 13-hydroxytridecanoic acid, [(ω-OHC13), (n=12)], and 18-hydroxyoctadecanoic acid, [(ω-OHC18) (n=17)]. Such ω-hydroxy esters and ω-hydroxy fatty acids are derived from natural oils, and their corresponding polymers were obtained by melt polycondensation. Additionally, the present effort investigates the effects of structural and molecular parameters on the thermal and mechanical properties of ω-hydroxy ester based polymers. Additionally, the present effort investigates the co-polymerization of ω-hydroxy ester based polymers.

### SUMMARY OF THE INVENTION

In one aspect of the invention, a monomer composition comprising ω-hydroxy esters having the formula of HO—(CH₂)ₙ—COOCH₃ is disclosed, wherein n is between 12 and 17. Such ω-hydroxy esters are selected from the group consisting of methyl-13-hydroxytridecanoate, and methyl-18-hydroxyoctadecanoate.

In another aspect of the invention, a monomer composition comprising w-hydroxy fatty acids having the formula of HO—(CH₂)ₙ—COOH is disclosed, wherein n is between 12 and 17. Such ω-hydroxy fatty acids are selected from the group consisting of 13-hydroxytridecanoic acid, and 18-hydroxyoctadecanoic acid.

In another aspect of the invention, a polymer composition derived from monomer units comprising ω-hydroxy esters having the formula of HO—(CH₂)ₙ—COOCH₃ is disclosed, wherein n is between 8 and 17. Such ω-hydroxy esters are selected from the group consisting of methyl-9-hydroxynonanoate methyl-13-hydroxytridecanoate, and methyl-18-hydroxyoctadecanoate.

In another aspect of the invention, a polymer composition derived from monomer units comprising ω-hydroxy fatty acids having the formula of HO—(CH₂)ₙ—COOH is disclosed. Such ω-hydroxy fatty acids are selected from the group consisting of 13-hydroxytridecanoic acid, and 18-hydroxyoctadecanoic acid.

In another aspect of the invention, a copolymer composition derived from monomer units comprising ω-hydroxy esters having the formula of HO—(CH₂)ₙ—COOCH₃, wherein n is between 8 and 12, is disclosed. Such ω-hydroxy esters are selected from the group consisting of methyl 9-hydroxynonanoate and methyl-13-hydroxytridecanoate.

### BRIEF DESCRIPTION OF THE DRAWINGS

FIG. 1 depicts the synthesis of Me-ω-OHC9, Me-ω-OHC13, and ω-OHC13 from methyl oleate, methyl erucate, and erucic acid respectively via ozonolysis (Step 1), hydrogenation (Step 2) and saponification (Step 3).

FIG. 2 depicts the reaction scheme for the synthesis of methyl erucate from erucic acid by Fisher esterification.

FIG. 3 depicts the reaction scheme for the synthesis of Me-ω-OHC18 and ω-OHC18 from methyl oleate and oleyl alcohol using cross metathesis followed by hydrogenation and saponification reactions.

FIG. 4 depicts the reaction scheme for melt polycondensation of P(Me-ω-OHFA)s and P(ω-OHFA)s.

FIG. 5 depicts the FT-IR spectra for ω-OHC18, Me-ω-OHC18, P(ω-OHC18) and P(Me-ω-OHC18).

FIG. 6 depicts the variation of M̅ₙ (Δ, ▴) and PDI (◯, ) for P(Me-ω-OHC18) (open symbols) and P(ω-OHC18) (closed symbols) as a function of catalyst concentration. The linear fits of PDI (R²>0.9035) are shown as dashed lines.

FIG. 7 depicts the variation of M̅ₙ (Δ, ▴) and PDI (◯, ) for P(Me-ω-OHFA)s (open symbols) and P(ω-OHFA)s (filled symbols) as a function of reaction temperature for polycondensation using optimal catalyst content. (a) P(Me-ω-OHC9) and P(ω-OHC9), (b) P(Me-ω-OHC13) and P(ω-OHC13), and (c) P(Me-ω-OHC18) and P(ω-OHC18).

FIG. 8 depicts the variation of M̅ₙ (▴, Δ) and PDI (, ◯) for P(ω-OHC18) (filled symbol) and P(Me-ω-OHC18) (open symbols) with the optimal catalyst amount of 300 ppm as a function of Phase 2 reaction time during polycondensation at 220° C. Linear fits of PDI (R²>9956) are shown as dashed lines.

FIG. 9 depicts the number average degree of polymerization ( X̅ₙ) as a function of t for P(Me-ω-OHC18), (◯), and P(ω-OHC18), (). Dashed lines are linear fits of the data collected at t≦4 h (R²>0.9872).

FIG. 10A depicts the WAXD patterns taken at room temperature for P(Me-ω-OHFA)s.

FIG. 10B depicts the d-spacing as a function of n. (i) n=8: P(Me-ω-OHC9)_{28.4k}, (ii) n=12: P(Me-ω-OHC13)_{30.3k} and (iii) n=17: P(Me-ω-OHC18)_{34.7k}

FIG. 11 depicts the degree of crystallinity, X_{C}(%), as a function of M̅ₙ (Kg/mol) for (i) n=8: P(Me-ω-OHC9)(▪) (ii) n=12: P(Me-ω-OHC13) (▴) and (iii) n=17: P(Me-ω-OHC18) (). The lines are linear fits (R²>0.9025).

FIG. 12 depicts the degree of crystallinity (X_{C}(%), estimated from WAXD)(◯) and enthalpy of melting (ΔHₘ, determined from DSC data)() as a function of n for (i) n=8: P(Me-ω-OHC9)_{28.4k}, n=12: P(Me-ω-OHC13)_{30.3k} and (iii) n=17: P(Me-ω-OHC18)_{34.7k}.

FIG. 13 depicts the DSC melting thermograms of (i) n=8: P(Me-ω-OHCq) (ii) n=12: P(Me-ω-OHC13)_{30.3k} and (iii) n=17: P(Me-ω-OHC18)_{34.7k} obtained with heating rate of 3° C./min.

FIG. 14 depicts the plot of Tₘ (° C.) of aliphatic polyesters [—(CH₂)ₙ—COO—] as a function of n. Half-filled symbols in FIG. 4 indicate Tₘ for n=1 [PGA], n=2 [P3HA], n=3 [P4HB], n=4, poly(δ-valerolactone) [PVL], n=5 [PCL], n=9 [P(ω-OHC10)], n=13 [P(ω-OHC14)], n=14 [PPDL], and n=15[HPDL]. Tₘ for P(Me-ω-OHFA)s are represented by closed circles. The dotted line indicates Tₘ of linear PE (T_{PE}).

FIG. 15 depicts the storage modulus (E′)(◯), loss modulus (E″)(□) and tan δ (Δ) versus temperature curves for P(Me-ω-OHC9)_{28.4k} (n=8).

FIG. 16 depicts the T_{g} (° C.) as a function of X_{C} (%) for P(Me-ω-OHC9) (n=8) (▪), P(Me-ω-OHC13) (n=12)(▴) and P(Me-ω-OHC18) (n=17) (). The lines are linear fits (R²>0.9709).

FIG. 17 depicts the T_{g} (° C.) of aliphatic polyesters [—(CH₂)ₙ—COO—] as a function of n. The half-filled symbols indicated T_{g} values for n=1 [PGA]¹, n=2 [P3HA], n=3 [P4HB], n=4 [PVL], n=5 [PCL], n=8 [P(ω-OHC9)]⁶, n=13 [P(ω-OHC14)]⁷, and n=14 [PPDL]. The closed symbols gave T_{g} for P(Me-ω-OHFA)s with n=8, 12 and 17.

FIG. 18 depicts the DTG traces of (i) n=8: P(Me-ω-OHC9)_{28.4k}, (ii) n=12: P(Me-ω-OHC13)_{30.3k} and (iii) n=17: P(Me-ω-OHC18)_{34.7k} obtained with heating rate of 10° C./min.

FIG. 19 depicts the onset degradation temperature, T_{d(1)} (filled symbols), and degradation temperature at 50% weight loss T_{d(50)} (open symbols) as a function of M̅ₙ for n=8 (□, ▪) (P(Me-ω-OHC9)); n=12 (Δ, ▴) (P(Me-ω-OHC13)) and n=17 (◯, ) (P(Me-ω-OHC18)). The lines are linear fits (R²>9656).

FIG. 20 depicts the maximum degradation temperature T_{d(max)} for aliphatic polyesters [—(CH₂)ₙ—COO—] as a function of 11. Half-filled symbols indicate T_{d(max)} for n=1 [PGA], n=5 [PCL], n=13 [P(ω-OHC13)], n=14 [PPDL] and n=15[HPDL]. Closed symbols indicate P(Me-ω-OHFA)s with n=8, 12 and 17. The broken line is the fit to an exponential rise to a maximum function. The solid line indicates T_{d(max)} of linear PE.

FIG. 21 depicts the stress-strain curves of (i) n=8: P(Me-ω-OHC9)_{28.4k} (ii) n=12: P(Me-ω-OHC13)_{30.3k} and (iii) n=17: P(Me-ω-OHC18)_{34.7k}

FIG. 22 depicts the dependence of YM(MPa) on X_{C}(%) for aliphatic polyesters [—(CH₂)ₙ—COO—] with varying n: n=8 (▪) (P(Me-ω-OHC9)); n=12 (▴) (P(Me-ω-OHC13)); n=13 (⋄) (P(Me-ω-OHC14)); n=14 (∇) (PPDL) and n=17 () (P(Me-ω-OHC18)). Broken lines are fits to an exponential rise to a maximum function for (a) the full data set and (b) data set excluding n=13 (⋄) (P(ω-OHC14)). The solid lines are linear fits of the data obtained for the P(Me-ω-OHFA)s (R²>9901).

FIG. 23 depicts the ultimate tensile strength (TS) (MPa) plotted against M̅ₙ for P(Me-ω-OHC9): ▪, P(Me-ω-OHC13): ▴ and P(Me-ω-OHC18): . The lines are linear fits (R²>0.9167).

FIG. 24 depicts the reaction scheme for co-polymerization of (Me-ω-OHC13) and (Me-ω-OHC9) comonomer units.

FIG. 25A depicts ¹H NMR spectra of P(Me-ω-OHC9).

FIG. 25B depicts ¹H NMR spectra of P(Me-ω-OHC13).

FIG. 25C depicts ¹H NMR spectra of 50/50 w/w P(-Me-ω-OHC13-/-Me-ω-OHC9-) co-polyester.

FIG. 26A depicts a DSC heating thermogram of P(-Me-ω-OHC13-/-Me-ω-OHC9-) copolymers.

FIG. 26B depicts a DSC cooling thermogram of P(-Me-ω-OHC13-/-Me-ω-OHC9-) copolymers.

FIG. 27 depicts the composition dependence of the melting temperature (Tₘ) () and melt crystallization temperature (T_{C})(▴) of P(-Me-ω-OHC13-/-Me-ω-OHC9-)copolymers. The dotted lines are guidelines for the reader.

FIG. 28A depicts a WAXD pattern taken at room temperature for P(-Me-ω-OHC13-/-Me-ω-OHC9-)copolymers.

FIG. 28B depicts changes of d-spacing for P(-Me-ω-OHC13-/-Me-ω-OHC9-)copolymers as a function of Me-ω-OHC9 (mol %).

FIG. 29 depicts the composition dependence of degree of crystallinity (X_{C}(%), estimated from WAXD)(◯) and enthalpy of melting (ΔHₘ, determined from DSC data)() for P(-Me-ω-OHC13-/-Me-ω-OHC9-) co-polyesters.

FIG. 30 depicts DTG traces of the P(Me-ω-OHC9)(A7) and P(Me-ω-OHC13) (A1) homopolymers, and of the P(-Me-ω-OHC13-/-Me-ω-OHC9-) (A2-A6) copolymers obtained with heating rate of 10° C./min.

FIG. 31 depicts composition dependence of the onset (T_{d(5)}) () and the maximum (T_{d(max)}) degradation temperature (▪) for P(-Me-ω-OHC13-/-Me-ω-OHC9-) copolymers.

FIG. 32A the storage modulus for P(Me-ω-OHC13) (A1) and P(-Me-ω-OHC13-/-Me-ω-OHC9-) (A2-A6) co-polyesters.

FIG. 32B depicts) the tan δ versus temperature curves for P(Me-ω-OHC13) (A1) and P(-Me-ω-OHC13-/-Me-ω-OHC9-) (A2-A6) co-polyesters.

FIG. 33 depicts the composition dependence of T_{g} (° C.) for P(-Me-ω-OHC13-/-Me-ω-OHC9-) co-polyesters. The line is a linear fit (R²>0.9298).

FIG. 34 depicts stress-strain curves of (i) P(Me-ω-OHC9)(B1) (ii) P(Me-ω-OHC13)(B7) and (iii) P(-Me-ω-OHC13-/-Me-ω-OHC9-) (B4).

### DETAILED DESCRIPTION OF THE INVENTION

### Synthesis of ω-Hydroxy Esters and ω-Hydroxy Fatty Acids

The synthesis of certain ω-hydroxy esters and ω-hydroxy fatty acids, including those having carbon chain lengths of 3 to 36 carbons, and preferably 9 to 22 carbons, occurs via the functionalization of natural oils. As used herein, the term “natural oil” may refer to oil derived from plants or animal sources. The term “natural oil” includes natural oil derivatives, unless otherwise indicated. Examples of natural oils include, but are not limited to, vegetable oils, algae oils, animal fats, tall oils, derivatives of these oils, combinations of any of these oils, and the like. Representative non-limiting examples of vegetable oils include canola oil, rapeseed oil, coconut oil, corn oil, cottonseed oil, jojoba oil, olive oil, palm oil, peanut oil, safflower oil, sesame oil, soybean oil, sunflower oil, linseed oil, palm kernel oil, tung oil, jatropha oil, mustard oil, camelina oil, pennycress oil, hemp oil, algal oil, and castor oil. Representative non-limiting examples of animal fats include lard, tallow, poultry fat, yellow grease, and fish oil. Tall oils are by-products of wood pulp manufacture. In certain embodiments, the natural oil may be refined, bleached, and/or deodorized. In some embodiments, the natural oil may be partially or fully hydrogenated. In some embodiments, the natural oil is present individually or as mixtures thereof.

Natural oils generally comprise triglycerides of saturated and unsaturated fatty acids. Suitable fatty acids may be saturated or unsaturated (monounsaturated or polyunsaturated) fatty acids, and may have carbon chain lengths of 3 to 36 carbon atoms. Such saturated or unsaturated fatty acids may be aliphatic, aromatic, saturated, unsaturated, straight chain or branched, substituted or unsubstituted, fatty acids, and mono-, di-, tri-, and/or poly-acid variants, hydroxy-substituted variants, aliphatic, cyclic, alicyclic, aromatic, branched, aliphatic- and alicyclic-substituted aromatic, aromatic-substituted aliphatic and alicyclic groups, and heteroatom substituted variants thereof. Any unsaturation may be present at any suitable isomer position along the carbon chain to a person skilled in the art.

Some non-limiting examples of saturated fatty acids include propionic, butyric, valeric, caproic, enanthic, caprylic, pelargonic, capric, undecylic, lauric, tridecylic, myristic, pentadecanoic, palmitic, margaric, stearic, nonadecyclic, arachidic, heneicosylic, behenic, tricosylic, lignoceric, pentacoyslic, cerotic, heptacosylic, carboceric, montanic, nonacosylic, melissic, lacceroic, psyllic, geddic, ceroplastic acids.

Some non-limiting examples of unsaturated fatty acids include butenoic, pentenoic, hexenoic, pentenoic, octenoic, nonenoic acid, decenoic acid, undecenoic acid, dodecenoic acid, tridecenoic, tetradecenoic, pentadecenoic, palmitoleic, palmitelaidic oleic, ricinoleic, vaccenic, linoleic, linolenic, elaidic, eicosapentaenoic, behenic and erucic acids. Some unsaturated fatty acids may be monounsaturated, diunsaturated, tri unsaturated, tetraunsaturated or otherwise polyunsaturated, including any omega unsaturated fatty acids.

In most natural oils, there are a few different reactive sites which offer various functionalities. Typically, these reactive sites are: (i) one or more of the double bonds of an unsaturated fatty acid; (ii) the carboxyl ester group linking the fatty acid to the glycerol; (iii) allylic positions, and (iv) and the α-position of ester groups. Schematically, the reactive sites are shown below:

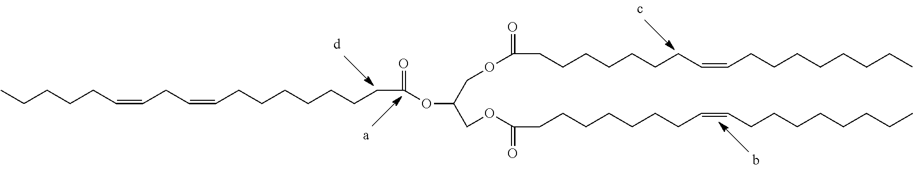 [SMILES: CCCCC/C=C\C/C=C\CCCCCCCC(=O)OC(COC(=O)CCCCCCC/C=C\CCCCCCCC)COC(=O)CCCCCCC/C=C\CCCCCCCC]

Reactive positions in triglycerides: ester groups (a), C═C double bonds (b), allylic positions (c), and the α-positions of ester groups (d).

The natural oils can be transformed chemically into different long chain w-hydroxy fatty acids and ω-hydroxy esters by functionalization reactions, including ozonolysis, hydrogenation, reduction, saponification, and/or metathesis, individually or in combinations thereof.

The term “ozonolysis” as used herein, means a method in which a C═C double bond of a hydrocarbon, more preferably an unsaturated fatty acid or a derivative thereof, such as an unsaturated ester derivative, is oxidatively cleaved as a result of the action of ozone on the molecule to form carbonyl products. In some embodiments, the unsaturated fatty acid to undergo ozonolysis may be butenoic, pentenoic, hexenoic, pentenoic, octenoic, nonenoic acid, decenoic acid, undecenoic acid, dodecenoic acid, tridecenoic, tetradecenoic, pentadecenoic, palmitoleic, palmitelaidic oleic, ricinoleic, vaccenic, linoleic, linolenic, elaidic, eicosapentaenoic, behenic and erucic acids. In some embodiments, the unsaturated ester derivative to undergo ozonolysis may be unsaturated fatty acid methyl esters such as methyl myristoleate, methyl 10-pentadecenoate, methyl palmitoleate, methyl 10-heptadecenoate, methyl elaidate, methyl linoleate, methyl linolenate, methyl oleate, methyl 11-eicosanoate, methyl 11,14-eicosadienoate, methyl 11,14,17-eicosatrienoate, methyl 13,16-docosadienoate, methyl erucate, and methyl nervonate.

The methods, agents and instruments suitable for carrying out the ozonolysis are conventionally known to a personal skilled in the art. Conventionally, ozonolysis is carried out in alcohols as solvents, the reaction mixture further comprising at least 0.5 percent by weight of water, based on the total amount of solvent. Usually, the unsaturated fatty acid or its derivative is present in a concentration of 0.1 to 1 mol/L. The ozonolysis is carried out preferably at temperatures from 0 to 40° C., more preferably at temperatures from 10 to 35° C., and particularly preferably at temperatures from 20 to 30° C. Usually, to produce the ozone, an ozone generator is used which uses technical-grade air or a mixture of carbon dioxide and oxygen as feed gas. The ozone is produced from the oxygen by means of non-luminous electric discharge. In the process, oxygen radicals are formed which form ozone molecules with further oxygen molecules. Using mechanistic terms, ozonolysis involves a [3+2]-cycloaddition of the ozone onto the double bond, which gives a primary ozonide, an unstable intermediate, which decomposes to give an aldehyde and a carbonyl oxide. The latter can either polymerize and/or dimerize to give a 1,2,4,5-tetraoxolane or, in a further cycloaddition, form a secondary ozonide. The secondary ozonide can then be worked-up oxidatively to give a carboxylic acid or reductively to give an aldehyde. The aldehyde can be reduced further as far as the alcohol. In some instances, reduction of ozonolysis products has been carried out with sodium borohydride, zinc/acetic acid solution, triphenylphosphine, dimethyl sulfide, or catalytic hydrogenation in the presence of a Raney nickel catalyst.

Hydrogenation may be conducted according to any known method for hydrogenating double bond-containing compounds. Hydrogenation may be carried out in a batch or in a continuous process and may be partial hydrogenation or complete hydrogenation. In a representative batch process, a vacuum is pulled on the headspace of a stirred reaction vessel and the reaction vessel is charged with the material to be hydrogenated. The material is then heated to a desired temperature. Typically, the temperature ranges from about 40° C. to 350° C., for example, about 50° C. to 300° C. or about 70° C. to 250° C. The desired temperature may vary, for example, with hydrogen gas pressure. Typically, a higher gas pressure will require a lower temperature. In a separate container, the hydrogenation catalyst is weighed into a mixing vessel and is slurried in a small amount of the material to be hydrogenated. When the material to be hydrogenated reaches the desired temperature, the slurry of hydrogenation catalyst is added to the reaction vessel.

Hydrogen gas is then pumped into the reaction vessel to achieve a desired pressure of H₂ gas. Typically, the H₂ gas pressure ranges from about 15 to 3000 psig, for example, about 15 psig to 120 psig. As the gas pressure increases, more specialized high-pressure processing equipment may be required. Under these conditions the hydrogenation reaction begins and the temperature is allowed to increase to the desired hydrogenation temperature (e.g., about 70° C. to 200° C.) where it is maintained by cooling the reaction mass, for example, with cooling coils. When the desired degree of hydrogenation is reached, the reaction mass is cooled to the desired filtration temperature.

In some embodiments, the ozonide product is hydrogenated in the presence of a metal catalyst, typically a transition metal catalyst, for example, nickel, copper, palladium, platinum, molybdenum, iron, ruthenium, osmium, rhodium, or iridium catalyst. Combinations of metals may also be used. Useful catalyst may be heterogeneous or homogeneous. The amount of hydrogenation catalysts is typically selected in view of a number of factors including, for example, the type of hydrogenation catalyst used, the amount of used, the degree of unsaturation in the material to be hydrogenated, the desired rate of hydrogenation, the desired degree of hydrogenation (e.g., as measure by iodine value (IV)), the purity of the reagent, and the H₂ gas pressure.

In some embodiments, the hydrogenation catalyst comprises nickel that has been chemically reduced with hydrogen to an active state (i.e., reduced nickel) provided on a support. In some embodiments, the support comprises porous silica (e.g., kieselguhr, infusorial, diatomaceous, or siliceous earth) or alumina. The catalysts are characterized by a high nickel surface area per gram of nickel. In some embodiments, the particles of supported nickel catalyst are dispersed in a protective medium. In some embodiments, the catalyst is a Raney nickel catalyst.

Saponification generally refers to the hydrolysis of an ester of a natural oil, under basic conditions to form an alcohol and the salt of a carboxylic acid (carboxylates), and the additional provision of an excess of a strong acid, such as dilute hydrochloric acid or dilute sulfuric acid, to the solution if the carboxylic acid of the carboxylic acid salt is desired to be obtained. In some embodiments, the ester may be ω-hydroxy esters such as methyl-9-hydroxynonanoate, methyl-13-hydroxytridecanoate, and methyl-18-hydroxyoctadecanoate, and the carboxylic acid may be ω-hydroxy fatty acids, such as 9-hydroxynonanoic acid, 13-hydroxytridecanoic acid, and 18-hydroxyoctadecanoic acid. In some embodiments, saponification of a natural oil includes a hydrolysis reaction of the esters in the natural oil with a metal alkoxide, metal oxide, metal hydroxide or metal carbonate, preferably a metal hydroxide to form salts of the fatty acids (soaps) and free glycerol. Non-limiting examples of metals include alkaline earth metals, alkali metals, transition metals, and lanthanoid metals, individually or in combinations thereof. Any number of known metal hydroxide compositions may be used in this saponification reaction. In certain embodiments, the hydroxide is an alkali metal hydroxide. In one embodiment, the metal hydroxide is sodium hydroxide.

In some embodiments, a metathesis step, particularly a cross-metathesis step, may be used to generate certain ω-hydroxy esters, via cross-metathesis of an unsaturated fatty acid methyl ester and an unsaturated fatty alcohol. Such unsaturated fatty acid methyl esters may have between 6 and 24 carbon atoms, and include methyl myristoleate, methyl 10-pentadecenoate, methyl palmitoleate, methyl 10-heptadecenoate, methyl elaidate, methyl linoleate, methyl linolenate, methyl oleate, methyl 11-eicosanoate, methyl 11,14-eicosadienoate, methyl 11,14,17-eicosatrienoate, methyl 13,16-docosadienoate, methyl erucate, and methyl nervonate. Such unsaturated fatty alcohols may have between 8 and 24 carbon atoms, and may include oleyl, vaccenyl, linoleyl, linolenyl, palmitoleyl, and erucyl alcohols, as well as mixtures of any of the foregoing unsaturated fatty alcohols. In some embodiments, the fatty alcohol is oleyl alcohol or erucyl alcohol, and the unsaturated fatty acid methyl ester is methyl oleate or methyl erucate.

Metathesis is a catalytic reaction that involves the interchange of alkylidene units among compounds containing one or more double bonds (i.e., olefinic compounds) via the formation and cleavage of the carbon-carbon double bonds. The metathesis catalyst in this reaction may include any catalyst or catalyst system that catalyzes a metathesis reaction. Generally, cross metathesis may be represented schematically as shown in Equation A:

R¹—CH═CH—R²+R³—CH═CH—R⁴⇄ R¹—CH═CH—R³+R¹—CH═CH—R⁴+R²—CH═CH—R³+R²—CH═CH—R⁴+R¹—CH═CH—R¹+R²—CH═CH—R²+R³—CH═CH—R³+R⁴—CH═CH—R⁴ (A)
wherein R¹, R², R³, and R⁴ are organic groups.

Suitable homogeneous metathesis catalysts include combinations of a transition metal halide or oxo-halide (e.g., WOCl₄ or WCl₆) with an alkylating cocatalyst (e.g., Me₄Sn). Preferred homogeneous catalysts are well-defined alkylidene (or carbene) complexes of transition metals, particularly Ru, Mo, or W. These include first and second-generation Grubbs catalysts, Grubbs-Hoveyda catalysts, and the like. Suitable alkylidene catalysts have the general structure:

M[X¹X²L¹L²(L³)ₙ]=Cₘ═C(R¹)R²

where M is a Group 8 transition metal, L¹, L², and L³ are neutral electron donor ligands, n is 0 (such that L³ may not be present) or 1, m is 0, 1, or 2, X¹ and X² are anionic ligands, and R¹ and R² are independently selected from H, hydrocarbyl, substituted hydrocarbyl, heteroatom-containing hydrocarbyl, substituted heteroatom-containing hydrocarbyl, and functional groups. Any two or more of X¹, X², L¹, L², L³, R¹ and R² can form a cyclic group and any one of those groups can be attached to a support.

First-generation Grubbs catalysts fall into this category where m=n=0 and particular selections are made for n, X¹, X², L¹, L², L³, R¹ and R² as described in U.S. Pat. Appl. Publ. No. 2010/0145086 (“the '086 publication”), the teachings of which related to all metathesis catalysts are incorporated herein by reference. Second-generation Grubbs catalysts also have the general formula described above, but L¹ is a carbene ligand where the carbene carbon is flanked by N, O, S, or P atoms, preferably by two N atoms. Usually, the carbene ligand is part of a cyclic group. Examples of suitable second-generation Grubbs catalysts also appear in the '086 publication.

In another class of suitable alkylidene catalysts, L¹ is a strongly coordinating neutral electron donor as in first- and second-generation Grubbs catalysts, and L² and L³ are weakly coordinating neutral electron donor ligands in the form of optionally substituted heterocyclic groups. Thus, L² and L³ are pyridine, pyrimidine, pyrrole, quinoline, thiophene, or the like. In yet another class of suitable alkylidene catalysts, a pair of substituents is used to form a bi- or tridentate ligand, such as a biphosphine, dialkoxide, or alkyldiketonate. Grubbs-Hoveyda catalysts are a subset of this type of catalyst in which L² and R² are linked. Typically, a neutral oxygen or nitrogen coordinates to the metal while also being bonded to a carbon that is α-, δ-, or γ- with respect to the carbene carbon to provide the bidentate ligand. Examples of suitable Grubbs-Hoveyda catalysts appear in the '086 publication.

The structures below provide just a few illustrations of suitable catalysts that may be used:

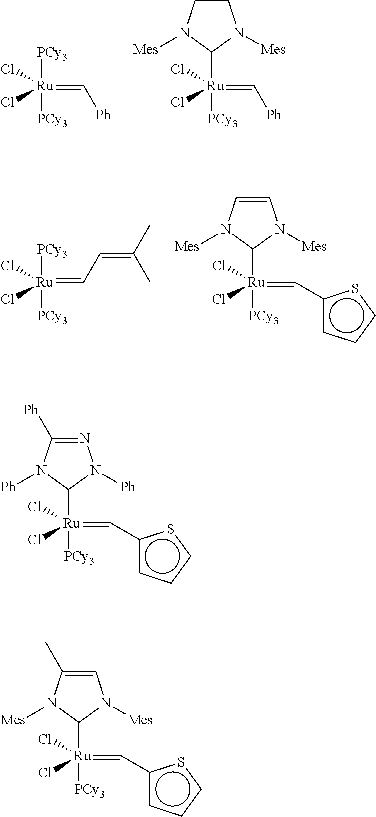

Heterogeneous catalysts suitable for use in the self- or cross-metathesis reaction include certain rhenium and molybdenum compounds as described, e.g., by J.C. Mol in Green Chem. 4 (2002) 5 at pp. 11-12. Particular examples are catalyst systems that include Re₂O₇ on alumina promoted by an alkylating cocatalyst such as a tetraalkyl tin lead, germanium, or silicon compound. Others include MoCl₃ or MoCl₅ on silica activated by tetraalkyltins. For additional examples of suitable catalysts for self- or cross-metathesis, see U.S. Pat. No. 4,545,941, the teachings of which are incorporated herein by reference, and references cited therein. See also J. Org. Chem. 46 (1981) 1821; J. Catal. 30 (1973) 118; Appl. Catal. 70 (1991) 295; Organometallics 13 (1994) 635; Olefin Metathesis and Metathesis Polymerization by Ivin and Mol (1997), and Chem. & Eng. News 80(51), Dec. 23, 2002, p. 29, which also disclose useful metathesis catalysts. Illustrative examples of suitable catalysts include ruthenium and osmium carbene catalysts as disclosed in U.S. Pat. Nos. 5,312,940, 5,342,909, 5,710,298, 5,728,785, 5,728,917, 5,750,815, 5,831,108, 5,922,863, 6,306,988, 6,414,097, 6,696,597, 6,794,534, 7,102,047, 7,378,528, and U.S. Pat. Appl. Publ. No. 2009/0264672 A1, and PCT/US2008/009635, pp. 18-47, all of which are incorporated herein by reference. A number of metathesis catalysts that may be advantageously employed in metathesis reactions are manufactured and sold by Materia, Inc. (Pasadena, Calif.).

### General Materials:

Erucic acid (90% purity), methyl oleate (70% purity), oleyl alcohol (85% purity), Raney nickel 2800 (slurry in water), sodium sulfate (anhydrous) (Na₂SO₄), Ti(IV) isopropoxide (Ti(OiPr)₄) (99.99% purity), 1-butanol (99.98% purity) sodium hydroxide, Grubbs 2^{nd} generation catalyst and filter agent Celite®545 were purchased from Sigma-Aldrich. The reagents were used without further purification. Ozone was generated from an Azcozon Model RMU-DG3 ozone generator (AZCO Industries Limited, Canada) connected to a PSA Model Topaz oxygen generator (AirSep® Corporation). Molecular sieve type 3A was purchased from Fisher. Silica gel (230-400 mesh) and TLC plates (60 Å) were obtained from SiliCycle Inc., QC, Canada.

### Listing of Synthesized Chemical Structures:

The chemical structures of (ω-OHFA)s and (Me-ω-OHFA)s prepared are listed in Table 1.

TABLE 1
Chemical structures of omega-hydroxy fatty acid/esters
and poly(omega-hydroxy fatty acid/esters).

| | Chemical | | | |
|---|---|---|---|---|
| Chemical name | formula | Acronym | Chemical structure | n |
| 9-hydroxynonanoic | C₁₀H₂₀O₃ | ω-OHC9 | HO—(CH₂)ₙ—COOH | 8 |
| acid | | | | |
| methyl 9- | C₁₁H₂₂O₃ | Me-ω- | HO—(CH₂)ₙ— | 8 |
| hydroxynonanoate | | OHC9 | COOCH₃ | |
| 13-hydroxytri- | C₁₃H₂₆O₃ | ω-OHC13 | HO—(CH₂)ₙ—COOH | 12 |
| decanoic acid | | | | |
| methyl-13-hy- | C₁₄H₂₈O₃ | Me-ω- | HO—(CH₂)ₙ— | 12 |
| droxytridecanoate | | OHC13 | COOCH₃ | |
| 18-hydroxyocta- | C₁₈H₃₆O₃ | ω-OHC18 | HO—(CH₂)ₙ—COOH | 17 |
| decanoic acid | | | | |
| methyl 18-hy- | C₁₉H₃₈O₃ | Me-ω- | HO—(CH₂)ₙ— | 17 |
| droxyoctadecanoate | | OHC18 | COOCH₃ | |

### Synthesis of (Me-ω-OHC9) and (Me-ω-OHC13) and their Hydroxyl Fatty Acids

The preparation of (Me-ω-OHC9) and (Me-ω-OHC13) monomers from methyl fatty acids included two steps, namely, ozonolysis and hydrogenation. Methyl erucate, the reactant for Me-ω-OHC13 was prepared initially from erucic acid as discussed below.

### Synthesis of Methyl Erucate from Erucic Acid

Erucic acid (50 g, 0.14 mol.) was dissolved in 350 mL dry methanol in a three neck 1 L round bottomed flask. 10 mL of hydrochloric acid (37%) was added to catalyze the reaction. In order to absorb the water produced from the reaction; molecular sieve type 3A (10 g) was also added to the flask. The entire reaction was kept under reflux at 65° C. and stirred for 4 h. Thin layer chromatography (TLC) was used to monitor the progress of the reaction until the starting material was depleted. The reaction was then cooled down to room temperature, and quenched by adding 350 mL distilled water. The resulting mixture was extracted by 2×200 mL of ethyl acetate. Afterward, the ethyl acetate phase was washed by brine and dried over Na₂SO₄. The crude products were collected by removing the solvent under pressure. The desired product was purified by column chromatography hexane/ethyl acetate eluting solvent (30:1).

### Ozonolysis:

Methyl fatty acid (0.1 mol.) was dissolved in 200 mL of anhydrous ethyl alcohol in a three neck flask equipped with a magnetic stirrer, inlet for ozone and outlet for gas. The reaction setup was placed in an ice-salt bath and the temperature was maintained at −5° C. Ozone (62.0 g/m³) was then bubbled into the reaction mixture with a flow rate of 5 L/min. The reaction conditions were maintained at controlled temperature of <5° C. The reaction was monitored by TLC until the starting material was completely reacted, which takes about 35 to 40 min. The ozone generator was then shut off and the flask was purged with nitrogen for 10 min to remove any ozone residues in the reactor vessel.

### Reduction of the Ozonide Product:

The ozonide product was diluted with 200 mL of anhydrous ethyl alcohol and transferred into a hydrogenation vessel (600 mL, Parr Instrument Co.) equipped with a mechanical stirrer. Raney nickel (5.0 g, slurry in water) was added into the hydrogenation vessel. The reaction vessel was purged with nitrogen gas, and then charged with hydrogen to 100 psi. The temperature was raised to 70° C. After 4 h, heat was shut off and the reaction vessel was allowed to cool down to room temperature. The reaction vessel was finally purged with nitrogen gas to remove any residues of hydrogen. The resulting mixture was filtered through filter agent Celite®545 in a Buchner funnel. The filtrate was then transferred to a flask, and solvent was removed by rotary evaporation. The pure (Me-ω-OHC9) and (Me-ω-OHC13) products were obtained by column chromatography using ethyl acetate/hexane eluting mixture at 1:6 and 1:8 ratios, respectively.

### Saponification:

In order to synthesize (ω-OHC9) and (ω-OHC13), the obtained (Me-ω-OHC9) and (Me-ω-OHC13) were saponified using 100 mL of sodium hydroxide solution (8%). The reaction was performed under reflux at 80° C. for 3 h. The resulting mixture was then cooled down to room temperature and washed by ether (3×100 mL). The aqueous layer was cooled down to 0° C., and then acidified by 8 mL concentrated HCl (36.5%). The acidified mixture was then extracted with ether (4×250 mL). The ether layers were combined and washed by brine (3×100 mL). The solution was then dried over magnesium sulfate and concentrated by rotary evaporation.

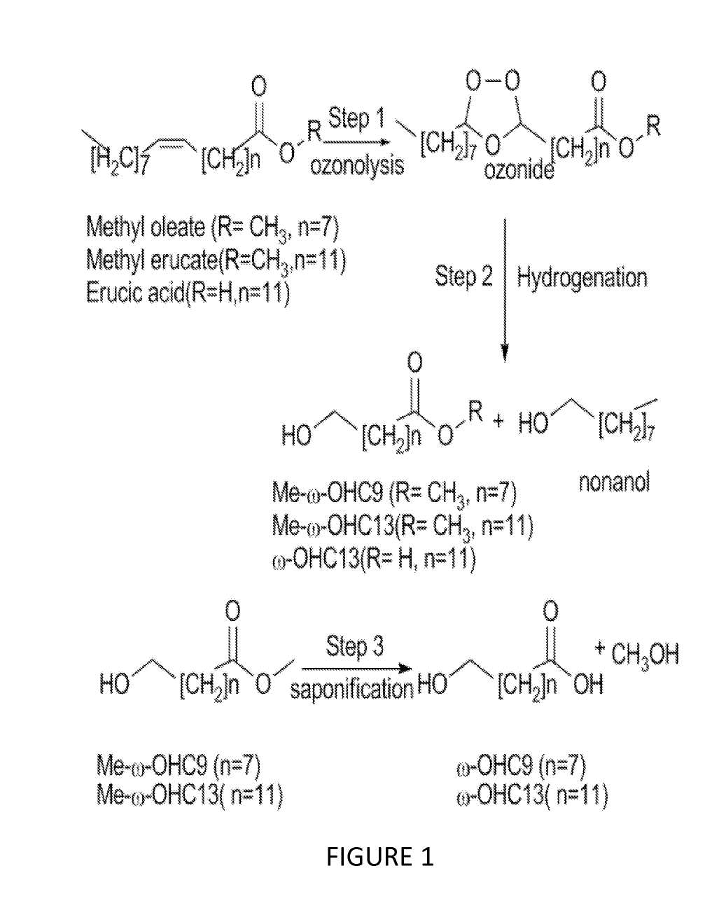

FIG. 1 below shows the reaction scheme for ozonolysis and hydrogenation of methyl oleate. In the first step, the cyclo-addition reaction of ozone to the double bond, yielded a stable ozonide. In Step 2, hydrogenation using Raney Ni gave Me-ω-OHC9 and nonanol. ω-OHC9 was obtained from Me-ω-OHC9 by saponification (Step 3 in FIG. 1), a well-established reaction for lipid-based compounds.

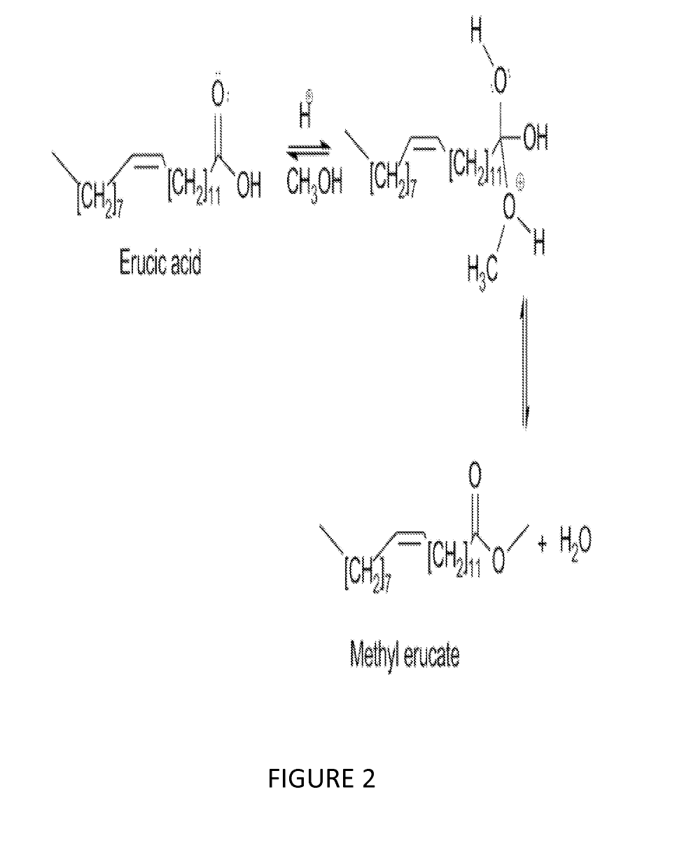

Me-ω-OHC13 was also synthesized by the same ozonolysis-reduction route discussed in FIG. 1, starting from methyl erucate. Methyl erucate was initially prepared from erucic acid by Fisher esterification using methanol and hydrochloric acid catalyst. FIG. 2 shows the reaction scheme for the synthesis of Me-ω-OHC13 from erucic acid. The carboxy carbon of erucic acid, in the presence of an acid catalyst and methanol, undergoes nucleophilic acyl substitution via a tetrahedral intermediate having two equivalent hydroxyl groups to give methyl erucate in high yields (94%). ω-OHC13 was prepared from Me-ω-OHC13 by saponification reaction (FIG. 1).

### Synthesis of (Me-ω-OHC18) and (ω-OHC18)

Me-ω-OHC18 was prepared by the cross metathesis of oleyl alcohol and methyl oleate followed by hydrogenation. ω-OHC18 was prepared from (Me-ω-OHC18) by saponification using 100 mL of sodium hydroxide solution (8%) as described in the same procedures as described above.

### Cross Metathesis Reaction:

Methyl oleate (30.0 g, 0.1 mol.) and oleyl alcohol (30.0 g, 0.1 mol.) were transferred into a 500 mL three-necked round-bottomed flask equipped with a magnetic stirrer. The reaction mixture was stirred at 45° C. under nitrogen gas for 30 min. Grubbs catalyst, second generation (100 mg), was then added to the reaction mixture. After 24 h, it was quenched with ethyl vinyl ether (10 mL) and excess ether was removed by rotary evaporation. The resulting mixture was then purified and Me-ω-OHC18 the desired product was obtained from other by-products. Column chromatography was used for purification of unsaturated Me-ω-OHC18 using hexane/ethyl acetate=10:1.

### Hydrogenation:

The purified product from the metathesis reaction was then reduced over Raney nickel 2800 (slurry in water). The mixture was added into the hydrogenation vessel with 5 g Raney nickel and 200 ml excess ethanol. First, the reaction vessel was purged with nitrogen gas and then charged with hydrogen at 100 psi and 85° C. for 4 h. The reaction mixture was filtered using filter agent Celite®545 in a Buchner funnel. The product was then concentrated under pressure.

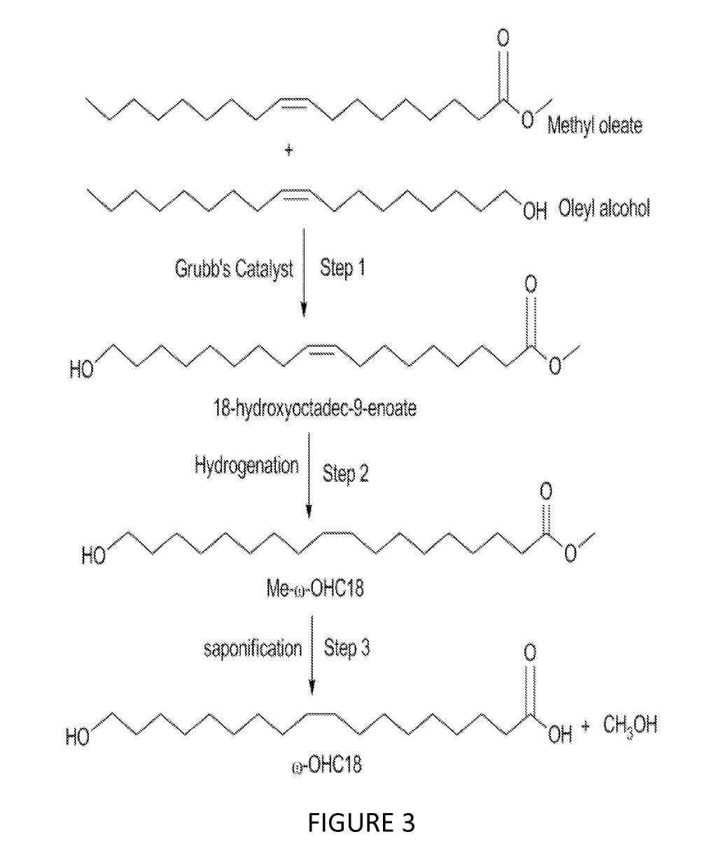

The synthesis of Me-ω-OHC18 is shown in the reaction scheme of FIG. 3. Me-ω-OHC18 was prepared from methyl oleate and oleyl alcohol by cross metathesis using 2^{nd} generation Grubbs catalyst, as shown in FIG. 3. The 2^{nd} generation Grubbs catalyst consists of N-heterocyclic carbene (NHC) ligands which are large electron donating compounds and its general formula is (NHC)(PCy3)(Cl)2Ru═CHPh (Cy: cyclohexyl and Ph: phenyl). The reaction proceeds via the formation of cyclic intermediates between the catalyst metal ion and methyl oleate as well as oleyl alcohol to give unsaturated Me-ω-OHC18 (yield: 40%) along with other products (Step 1). The purity of unsaturated Me-ω-OHC18 after separation by column chromatography was determined by HPLC to be approximately 99%. Although the metathesis is a low yield reaction for the production of Me-ω-OHC18, the subsequent hydrogenation of unsaturated Me-ω-OHC18 using Raney Nickel (Step 2) yielded Me-ω-OHC18 in high yields (88%). ω-OHC18 was prepared by saponification reaction on Me-ω-OHC18 (Step 3).

The structure of (ω-OHFA)s and (Me-ω-OHFA)s were confirmed by ¹H NMR and mass spectroscopy, and is given in Table 2 along with their respective yield and purity values, determined by HPLC.

TABLE 2
Characteristic structural parameters of (ω-OHFA)s and (Me-ω-OHFA)s.
Yield and purity by HPLC, chemical shift values obtained by ¹H NMR,
and molecular mass obtained by mass spectroscopy (ESI-MS).

| | Yield | Purity | | |
|---|---|---|---|---|
| | (%) | (%) | ¹H-NMR | ESI-MS |
| Me-ω-OHC9 | 84 | 97 | (CDCl₃, 400 MHz) δ (ppm): 3.64 (s, 3H, —OCH₃), | C₁₀H₂₀O₃, cal. |
| | | | 3.63-3.9 (t, 2H, —CH₂OH), 2.30-2.25 (t, | 188.2, found |
| | | | 2H, —CH₂COO), 1.61-1.55 (m, 2H, —CH₂CH₂OH), | (m/z) 206.2 |
| | | | 1.56-1.50 (m, 2H, —CH₂CH₂COO), 1.29-1.27 | ([M + NH₄]⁺) |
| | | | (m, 8H, —CH₂—). | |
| ω-OHC9 | 78 | 97 | (CDCl₃ 400 MHz) δ (ppm): 3.64-3.60 (t, 2H, —CH₂OH), | C₉H₁₈O₃, cal. |
| | | | 2.35-2.31 (t, 2H, —CH₂COOH), 1.65-1.55 (m, | 174.2, found |
| | | | 4H, —CH₂CH₂COOH + —CH₂CH₂OH), | (m/z) 192.2 |
| | | | 1.35 (m, 8H, —CH₂—). | ([M + NH₄]⁺) |
| Me-ω-OHC13 | 82 | 98 | (CDCl₃, 400 MHz) δ (ppm): 3.64 (s, 3H, —OCH₃), | C₁₄H₂₈O₃, cal. |
| | | | 3.63-3.61 (t, 2H, —CH₂OH), 2.32-2.35 (t, | 244.2, found |
| | | | 2H, —CH₂COOH), 1.63-1.58 (m, 2H, —CH₂CH₂COO), | (m/z) 262.2 |
| | | | 1.56-1.53 (m, 2H, —CH₂CH₂OH) 1.22-1.25 | ([M + NH₄]⁺) |
| | | | (m, 16H, —CH₂—). | |
| ω-OHC13 | 81 | 97 | (CDCl₃, 400 MHz) δ (ppm): 3.63-3.61 (t, 2H, —CH₂OH), | C₁₃H₂₆O₃, cal. |
| | | | 2.32-2.35 (t, 2H, —CH₂COO), 1.63-1.58 (m, | 230.3, found |
| | | | 2H, —CH₂CH₂COO), 1.56-1.53 (m, 2H, —CH₂CH₂OH), | (m/z) 248.2 |
| | | | 1.22-1.25 (m, 16H, —CH₂—). | ([M + NH₄]⁺) |
| Me-ω-OHC18 | 88 | 99 | (CDCl₃, 400 MHz) δ (ppm): 3.64 (s, 3H, —OCH₃), | C₁₉H₃₈O₃, cal. |
| | | | 3.62-3.59 (t, 2H, —CH₂OH), 2.30-2.26 (t, | 314.4, found |
| | | | 2H, —CH₂COO), 1.56 (m, 2H, —CH₂CH₂COO), | (m/z): 332.4 |
| | | | 1.25-1.23 (m, 26H, —CH₂—) | ([M + NH₄]⁺) |
| ω-OHC18 | 80 | 97 | (CDCl₃, 400 MHz) δ (ppm): 3.61-3.64 (t, 2H —CH₂OH) | C₁₈H₃₆O₃, cal. |
| | | | 2.31-2.35 (t, 2H, —CH₂COO), 1.58 (m, | 300.4, found |
| | | | 2H, —CH₂CH₂COO), 1.55-1.53 (m, 2H, —CH₂CH₂OH), | (m/z): 318.3 |
| | | | 1.25-1.23 (m, 26H, —CH₂—). | ([M + NH₄]⁺) |

### Polymerization of P(ω-OHFA)s and P(Me-ω-OHFA)s

The polymerization process to make P(Me-ω-OHFA)s and P(ω-OHFA)s is an equilibrium reaction and involved two phases; an esterification/transesterification phase (Phase 1) followed by the polycondensation phase (Phase 2). Polycondensation is a step-growth polymerization process, which involves a series of chemical reactions between bi-functional or multifunctional monomers to give polymeric condensates accompanied by the elimination of low molecular weight by-products (water, alcohol, etc.). This is an equilibrium reaction and required to push the reaction forward to obtain high molecular weights. This is achieved by using polycondensation catalysts, high temperatures (more than 200° C.) and high vacuum (below 0.1 mm of Hg). Catalysts are often used to obtain high molecular weight polyesters during polyesterification.

Zinc acetate and manganese acetate are some examples for esterification/transesterification catalysts used for the first polymerization phase. Titanium, antimony and tin-based compounds are the most reported catalysts used for the polycondensation (Phase 2), and at times, germanium has also be reported as a polycondensation catalyst, or combinations of the preceding. The order of the activities of various metallic catalyst was found to vary as Ti>Sn>Sb>Mn>Pb. The high catalytic activity, least environmental concerns and their acceptable prices for low-cost industrial processes favored the widespread use of Ti derived catalysts for polycondensation. Some non-limiting examples of catalysts used for polycondensation reactions include antimony trioxide, antimony triacetate, germanium oxide, tetrapropyl titanate, tetrabutyl titanate, tetrapropyl titanate, titanium butoxide, tetraisopropyl titanate, dibutyltin oxide or n-butyl hydroxytin oxide, all of which may be used alone or in combination. In some embodiments, titanium alkoxides such as titanium isopropoxide, may be used as the polycondensation catalyst.

Polymerization was conducted in a stainless steel reactor equipped with a mechanical stirrer, nitrogen inlet, gas outlet, a thermocouple and pressure gauge. The monomer (10 g) and a certain amount of catalyst solution (10 mg/mL Ti(OiPr)₄ in 1-butanol) was transferred into the reactor. In the first polymerization phase (esterification/transesterification), the reaction mixture was initially heated at 150° C. for three hours with continuous stirring under N₂ flow at atmospheric pressure. The temperature was subsequently raised and maintained at 180° C. for 2 hours, followed by another 2 hours at 200° C. under the same reaction conditions. Except for Me-ω-OHC9, because of its low thermal stability (˜130° C., as determined by thermogravimetric analysis), the reaction was initiated at 120° C. for an hour before applying elevated temperature cycles. In the second phase (polycondensation), traces of water/methanol were removed from the reaction medium to ensure high molecular weight products. This was achieved by (i) raising the temperature to 220° C. and maintaining it for 4 hours, (ii) placing the contents of the reactor under reduced pressure (<0.1 torr), (iii) increasing the speed of mixing. The polycondensation was further continued for another two hours at 220° C. under vacuum. Samples were measured in duplicates at regular intervals using GPC to determine the molecular weight and distribution.

To determine the optimal catalyst contents for P(ω-OHFA)s and P(Me-ω-OHFA)s, a series of polycondensation reactions were performed using varying catalyst amounts (50-500 ppm) and the evolution of molecular weight were analyzed using GPC. Polycondensation reactions were performed in duplicates for the optimal catalyst concentrations so as to determine the reproducibility of the experiments.

Optimization of the reaction time for polycondensation was carried out by increasing the phase 2 reaction time up to 6 hours at 220° C., for each individual catalyst concentration ranging from 50-500 ppm. The polyester molecular weight and distribution was measured every hour by GPC.

To optimize the reaction temperature, the phase 2 reaction temperature was increased from 220° C. to 230° C., 240° C. and 250° C. at regular intervals of 1 h during polymerization using optimal catalyst amounts. The evolution of polyester molecular weight and distribution was measured using GPC.

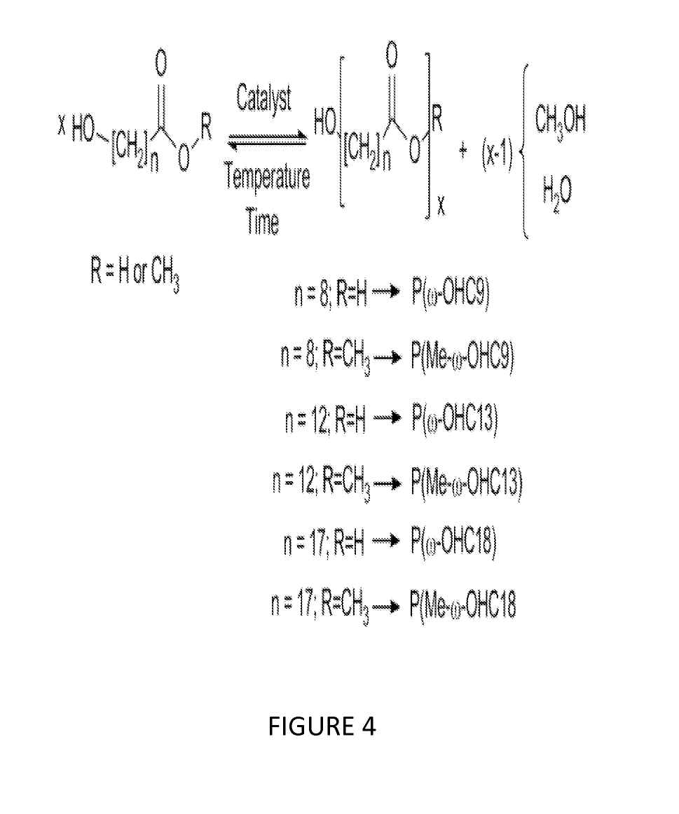

The general reaction scheme for the step-growth polymerization of P(Me-ω-OHFA)s and P(ω-OHFA)s is shown in FIG. 4. Polycondensation of P(Me-ω-OHFA)s and P(ω-OHFA)s is an equilibrium reaction and involved two phases; an esterification/transesterification phase (Phase 1) followed by the polycondensation phase (Phase 2). The first phase, so-called pre-polymerization, proceeds through the formation of dimers, trimers, tetramers etc., by either esterification (in the case of ω-OHFAs) or transesterification (in the case of Me-ω-OHFAs) reaction between the monomers. Most of the water/methanol by-products were eliminated in the first stage. The polycondensation proceeded in the presence of Ti(OiPr)₄ metal-alkoxide acid catalyst at high temperature (more than 200° C.) under vacuum (below 0.1 mm of Hg) so as to obtain high molecular weight polyesters by removing the final traces of the condensation by-products.

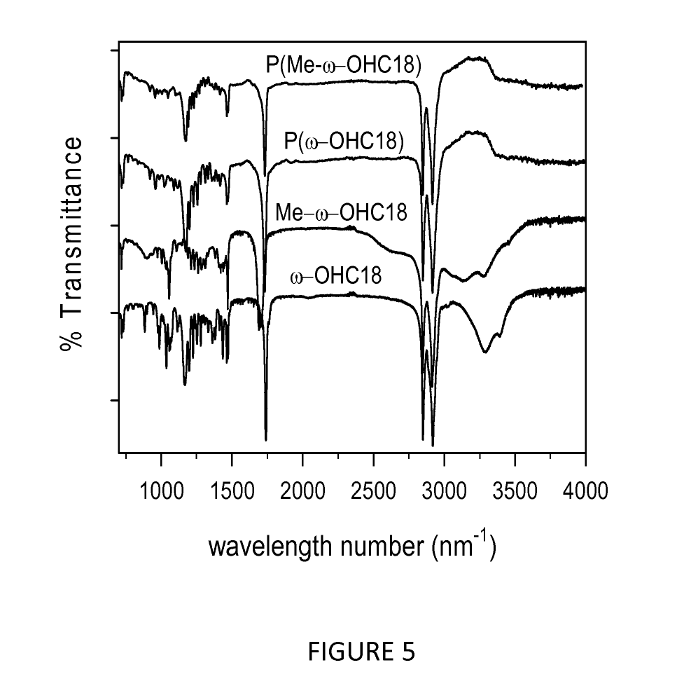

The structures of P(ω-OHFA)s and P(Me-ω-OHFA)s were analyzed by ¹H NMR and FT-IR. ¹H NMR (CDCl₃ 400 MHz) data of the P(ω-OHFA) and P(Me-ω-OHFA) are listed in Table 3. FIG. 5 shows the FT-IR spectra of ω-OHC18, Me-ω-OHC18, P(ω-OHC18) and P(Me-ω-OHC18).

TABLE 3
¹H NMR (CDCl₃ 400 MHz) data of the P(ω-OHFA)
and P(Me-ω-OHFA).

| | ¹H NMR (CDCl₃ 400 MHz) δ (ppm) |
|---|---|
| P(ω-OHC9) and | 1.20-1.34 (m, 10H, —CH₂—), 1.6-1.64 |
| P(Me-ω-OHC9) | (m, 2H, —CH₂CH₂COO—), 2.28-2.36 (t, |
| | 2H, —CH₂COO—), 4.06-4.09 (t, 2H, —CH₂O—) |
| P(ω-OHC13) and | 1.29-1.31 (m, 18H, —CH₂—), 1.6-1.66 |
| P(Me-ω-OHC13) | (m, 2H, —CH₂CH₂COO—), 2.29-2.33 (t, |
| | 2H, —CH₂COO—), 4.06-4.09 (t, 2H, —CH₂O—) |
| P(ω-OHC18) and | 1.28-1.33 (m, 28H, —CH₂—), 1.59-1.66 |
| P(Me-ω-OHC18) | (m, 2H, —CH₂CH₂COO—), 2.29-2.36 (t, |
| | 2H, —CH₂COO—), 4.06-4.10 (t, 2H, —CH₂O—) |

The chemical shift at 6=4.06-4.10 ppm for P(ω-OHFA)s and P(Me-ω-OHFA)s was assigned to the protons from the methylene group attached to the ester linkage (—CH₂O—) formed as a result of polymerization. The absence of chemical shift at δ=3.50-3.70 ppm, corresponding to the protons from methylene group adjacent to the hydroxyl group in (ω-OHFA) and (Me-ω-OHFA)s monomers, suggests that the polymerization was carried out well. FT-IR, also confirmed the formation of the polyesters. As can be seen in FIG. 5, the characteristic absorption peak of the hydroxyl group at 3300 to 3500 cm⁻¹ and 1050 cm⁻¹ and the peak at 1700 cm⁻¹ related to the carboxylic acid group are clearly shown in the IR spectra of the monomers, but are absent in the FTIR of the polymers. Furthermore, the strong ester characteristic absorption peak at 1730 cm⁻¹ and 1170 cm⁻¹ are presented.

### Characterization Techniques of P(Me-ω-OHFA)s and P(ω-OHFA)s:

### Nuclear Magnetic Resonance:

The ¹H-NMR spectra were recorded on a Bruker Advance III 400 spectrometer (Bruker BioSpin MRI GmbH, Karlsruhe, Germany) at a frequency of 400 MHz, using a 5 mm BBO probe, and were acquired at 25° C. over a 16-ppm spectral window with a 1 s recycle delay, and 32 transients. NMR spectra were Fourier transformed, phase corrected, and baseline corrected. Window functions were not applied prior to Fourier transformation. Chemical shifts were referenced relative to residual solvent peaks.

### Fourier Transform Infrared Spectroscopy (FT-IR):

FTIR spectra were acquired using a Thermo Scientific Nicolet 380 FTIR spectrometer (Thermo Electron Scientific Instruments LLC, Fitchburg, Wis.) fitted with a PIKE MIRacle™ attenuated total reflectance (ATR) system (PIKE Technologies, Madison, Wis., USA). The samples were placed onto the ATR crystal area and held in place by a pressure arm. The signal was acquired with the following parameters: scanning number=32; resolution=4.000; sample gain=8.0; mirror velocity=0.6329; and aperture=100.

### Mass Spectrometry:

Electrospray ionization mass spectrometry (ESI-MS) analysis was performed on the monomers using a QStar XL quadrupole time-of-flight mass spectrometer (AB Sciex, Concord, ON) equipped with an ion-spray source and a modified hot source-induced de-solvation (HSID) interface (Ionics, Bolton, ON). The ion source and interface conditions were adjusted as follows: ion spray voltage (IS=4500 V), nebulizing gas (GS1=45), curtain gas (GS2=45), de-clustering potential (DP=60 V) and HSID temperature (T=200° C.). Multiple-charged ion signals were reconstructed using the BioTools 1.1.5 software package (AB Sciex, Concord, ON).

### High Performance Liquid Chromatography:

The purity of (ω-OHFA)s and (Me-ω-OHFA)s were determined using High Performance Liquid Chromatography (HPLC). HPLC was carried on a Waters Alliance (Milford, Mass., USA) e2695 HPLC system fitted with a Waters ELSD 2424 evaporative light scattering detector. The HPLC system includes an inline degasser, a pump, and an auto-sampler. The temperature of the column (C18, 150 mm×4.6 mm, 5.0 μm, X-Bridge column, Waters Corporation, MA, USA) was maintained at 35° C. by a Waters Alliance column oven. The ELSD nitrogen flow was set at 25 psi with nebulization and drifting tube maintained at 12° C. and 55° C., respectively. Gain was set at 500. The mobile phase was chloroform: acetonitrile (50:50)v run for 30 min at a flow rate of 0.2 mL/min. 1 mg/mL (w/v) solution of sample in chloroform was filtered through single step filter vial (Thomson Instrument Company, CA, USA) and 0.5 mL of sample was passed through the C18 column by reversed-phase in isocratic mode. All solvents were HPLC grade and obtained from VWR International (Mississauga, ON, Canada).

### Gel Permeation Chromatography:

Gel Permeation Chromatography (GPC) was used to determine the number average molecular weight ( M̅ₙ), weight-average molecular weight ( M̅_{w}) and the distribution of molecular mass,

$$PDI = \frac{{\overline{M}}_{w}}{{\overline{M}}_{n}} .$$

GPC tests were carried out on a Waters Alliance (Milford, Mass., USA) e2695 pump, Waters 2414 refractive index detector and a Styragel HR5E column (5 mm). Chloroform was used as eluent with a flow rate of 0.5 mL/min. The sample was made with a concentration of 1 mg/mL, and the injection volume was 30 ml for each sample. Polystyrene (PS, #140) standards were used to calibrate the curve. All the GPC analyses were done in duplicate to assess the uncertainties.

### Optimization Results:

### Effect of Catalyst Concentration:

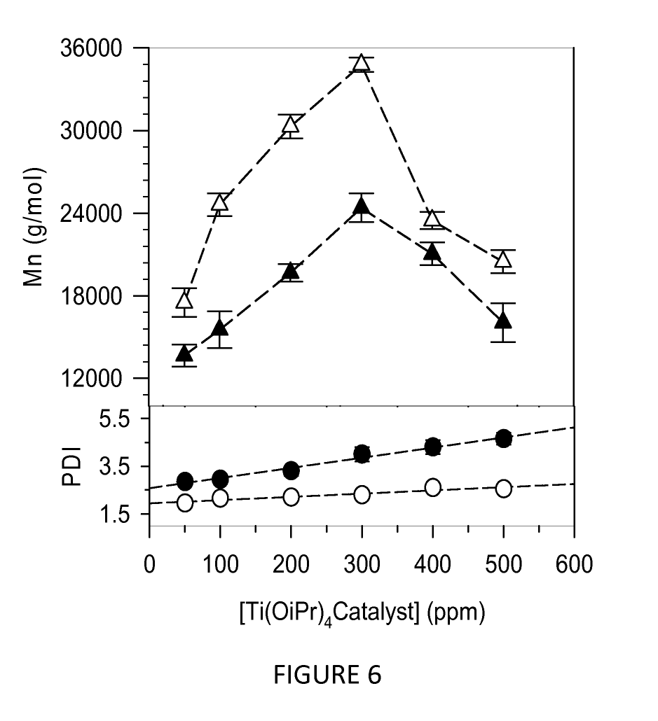

FIG. 6 shows the variation of M̅ₙ and PDI of P(ω-OHC18) (filled symbol) and P(Me-ω-OHC18) (open symbols) with Ti(OiPr)₄ catalyst concentration. The M̅ₙ versus catalyst amount for P(ω-OHC9), P(ω-OHC13), and their corresponding methyl derivatives also presented similarly shaped curves that reached a maximum for 200 or 300 ppm loading, depending on the sample. The optimal catalyst concentrations and corresponding (maximum) M̅ₙ values for the different P(ω-OHFA)s and P(Me-ω-OHFA)s are listed in Table 4. One can notice that for similar catalyst loading, the values of M̅ₙ for P(Me-ω-OHC18) were slightly higher than those for P(ω-OHC18). The PDI exhibited a linear increase with catalyst content (FIG. 6). PDI was found to be relatively higher for the P(ω-OHFA)s than for the (Me-ω-OHFA) monomers. However, the optimum catalyst concentration was consistently the same for any P(Me-ω-OHFA) and P(ω-OHFA) with the same FA (Table 4), suggesting that very close catalysis mechanisms were involved in the polymerization of methyl and acid ester monomers.

TABLE 4
Mean and standard deviation values (from duplicates) for
M̅ₙ and PDI obtained at optimal catalyst concentration
for the P(ω-OHFA)s and the P(Me-ω-OHFA)s.

| | | optimum | | |
|---|---|---|---|---|
| | | [Ti(OiPr)₄] | M̅ₙ ^{a} | |
| Polyesters | sample code | (ppm) | (g/mol) | PDI ^{a} |
| P(ω-OHFA)s | P(ω-OHC9) | 200 | 24321 ± 987 | 4.8 ± 0.2 |
| | P(ω-OHC13) | 300 | 29469 ± 1397 | 6.1 ± 0.3 |
| | P(ω-OHC18) | 300 | 27469 ± 905 | 4.0 ± 0.3 |
| P(Me-ω- | P(Me-ω- | 200 | 28470 ± 761 | 2.5 ± 0.1 |
| OHFA)s | OHC9) | | | |
| | P(Me-ω- | 300 | 30377 ± 975 | 2.4 ± 0.0 |
| | OHC13) | | | |
| | P(Me-ω- | 300 | 34779 ± 528 | 2.3 ± 0.0 |
| | OHC18) | | | |

^{a} obtained from GPC.

The mechanism of the metal-alkoxide catalyst in self polycondensation of hydroxyl acids is still not well understood. Nonetheless, the observation of a maximum in plots of catalyst concentration versus M̅ₙ is consistent with reported results for self polycondensation methyl ω-hydroxyl tetradecanoate [HO—(CH₂)ₙ—COOCH₃] (n=13, (Me-ω-OHC14)) and other related metal catalyst-monomer polycondensation reactions. Recent studies explained the decrease in molecular weight beyond the optimum catalyst concentration by the competitive binding of the catalyst at chain-end groups (which leads to chain propagation) and at the intra-chain ester units. As polycondensation proceeds, the end group (e.g., hydroxyl or carboxyl moieties) concentration decreases with the molecular weight build up. Consequently, an increased number of metal ions becomes available for the intra-chain ester oxygens to complex, which can lead to chain scission reactions. The fact that the decrease in M̅ₙ at the highest Ti(OiPr)₄ content used in this study (500 ppm) is less severe for monomers with n=17 than n=13 and n=9 (see corresponding M̅ₙ for P(ω-OHC18) and P(Me-ω-OHC18), (P(ω-OHC13) and P(Me-ω-OHC13), and (P(ω-OHC9) and P(Me-ω-OHC9), respectively) is a consequence of the relatively lower number of intra-chain ester oxygen units in the long chain ω-OHC18 and Me-ω-OHC18 monomers (methylene to ester group ratio=17:1).

### Effect of Temperature:

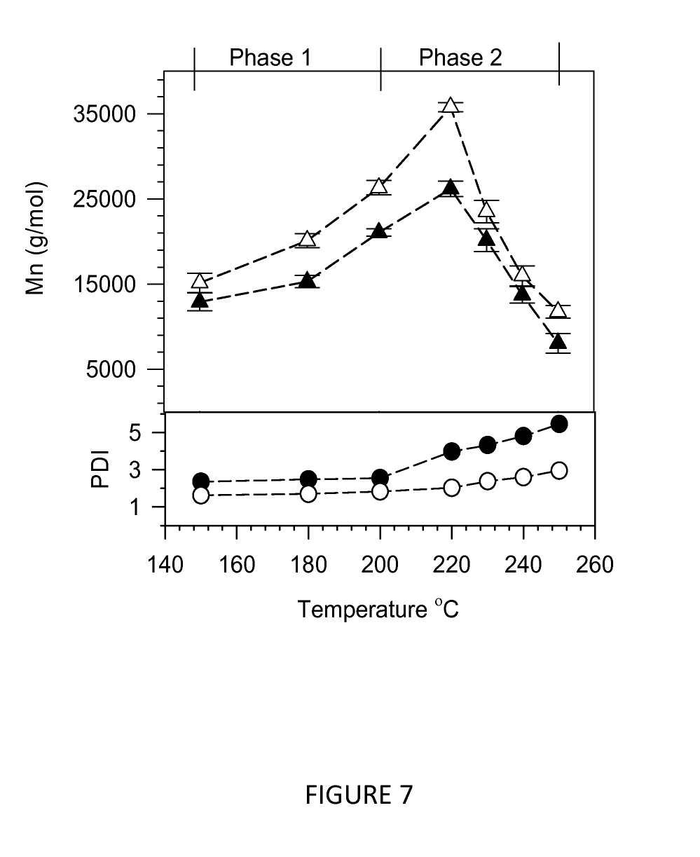

The variation of M̅ₙ and PDI as a function of reaction temperature during polymerization of P(ω-OHC18) (filled symbol) and P(Me-ω-OHC18) (open symbols) using optimal catalyst concentration (300 ppm) is shown in FIG. 7. These data were collected from a single experiment at the end of polymerization at each reaction temperature, i.e., at after 3 hours at 150° C., 2 hours at 180° C., and 2 hours at 200° C. during Phase 1 of polymerization. During the second phase, the M̅ₙ and PDI data were collected after 1 hour polymerization at 220° C., 230° C., 240° C. and 250° C. The curves shown in FIG. 7 are representative of the variation of polyester chain size and distribution during the melt polycondensation of all the (ω-OHFA)s and (Me-ω-OHFA)s. M̅ₙ of P(ω-OHFA)s and P(Me-ω-OHFA)s demonstrated a relatively moderate increase with increasing temperature of polymerization up to 220° C., at which point it decreased noticeably (FIG. 7). Increasing the reaction temperature of Phase 2 affected favorably the increased viscosity build up caused due to the rise in M̅ₙ during polymerization and thereby explains the initial increase in M̅ₙ with reaction temperature. The values of M̅ₙ and PDI corresponding to the optimal reaction temperature (Tₒₚₜ=220° C.) for P(ω-OHFA)s and P(Me-ω-OHFA)s are given in Table 5.

TABLE 5
Mean and standard deviation values for M̅ₙ and PDI
obtained at optimal reaction temperature (Tₒₚₜ = 220° C.)
for P(ω-OHFA)s and P(Me-ω-OHFA)s.

| | | M̅ₙ ^{a} | |
|---|---|---|---|
| Polyesters | Sample | (g/mol) | PDI ^{a} |
| P(ω-OHFA)s | P(ω-OHC9) | 20800 ± 1150 | 4.8 ± 0.2 |
| | P(ω-OHC13) | 27480 ± 1397 | 3.6 ± 0.1 |
| | P(ω-OHC18) | 26190 ± 905 | 3.9 ± 0.1 |
| P(Me-ω-OHFA)s | P(Me-ω -OHC9) | 28470 ± 761 | 2.8 ± 0.1 |
| | P(Me-ω- OHC13) | 30377 ± 975 | 1.9 ± 0.1 |
| | P(Me-ω -OHC18) | 34779 ± 528 | 2.0 ± 0.1 |

^{a} obtained from GPC.

The polycondensation step (Phase 2) at temperatures higher than 220° C. yielded polyesters with lower M̅ₙ and much broader molecular weight distributions, irrespective of n and the type of monomer (acid or ester). The samples obtained at these higher temperatures presented a charred appearance and most were not completely soluble in chloroform at room temperature. This suggested that possible side reactions, such as 13-scission of the polyester, which interfere with polymerization and lead to thermal degradation and subsequent reduction in polyester molecular weights have occurred in our case.

### Effect of Reaction Time:

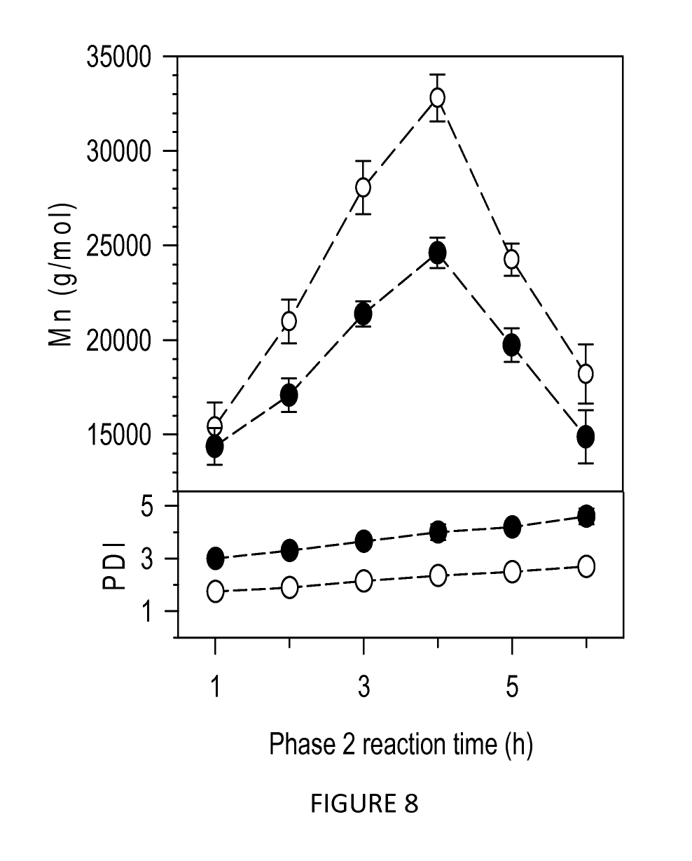

The variation in M̅ₙ and PDI with reaction time (t) in Phase 2 of polymerization for P(ω-OHFA)s and P(Me-ω-OHFA)s at 220° C. and different catalyst concentrations (50-500 ppm) were investigated. FIG. 8 displays M̅ₙ and PDI versus time curves of P(ω-OHC18) (filled symbol) and P(Me-ω-OHC18) (open symbols) when the optimal catalyst amount (300 ppm) was used. As can be seen, M̅ₙ increased initially, reached a maximum after 4 hours and then decreased abruptly, probably due to thermal degradation at prolonged reaction times. PDI increased linearly with reaction time (R²>0.9956, dashed lines in FIG. 8). The highest value of M̅ₙ with most uniform chain distribution (lowest PDI) was obtained for the optimal catalyst amounts, even though, all the samples exhibited a similar trend at all catalyst loadings (50-500 ppm) with a maximum M̅ₙ at 4 hours. M̅ₙ and PDI values of the polymers obtained at the optimal reaction time (tₒₚₜ) are listed in Table 6.

TABLE 6
Mean and standard deviation values for M̅ₙ and PDI obtained at optimal
reaction time (tₒₚₜ) for P(ω-OHFA)s and P(Me-ω-OHFA)s. The range for number
average degree of polymerization ( X̅ₙ) and extent of reaction (p), as well as the
kinetic rate constant (k) and equilibrium constant (K_{c}) for P(ω-OHFA)s and P(Me-ω-
OHFA)s are also given.

| | M̅ₙ^{a} | | | | k | |
|---|---|---|---|---|---|---|
| Polyesters | (g/mol) | PDI^{a} | X̅ₙ | p | (L mol⁻¹ s⁻¹) | K_{c} × 10⁴ |
| P(ω-OHC9) | 24851 ± 987 | 4.8 ± 0.2 | 129-159 | 0.991-0.992 | 5.8 | 1.9 |
| P(ω-OHC13) | 27469 ± 1397 | 5.9 ± 0.2 | 74-148 | 0.986-0.994 | 3.4 | 2.0 |
| P(ω-OHC18) | 27469 ± 905 | 4.3 ± 0.1 | 80-93 | 0.987-0.989 | 2.2 | 1.0 |
| P(Me-ω-OHC9) | 28470 ± 760 | 2.5 ± 0.1 | 107-177 | 0.991-0.993 | 8.1 | 2.5 |
| P(Me-ω-OHC13) | 30377 ± 975 | 2.3 ± 0.1 | 92-143 | 0.988-0.992 | 9.0 | 2.2 |
| P(Me-ω-OHC18) | 34779 ± 528 | 2.3 ± 0.1 | 98-127 | 0.989-0.992 | 6.4 | 1.6 |

^{a}obtained from GPC.

### Kinetic Studies of P(ω-OHFA)s and P(Me-ω-OHFA)s:

Knowledge of the reaction kinetics is required for the practical synthesis of P(ω-OHFA)s and P(Me-ω-OHFA)s. Assuming the rate of disappearance is first order in the reactive group concentration, the linear relationship between the number average degree of polymerization (X) and Phase 2 reaction time (t) is given by Equation 1,

X̅ₙ=1+k[A₀]t (1)

where k is the reaction rate constant, and [A₀] the concentration of the hydroxyl and acid/ester groups, [OH]═[COOH(OCH₃)]=[A₀] at the onset of Phase 2 polymerization at 220° C. S, is also related to the extent of reaction (p) by the well-known Carothers equation⁴⁰ given by Equation 2,

$${\overline{X}}_{n} = \frac{1}{1 - p} \qquad ( 2 )$$

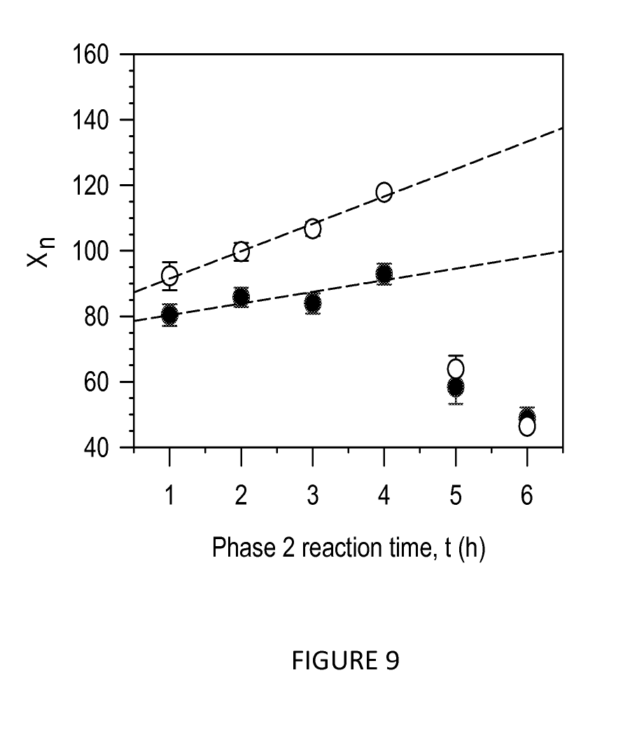

FIG. 9 plots the variation of X̅ₙ with t during Phase 2 polycondensation at 220° C. for P(ω-OHC18) and P(Me-ω-OHC18). For the range of conversions (p) between 0.9876 and 0.9892 (calculated using Equation 2) that represents the last 1-2% of polymerization, X̅ₙ of P(ω-OHC18) and P(Me-ω-OHC18) obeyed the rate law (given by Equation 1). The number average degree of polymerization, X̅ₙ increased from 80 to 92 for P(Me-ω-OHC18), and from 98 to 127 for P(ω-OHC18) with time until an upper limit (tₒₚₜ) was reached (FIG. 9).

The range of values for X̅ₙ and p along with the rate constants (k) for P(Me-ω-OHFA)s and P(ω-OHFA)s are listed in Table 6. These systems obeyed the rate law for only the last 1-2% percent of polymerization, which however represented 67% of the duration of Phase 2 of the polymerization process. The degree of polymerization, X̅ₙ, increased substantially from 90 to 180 in the above conversion range. For step-growth polymerization it is generally known that polymeric products with molecular weights sufficiently high for useful and practical applications are formed at large extent of reaction (usually at p>0.95) and therefore the kinetics of polymerization for the later stages are more significant. The rate constant values (Table 6) varied with 11 by less than ±37% for P(ω-OHFA)s and less than ±13% P(Me-ω-OHFA)s). Based on Flory's theoretical concept of equal reactivity of functional groups and as also experimentally proven for many polymeric systems, the value of the rate constants (k) for step-growth polymerization of monomers in a homologous series, is independent of the molecular size (for n>2). The reactivity of the series [HO—(CH₂)ₙ—COOH] for (ω-OHFA)s and of [HO—(CH₂)ₙ—COOCH₃] for (Me-ω-OHFA)s, (n=8, 12 and 17), which are comparable within ±37% and ±13% for P(ω-OHFA)s and P(Me-ω-OHFA)s), respectively, can be explained under the Flory concept.

As seen in FIG. 9, the linear behavior did not hold for times longer than the optimal time (4 hours) indicating a mitigating effect on X̅ₙ by possible depolymerization or degradation through unwanted side reactions. Polycondensation being an equilibrium reaction requires the complete removal of by-products to make it favorable to achieve high molecular weight polyesters. At larger conversions the high viscosity of the reaction medium makes it progressively difficult to remove the by-products which as a consequence increases the rate of reverse reaction (depolymerization). The values of equilibrium constant for polymerization, K_{C} calculated for the polycondensation of P(ω-OHFA)s and P(Me-ω-OHFA)s) at 220° C., using Equation 3 are listed in Table 4.

X̅ₙ=1+K_{C}^{1/2} (3)

The equilibrium constant values obtained for all the polyesters are higher enough (K_{C}≧10⁴) to afford a degree of polymerization, X̅ₙ≧100, that corresponds to molecular weights for favorable polymeric properties.

The use of different reactant systems, namely, ω-OHFAs and Me-ω-OHFAs yielded the same type of polyester, i.e., having the same [—(CH₂)ₙ—COO—] repeating monomer unit. The polyesters with the best chain distribution was obtained by the polycondensation of Me-ω-OHFAs at 220° C. using the optimal catalyst amounts (300 ppm), as is revealed by Tables 4, 5 and 6. The relatively higher X̅ₙ attained at tₒₚₜ for P(Me-ω-OHFA)s) suggests that its polymerization was much easier than ω-OHFAs. The slightly higher values of rate constant obtained for the P(Me-ω-OHFA)s (Table 6) indicate higher reactivity for the Me-ω-OHFA monomers. Furthermore, the relatively higher values of equilibrium constants obtained for the P(Me-ω-OHFA)s (Table 6), suggest that the (Me-ω-OHFA) monomers offer a more favorable equilibrium with minimized side reactions to give high molecular weight polyesters than the acid terminated ω-OHFA monomers.

As a general recap, a group of ω-hydroxy fatty acid (ω-OHFA) [HO—(CH₂)ₙ—COOH] and ester (ω-Me-OHFA) [HO—(CH₂)ₙ—COOCH₃] homologues with medium (n=8 and 12) and long (n=17) methylene chains, suitable for making degradable thermoplastic polyesters were successfully produced from unsaturated fatty acids, unsaturated fatty acid methyl esters, and unsaturated fatty alcohols, derived from natural oils. The methyl ester homologues having n=8 and 12 were synthesized from methyl oleate, and erucic acid, respectively, by ozonolysis—reduction reactions at the fatty acid double bonds. Their subsequent saponification gave the acid homologues, namely 9-hydroxynonanoic acid (ω-OHC9), and 13-hydroxytridecanoic acid (ω-OHC13), respectively. The long chain homologue (n=17) 18-hydroxyoctadecanoic acid (ω-OHC18) and methyl 18-hydroxyoctadecanoate (ω-Me-OHC18) were obtained by cross-metathesis of methyl oleate and oleyl alcohol using Grubbs catalyst in good yields and purity.

The equilibrium melt polycondensation of the (ω-OHFA)s and (ω-Me-OHFA)s was investigated for the purpose of understanding the optimal reaction conditions favorable to achieve polymerization products with desired molecular mass and distribution. For P(ω-OHFA)s and P(ω-Me-OHFA)s, the molecular chain size ( M̅ₙ) and distribution (PDI) deteriorated beyond a maximum Ti(OiPr)₄ catalyst concentration (200-300 ppm), probably due to the increased concentration of intra-chain metal ion-ester oxygen complexes that are susceptible to chain scission reactions. M̅ₙ of both the P(ω-OHFA)s and the P(ω-Me-OHFA)s increased with the step-wise increase of reaction temperatures, due to the offset of the rise in polyester viscosity, up until 220° C., beyond which it decreased significantly due to unwanted side reactions causing degradation. The duration of the final reaction stage was also critical since the polycondensation of the (ω-OHFA)s and (ω-Me-OHFA)s at 220° C. beyond the optimal reaction time (4 hours) caused a mitigating effect on the number average degree of polymerization, X̅ₙ, due to depolymerization or degradation.

P(ω-OHFA)s and P(ω-Me-OHFA)s obeyed first order kinetics for the last 1-2% of polymerization. The acid homologues (Me-ω-OHFA)s were preferred over the ester derivatives for their ease of preparation of the monomers. The equilibrium and kinetics studies suggested that the polymerization of the P(ω-Me-OHFA)s proceeded more easily and at a faster rate and gave polyesters with higher molecular weights and better distribution than P(ω-OHFA)s.

### Effects of Molecular Parameters and Structure on Physical Properties of Poly-Hydroxyesters:

The effects of structural and molecular parameters on the thermal and mechanical properties of poly-hydroxyesters, namely poly(ω-hydroxynonanoate), P(Me-ω-OHC9) (n=8), poly(ω-hydroxytridecanoate), P(Me-ω-OHC13) (n=12), and poly(ω-hydroxyoctadecanoate), P(Me-ω-OHC18) (n=17), were analyzed. The corresponding polymers of these materials were obtained by polycondensation of certain of methyl-ω-hydroxyl fatty ester monomers (Me-ω-OHFA)s [HO—(CH₂)ₙ—COOCH₃], as previously described.

### Materials and Preparation of Polyesters:

Ti(IV) isopropoxide and 1-butanol were purchased from Sigma-Aldrich. The monomers (Me-ω-OHC9) (96.5% purity), (Me-ω-OHC13) (97% purity), and (Me-ω-OHC18) (97% purity) were synthesized in our laboratories. The detailed synthesis of the monomers was described previously. A series of P(Me-ω-OHFA)s were prepared with the number average molecular weights, M̅ₙ, between 10000 to 40000 g/mol, as previously described. The reaction parameters, catalyst concentration, and reaction time and temperature were optimized to obtain the desired molecular weights, were also previously described. The optimal amount of catalyst solution was found to be 200 ppm for (Me-ω-OHC9) and 300 ppm for both (Me-ω-OHC13) and (Me-ω-OHC18).

The polyesterification was conducted in a stainless steel reactor equipped with a mechanical stirrer, nitrogen inlet, gas outlet, a thermocouple and pressure gauge. The monomer (10 g) and optimal amount of catalyst solution (10 mg/mL Ti(OiPr)₄ in 1-butanol) was transferred into the reactor. The reaction mixture was initially heated at 150° C. for three hours with continuous stirring under N₂ flow at atmospheric pressure. The temperature was subsequently raised and maintained at 180° C. for 2 hours, followed by another 2 hours at 200° C. under the same reaction conditions.

Except for (Me-ω-OHC9), because of its relatively lower thermal stability (˜130° C., determined from TGA analysis), the reaction was initiated at 120° C. for one hour before applying elevated temperature cycles. Traces of methanol were removed from the reaction medium by heating the mixture at 220° C. under reduced pressure (<0.1 torr). Desired molecular weights were obtained by maintaining the above reaction conditions for optimal reaction times, which varied between 1 to 4 hours. The solid samples were melt pressed to make films at a controlled cooling rate of 5° C./minute on a Carver 12 ton hydraulic heated bench press (Model 3851-0, Wabash, Ind., USA).

### Characterization Techniques:

The structures of P(Me-ω-OHFA)s were analyzed by ¹H NMR spectroscopy. The spectra were recorded on a Bruker Avance III 400 spectrometer (Bruker BioSpin MRI GmbH, Karlsruhe, Germany) at a frequency of 400 MHz. Deuterated chloroform (CDCl₃), which has a chemical shift of 7.26 ppm was used as a solvent. The chemical shifts for P(Me-ω-OHFA)s were referenced relative to residual solvent peaks.

Gel Permeation Chromatography (GPC) was used to determine the number ( M̅ₙ), weight average molar mass (R), and polydispersity index (PDI) of the P(Me-ω-OHFA)s. GPC tests were carried out on a Waters Alliance (Milford, Mass., USA) e2695 pump, Waters 2414 refractive index detector and a Styragel HR5E column (5 μm). Chloroform was used as eluent with a flow rate of 0.5 mL/min. The sample was made with a concentration of 2 mg/mL and the injection volume was 30 pl for each sample. All analyses were done in duplicate. Polystyrene (PS, #140) Standard was used to calibrate the GPC curve.

DSC analysis was carried out under a dry nitrogen gas atmosphere on a Q200 (TA instrument, Newcastle, Del., USA) following the ASTM E1356-03 standard procedure. The solid sample (5.0-6.0 mg) was first equilibrated at 0° C. and heated to 130° C. at a constant rate of 3.0° C./min (first heating cycle). The sample was held at that temperature for 10 minute to erase the thermal history, then cooled down to −90° C. with a cooling rate of 3° C./minute and subsequently reheated to 130° C. at the same rate (second heating cycle). During the heating process, measurements were performed with modulation amplitude of ±1° C. at every 60 seconds.

Thermogravimetric Analysis (TGA) of the synthesized polyesters was carried out on a Q500 (TA instrument, Newcastle, Del., USA) following the ASTM D3850-94 standard procedure. Samples of ˜10 mg were heated from room temperature to 600° C. under dry nitrogen at a constant heating rate of 10° C./minute.

Viscoelastic behavior of P(Me-ω-OHFA)s was studied by performing dynamic temperature sweeps in a dynamic mechanical analyzer (DMA Q800, TA instrument) equipped with a liquid nitrogen cooling system. Rectangular polymer films (17.5 mm×12 mm×0.6 mm) were measured in dual cantilever and three points bending modes at a frequency of 1 Hz and fixed oscillation displacement of 15 μm, following the ASTM D7028 standard procedure. The samples were heated under a constant rate of 1° C./min over a temperature range of −90° C. to 60° C.

The static mechanical properties of the polymer films were determined at room temperature using a Texture Analyzer (TA HD, Texture Technologies Corp, NJ, USA) equipped with a 2-kg load cell. The measurements were performed following the ASTM D882 standard procedure. The sample was stretched at a rate of 5 mm/min from a gauge of 35 mm.

Wide-angle X-ray diffraction (WAXD) was carried out at room temperature (˜22° C.) on an EMPYREAN diffractometer system (PANalytical, The Netherlands) equipped with a Cu-Kα radiation source (λ=1.540598 Å) and a PIXcel-3D™ area detector. The WAXD patterns were recorded at 45 kV and at 40 mA. The 2θ-scanning range was from 3° to 90°. 3313 points were collected in 45 min in this process. The data were processed and analyzed using the Panalytical's X′Pert HighScore V3.0 software. The degree of crystallinity was estimated according to a well-established procedure. The percentage degree of crystallinity (X_{C}) is given by equation (4),

$${X}_{C} = 100 \times \frac{{A}_{C}}{{A}_{C} + {A}_{A}} \qquad ( 4 )$$

where A_{C} is the area under the resolved crystal diffraction peaks and A_{A}, the area of the amorphous contribution halo.

### Characterization of P(Me-ω-OHFA)s:

The structures of P(Me-ω-OHFA)s were analyzed by ¹H NMR spectroscopy. Generally, the peaks at 3.50-3.70 ppm corresponding to protons from the end methyl group and the hydrogen from the α-proton to hydroxyl group which are present in the monomers did not appear in the spectrums of the P(Me-ω-OHFA)s. The spectrums of P(Me-ω-OHFA)s also demonstrated a new peak at 4.06-4.10 ppm, assignable to the protons from the methylene group attached to the ester linkage formed as a result of polymerization. ¹H NMR (CDCl₃ 400 MHz) data of the P(Me-ω-OHFA)s are listed in Table 6A.

TABLE 6A
¹H NMR (CDCl₃ 400 MHz) data of the P(Me-ω-OHFA)s.

| | |
|---|---|
| P(Me-ω-OHC9) | ¹H NMR (CDCl₃ 400 MHz) δ (ppm): 1.20-1.34 |
| | (m, 10H, CH₂), 1.6-1.64 (m, 2H, CH₂CH₂COO), |
| | 2.28-2.36 (t, 2H, CH₂COO), 4.06-4.09 (2H, CH₂O) |
| P(Me-ω-OHC13) | ¹H NMR (CDCl₃ 400 MHz) δ (ppm): 1.29-1.31 |
| | (m, 18H, CH₂), 1.6-1.66 (m, 2H, CH₂CH₂COO), |
| | 2.29-2.33 (t, 2H, CH₂COO), 4.06-4.09 (2H, CH₂O) |
| P(Me-ω-OHC18) | ¹H NMR (CDCl₃ 400 MHz) δ (ppm): 1.28-1.33 |
| | (m, 28H, CH₂), 1.59-1.66 (m, 2H, CH₂CH₂COO), |
| | 2.29-2.36 (t, 2H, CH₂COO), 4.06-4.10 (2H, CH₂O). |

The number ( M̅ₙ) weight average molar masses ( M̅_{w}), and polydispersity index (PDI) of the P(Me-ω-OHFA)s determined by GPC are listed in Table 7. The polyester samples are labeled by their abbreviations followed by their rounded M̅ₙ values given as subscripts (Table 7). The calculated ester group concentration for P(Me-ω-OHC9), P(Me-ω-OHC13) and P(Me-ω-OHC18) were 20, 14 and 10 wt %, respectively. Three P(Me-ω-OHFA)s, namely P(Me-ω-OHC9)_{28.4k}, P(Me-ω-OHC13)_{30.3k} and P(Me-ω-OHC18)_{34.7k}, having comparable M̅ₙ and PDI values were selected to investigate the effect of n on the thermal and mechanical properties of P(Me-ω-OHFA)s. Unless specified otherwise, the linear PE to which the P(Me-ω-OHFA)s are compared is high-density polyethylene (HDPE), which consists predominantly of (—CH₂—)ₙ and has very low branching content.

TABLE 7
Molecular parameters for P(Me-ω-OHFA)s determined
by GPC: The average values of M̅ₙ, M̅_{w} and
PDI, and their standard deviations are given.

| | number | | | |
|---|---|---|---|---|
| | of (CH)₂ | M̅_{w} | M̅ₙ | |
| Sample code | groups (n) | (g/mol) | (g/mol) | PDI |
| P(Me-ω- | 8 | 34577 ± 4387 | 13831 ± 988 | 2.3 ± 0.1 |
| OHC9)_{13.8k} | | | | |
| P(Me-ω- | | 50538 ± 3894 | 19438 ± 1015 | 2.4 ± 0.0 |
| OHC9)_{19.4k} | | | | |
| P(Me-ω- | | 61519 ± 4419 | 25633 ± 946 | 2.6 ± 0.2 |
| OHC9)_{25.6k} | | | | |
| P(Me-ω- | | 72604 ± 6693 | 28470 ± 761 | 2.5 ± 0.1 |
| OHC9)_{28.4k} | | | | |
| P(Me-ω- | 12 | 16333 ± 4553 | 10889 ± 1022 | 1.6 ± 0.1 |
| OHC13)_{10.8k} | | | | |
| P(Me-ω- | | 22574 ± 6518 | 14109 ±866 | 1.8 ± 0.2 |
| OHC13)_{14.1k} | | | | |
| P(Me-ω- | | 35148 ± 5406 | 20675 ± 930 | 2.1 ± 0.1 |
| OHC13)_{20.6k} | | | | |
| P(Me-ω- | | 72147 ± 6247 | 30377 ± 975 | 2.4 ± 0.0 |
| OHC13)_{30.3k} | | | | |
| P(Me-ω- | 17 | 28010 ± 1559 | 17506 ± 1044 | 1.9 ± 0.1 |
| OHC18)_{17.5k} | | | | |
| P(Me-ω- | | 44309 ± 5513 | 24616 ± 836 | 2.1 ± 0.1 |
| OHC18)_{24.6k} | | | | |
| P(Me-ω- | | 57558 ± 4471 | 30294 ± 860 | 2.2 ± 0.1 |
| OHC18)_{30.2k} | | | | |
| P(Me-ω- | | 76513 ± 6826 | 34779 ± 528 | 2.3 ± 0.0 |
| OHC18)_{34.7k} | | | | |

### Crystalline Structure and Melt Transition Behavior of P(Me-ω-OHFA)s:

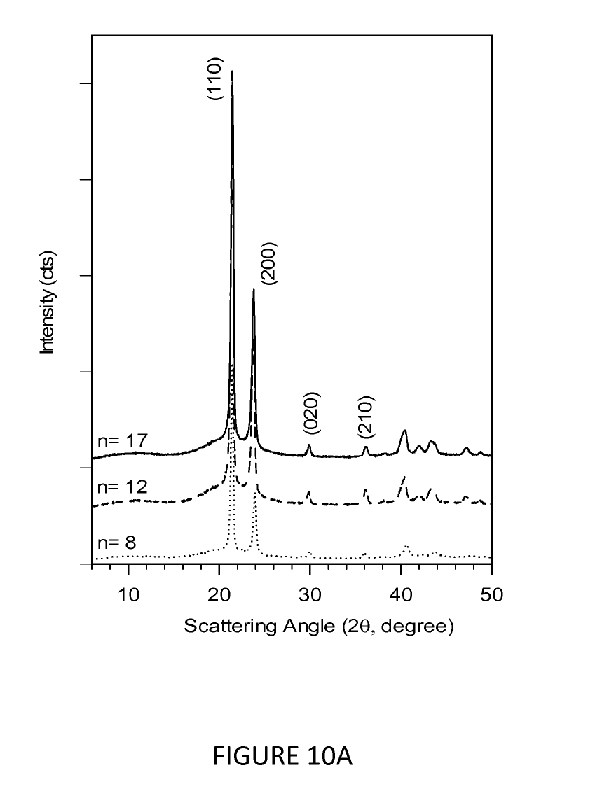

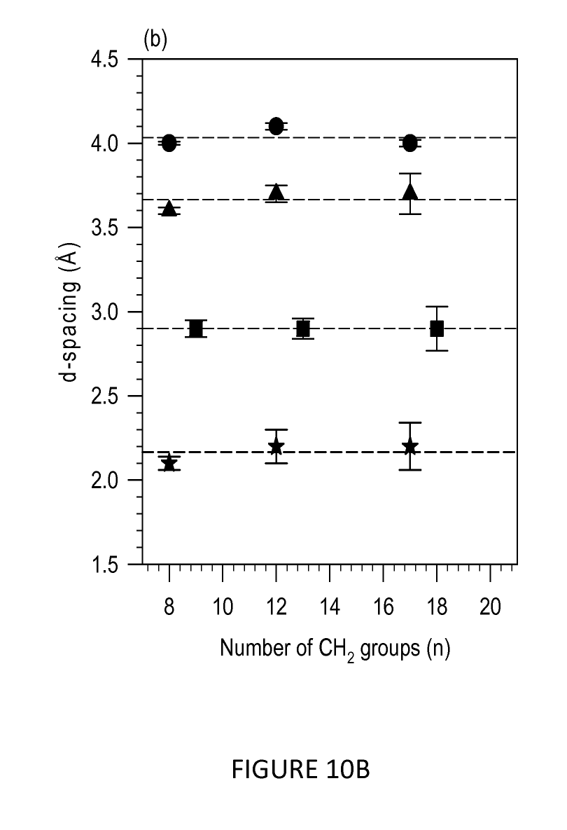

The crystalline structure of the P(Me-ω-OHFA) samples was investigated by wide-angle X-ray diffraction (WAXD). FIG. 10A shows the WAXD patterns of P(Me-ω—OHC9)_{28.4k} (n=8), P(Me-ω-OHC13)_{30.3k} (n=12) and P(Me-ω-OHC18)_{34.7k} (n=17).

The variation of the corresponding d-spacing of the crystal peaks with number of (CH₂) groups (n) are presented in FIG. 10B. These data are representative of all P(Me-ω-OHFA) samples, irrespective of their M̅ₙ values. The experimental WAXD profiles of all the P(Me-ω-OHFA) samples consisted of four resolved diffraction peaks, characteristic of a large crystalline phase, superimposed to a relatively small wide halo, indicative of the presence of an amorphous phase. As can be seen in FIGS. 10A and 10B, all samples demonstrated similar WAXD spectra indicating that they crystallized in similar crystal forms. The analysis of the WAXD patterns was performed with a fitting module of HighScore Version 3.0. The initial positions of the peaks were selected at the maximum height of the well-resolved WAXD peaks. The amorphous contribution was added in the form of two wide lines (centered at 3.8 and 4.6 Å) as typically done for semi-crystalline polymers. The observed intensities were evaluated by integrating the crystalline peaks observed in the WAXD profiles.

The WAXD patterns obtained for P(Me-ω-OHFA)s are reminiscent of that obtained for melt crystallized polyethylene (PE), indicating similar crystal structures. The sharp diffraction peaks observed in the WAXD patterns of P(Me-ω-OHFA)s (FIG. 10A) are characteristic of the common orthorhombic methylene subcell packing. The two very strong lines at positions 21.29 ° [2θ] and 24.22° [2θ] (d-spacings of 4.18±0.02 Å and 3.69±0.05 Å, respectively) originated from the 110 and 200 reflections of the orthorhombic symmetry, respectively. The weaker peaks at d-spacings of 2.99±0.01 Å and 2.50±0.03 Å originated from the 210 and 020 reflections of the orthorhombic symmetry, respectively.

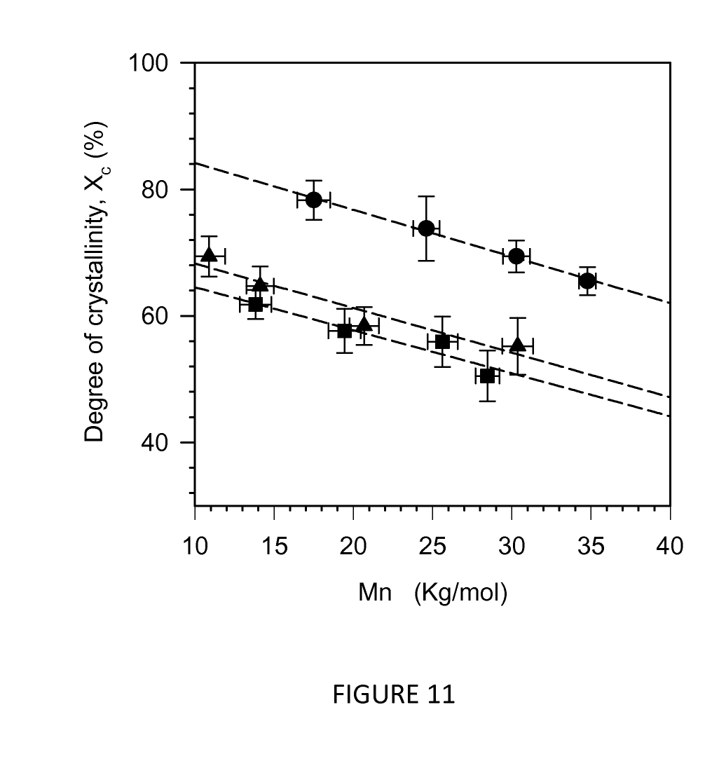

The degree of crystallinity, X_{C}, of the P(Me-ω-OHFA)s as estimated from WAXD, were in the 50% to 78% range (Table 8). FIG. 11 displays the variation of X_{C} with M̅ₙ for the P(Me-ω-OHFA)s. The fraction of ordered crystalline regions (X_{C}) decreased linearly (R²>0.9025) with increasing M̅ₙ for all three P(Me-ω-OHFA)s. It is worth noting that the rate at which X_{C} decreases is significantly the same (˜0.71±0.16). For polymers, crystallization upon cooling from the melt occurs at temperatures between T_{g}<T<Tₘ. At M̅ₙ increases, the relative number of molecular entanglements increases, resulting in increased chain viscosities. This further decreases the rate of crystallization in higher molecular weight P(Me-ω-OHFA)s. The linear relationship observed between M̅ₙ and X_{C} (FIG. 11) is of importance, since X_{C} relates directly to several other properties such as glass transition, mechanical behavior, biodegradability, etc.

TABLE 8
Characteristic parameters of P(Me-
ω-OHFA)s obtained by DSC and WAXD.

| | Second melting | | | | |
|---|---|---|---|---|---|
| | Tₒₙ | T_{off} | Tₘ | ΔHₘ | X_{C} |
| Polyester code | (° C.) | (° C. | (° C.) | (J/g) | (%) |
| P(Me-ω-OHC9)_{13.8k} | 62.9 | 68.9 | 66.1 | 134 | 61.8 |
| P(Me-ω-OHC9)_{19.4k} | 60.6 | 69.5 | 68.8 | 132 | 57.6 |
| P(Me-ω-OHC9)_{25.6k} | 60.9 | 71.2 | 67.8 | 132 | 55.9 |
| P(Me-ω-OHC9)_{28.4k} | 64.9 | 72.7 | 69.3 | 129 | 50.5 |
| P(Me-ω-OHC13)_{10.8k} | 74.1 | 82.7 | 78.3 | 145 | 69.4 |
| P(Me-ω-OHC13)_{14.1k} | 74.5 | 82.6 | 76.7 | 144 | 64.7 |
| P(Me-ω-OHC13)_{20.6k} | 73.1 | 84.4 | 78.8 | 138 | 57.4 |
| P(Me-ω-OHC13)_{30.3k} | 72.1 | 83.3 | 79.8 | 133 | 55.2 |
| P(Me-ω-OHC18)_{17.5k} | 84.8 | 92.7 | 89.5 | 182 | 78.3 |
| P(Me-ω-OHC18)_{24.6k} | 84.9 | 93.0 | 90.0 | 178 | 73.8 |
| P(Me-ω-OHC18)_{30.2k} | 84.1 | 92.5 | 89.4 | 182 | 69.4 |
| P(Me-ω-OHC18)_{34.7k} | 84.2 | 92.2 | 90.2 | 161 | 65.5 |

Onset, Tₒₙ, offset, T_{off}, peak temperature of melting, Tₘ, and enthalpy of melting, ΔHₘ obtained from second heating cycle, and degree of crystallinity, X_{C} estimated from WAXD. The uncertainties attached to the characteristic temperatures, enthalpies and degree of crystallinity are better than 0.5° C., 8 J/g and 5% respectively.

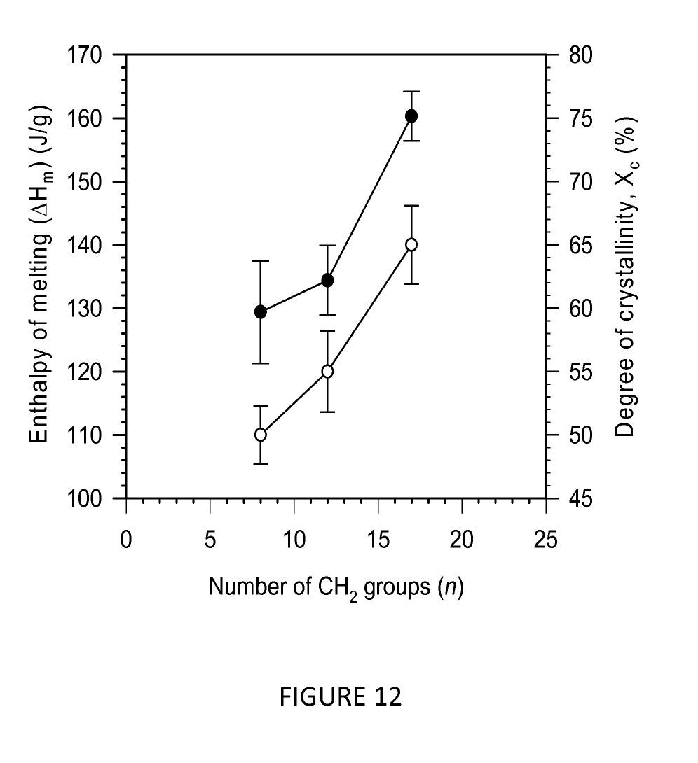

FIG. 12 shows the variation of 4 as a function of n for P(Me-ω-OHC9)_{28.4k} (n=8), P(Me-ω-OHC13)_{30.3k} (n=12) and P(Me-ω-OHC18)_{34.7k} (n=17). X_{C} increased with increasing n for P(Me-ω-OHFA)s, because increased methylene segments length provides increased van der Waals attractions, yielding an increasing fraction of crystalline regions. Not surprisingly, the X_{C} data correlates very well with the melting enthalpies, ΔHₘ, obtained in the second DSC heating cycle as evidenced in FIG. 12. This is understandable as both represents the same fraction of crystalline material.

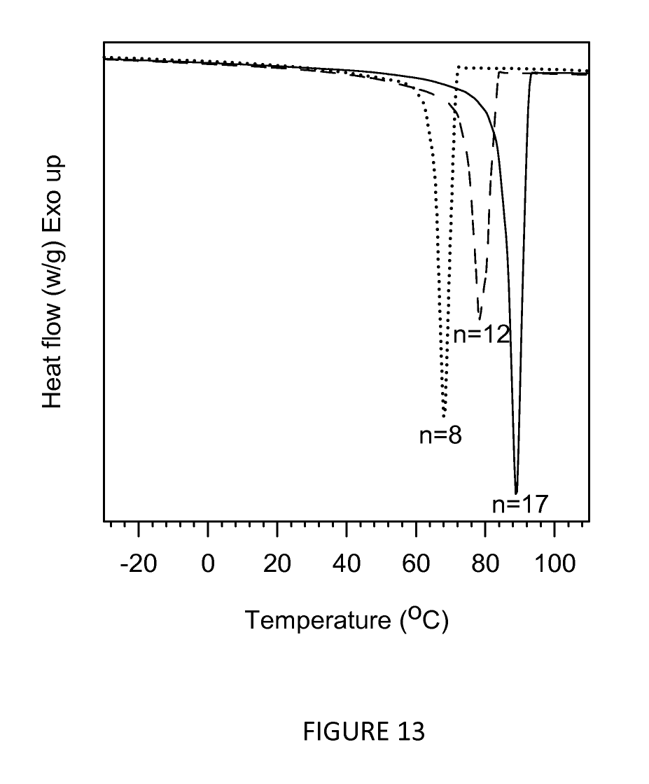

The DSC thermograms of P(Me-ω-OHC9)_{28.4k} (n=8), P(Me-ω-OHC13)_{30.3k} (n=12), and P(Me-ω-OHC18)_{34.7k} (n=17) obtained during the second heating cycle are shown in FIG. 13. These are representative of the melting behavior of the crystalline phases obtained from the melt. The DSC characteristic data (temperature and enthalpy) obtained for the P(Me-ω-OHFA) samples during the second heating cycles are listed in Table 8. The thermograms obtained for all the samples demonstrated a single endotherm. As can be seen in Table 8, although the enthalpy of melting was affected by M̅ₙ, the peak temperature (melting point, Tₘ) did not vary significantly for any given n. This corroborates the WAXD results, which indicated the presence of a unique orthorhombic crystal phase having a varying degree of crystallinity. Furthermore, the relatively small width of the endotherms (FWHM=2-4° C.) indicated that the phases formed from the melt were homogeneous, again consistent with the WAXD findings.

As seen from Table 8, Tₘ of the P(Me-ω-OHFA)s increased significantly with n. The large increase in Tₘ(˜20° C.) when the number of methylene groups was increased from n=8 to 17 indicates clearly that longer [—(CH₂)ₙ—COO—] monomer units form thermodynamically more stable, thicker crystals upon cooling, which melt at higher temperatures.

For semi-crystalline polymers, the three key physical factors determining Tₘ are (i) chain stiffness (ii) inter-chain cohesive forces, and (iii) inter-chain packing efficiency. In the case of polyesters, the concentration of flexible —OCO groups in the chain backbone determines the molecular chain stiffness. The polar ester groups also contribute favorably to the inter-chain attractive cohesive forces, and thereby promote crystallization. Any preferred conformational effect favoring the packing of aliphatic methylene chains by van der Waals attraction is also expected to contribute to the polyester crystallinity.

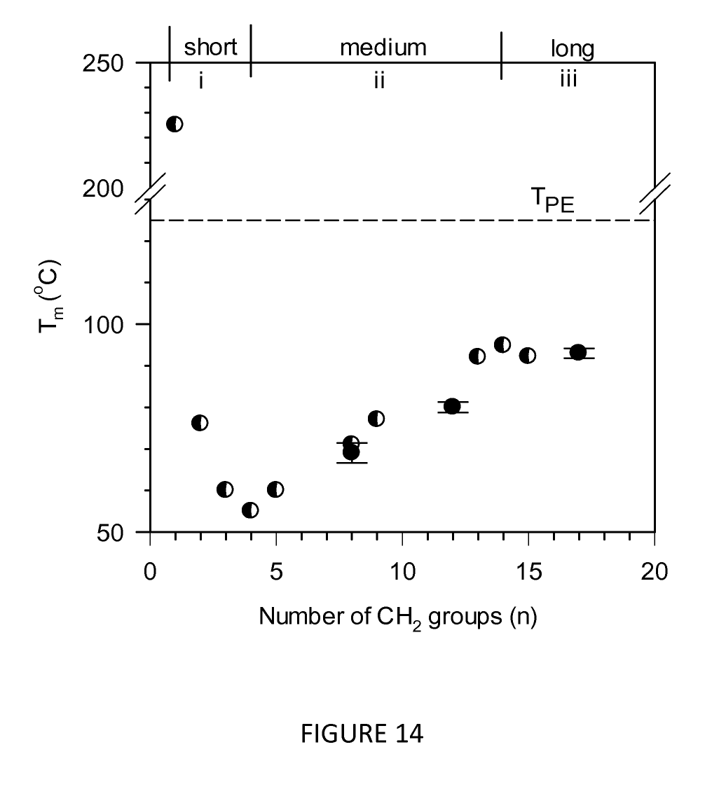

FIG. 14 shows the effect of the number of methylene groups (n) on Tₘ for a collection of polyesters of the [—(CH₂)ₙ—COO—] homologous series. Data mined from the literature is included in the figure in order to provide a context for the discussion. Because Tₘ of high molecular weight polyesters is not affected much by M̅ₙ, the trend observed in FIG. 14 is solely attributable to the number of methylene groups (n). Three regions (labeled (i) short, (ii) medium and (iii) long in FIG. 14) where Tₘ of the homologues exhibit different, but distinct behavior can be distinguished. After an initial steep decrease observed for the short aliphatic polyesters (region 1, n≦5), Tₘ reaches a minimum then increases gradually with ri for the medium chains (region 2, n=5-13) and reaches a plateau at ˜90° C. for the long chain aliphatic polyesters (n>13).

The minimum observed in Tₘ versus n curve (FIG. 14) is attributable to the competition between the cohesive energies, which decrease with increasing n, and the chain stiffness as well as inter-chain packing efficiencies, which increases with increasing n, as the polymer chains become more “PE-like”. The relatively high value of Tₘ for linear PE (T_{PE}) (line at 125° C. in FIG. 14) is the result of the ideal packing efficiency in its energetically preferred all -trans planar zigzag chain conformation which predominate over its very low chain stiffness and cohesive energies. The plateauing of Tₘ for the long chain polyesters emphasizes the strong effect of the ester groups even when present at very low concentration (10 wt. % for P(Me-ω-OHC18)). Conformational and chain rotation effects probably dominate in this case. There is no Tₘ data for polyesters with chains longer than n=17 and no evidence that the balance of interactions at the origin of the plateau holds beyond. It may therefore be possible to increase the melting point of long chain polyesters by increasing further n, and even reach values close to Tₘ of linear PE. This of course has to be determined experimentally. Nevertheless, the finding of a predictive behavior for Tₘ of long chain polyesters is of substantial practical importance as it will help design suitable monomers for targeted applications.

### Glass Transition Behavior of P(Me-ω-OHFA)s:

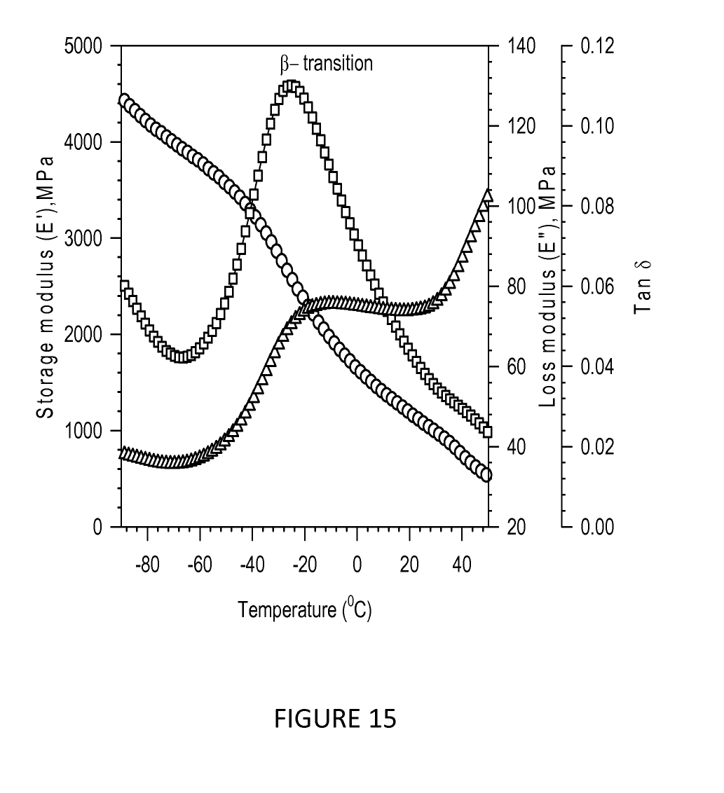

Viscoelastic response, obtained by DMA was used to classify the various solid state transitions, including glass transition. FIG. 15 displays the DMA spectrum for P(Me-ω-OHC9)_{28.4k}, which is representative of all P(Me-ω-OHFA) samples.

The amorphous glass-rubber transition (T_{g}) is indicated prominently by a well-developed relaxation process. T_{g} is marked by an abrupt decrease of ˜3 GPa in E′ observable between −30° C. and 0° C. (FIG. 15) as well as pronounced peaks in E′ and tan δ curves. The intensity of the glass transition is measured by the slope of E′ as well as by the tan δ peak area. For P(Me-ω-OHFA)s with any given n, the intensity of the glass transition increased with the fraction of amorphous chains (1−X_{C}). This is evidence of the fact that the segmental motions due to amorphous chains are responsible for the glass transition in P(Me-ω-OHFA)s. The glass transition temperature (T_{g}) of the P(Me-ω-OHFA)s determined from the peak value of tan δ curves are listed in Table 9.

Aliphatic polyesters generally exhibit three relaxations where the elastic storage modulus (E′) changes rapidly with temperature, and maxima occur in the mechanical loss factor (E′) and tan δ curve. These transitions, in their descending order, i.e., the melting temperature, glass transition and subglass transition are known as the α, β, and γ transitions, respectively. The α-transition corresponding to the melting of the crystal phase of the P(Me-ω-OHFA) samples did not appear in FIG. 15, because of the limits of the experimental design. A subglass relaxation, resembling the γ process of linear PE which has been reported for PPDL 5 (n=14) at −130° C., did not show for the P(Me-ω-OHFA)s, probably because of the limited range of temperatures used in our DMA.

The T_{g} of P(Me-ω-OHFA)s ranged from −30° C. to −19° C. (Table 9), indicating that the amorphous regions remain in the ductile state at temperatures very favorable for a large set of high end applications, especially at service temperatures which are required for biomedical polymers. The location of T_{g} is also relevant for the fabrication of P(Me-ω-OHFA)s with desired crystallinities. Since crystallization is limited to the temperature range between T_{g} and Tₘ, and that a maximum rate of crystallization is expected between these two temperatures, the thermal history between T_{g} and Tₘ while processing influence the extent of crystallinity in P(Me-ω-OHFA)s.

TABLE 9
Glass transition temperature (T_{g}) obtained from DMA, T_{g}/Tₘ
parameter, onset temperature of degradation obtained at 1%
weight loss, T_{d(1)}, and temperature of degradation for 50%
weight loss T_{d(50)} obtained by TGA for the P(Me-ω-OHFA)s.

| | T_{g} | T_{g}/ | T_{d(1)} | T_{d(50)} |
|---|---|---|---|---|
| Sample | (° C.) | Tₘ | (° C.) | (° C.) |
| P(Me-ω-OHC9)_{13.8k} | −23.6 ± 1.4 | 0.73 | 277.0 ± 2.4 | 411.5 ± 1.9 |
| P(Me-ω-OHC9)_{19.4k} | −25.5 ± 1.5 | 0.72 | 288.1 ± 3.3 | 412.4 ± 1.6 |
| P(Me-ω-OHC9)_{25.6k} | −26.1 ± 0.8 | 0.72 | 302.1 ± 3.2 | 415.4 ± 1.6 |
| P(Me-ω-OHC9)_{28.4k} | −27.8 ± 1.1 | 0.71 | 309.8 ± 1.3 | 416.5 ± 2.0 |
| P(Me-ω-OHC13)_{10.8k} | −19.5 ± 1.1 | 0.72 | 287.0 ± 2.6 | 419.9 ± 2.8 |
| P(Me-ω-OHC13)_{14.1k} | −21.4 ± 1.3 | 0.71 | 300.0 ± 1.7 | 420.9 ± 2.7 |
| P(Me-ω-OHC13)_{20.6k} | −24.3 ± 1.0 | 0.70 | 311.2 ± 2.7 | 423.9 ± 2.4 |
| P(Me-ω-OHC13)_{30.3k} | −26.8 ± 0.8 | 0.69 | 335.4 ± 2.6 | 425.6 ± 2.1 |
| P(Me-ω-OHC18)_{17.5k} | −15.3 ± 1.3 | 0.71 | 292.0 ± 2.1 | 424.6 ± 1.4 |
| P(Me-ω-OHC18)_{24.6k} | −19 ± 0.9 | 0.69 | 302.9 ± 2.3 | 426.2 ± 1.6 |
| P(Me-ω-OHC18)_{30.2k} | −22.4 ± 1.6 | 0.69 | 330.6 ± 3.2 | 427.8 ± 1.7 |
| P(Me-ω-OHC18)_{34.7k} | −23.8 ± 1.4 | 0.68 | 344.3 ± 2.2 | 430.8 ± 1.5 |

Aliphatic polyesters as well as linear PE are non-quenchable to their amorphous states (X_{C}=0%), and are generally categorized into medium (X_{C}=30-60%) and highly crystalline (X_{C}=60-80%) classes of polymers for investigating their relaxation behavior. In linear PE, the high degree of crystallinity obscure the molecular motions due to the amorphous chains and therefore the assignment of T_{g} has long been a controversial topic. Based on the thermal expansion data for linear PE, recent studies established a linear relationship between T_{g} and X_{C} and suggested that T_{g} is determined by PE crystalline fraction.

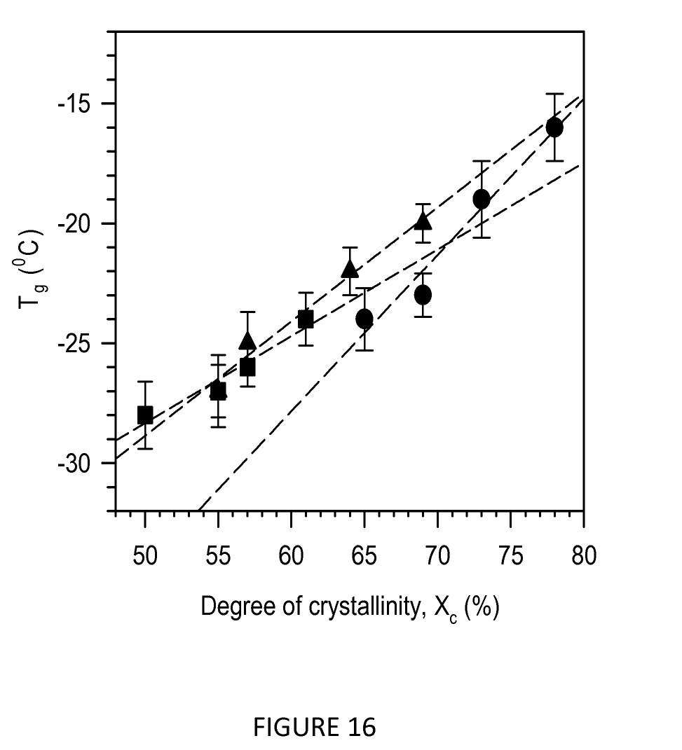

FIG. 16 displays the variation of T_{g} as a function of X_{C} for each P(Me-ω-OHFA). The increase observed for the three curves suggests that the rigid crystallites, as well as the interphase regions between the crystalline and amorphous regions (tie molecules), stiffen the amorphous chains thus raising T_{g}. For P(Me-ω-OHC9), P(Me-ω-OHC13) and P(Me-ω-OHC18), the linear fits (R²>0.9709) of T_{g} data yielded slopes of 0.36±0.06, 0.48±0.05, and 0.65±0.09° C. per % of X_{C}, respectively. Earlier, from FIG. 2, it has been found that X_{C} for all three P(Me-ω-OHFA)s decreases at significantly similar rates (˜0.71±0.16) with 4. Therefore the variation of the rate of increase in T_{g} of P(Me-ω-OHFA)s due to X_{C} cannot be due to M̅ₙ effects, but rather related to the increased n (8 to 12 and 17 for P(Me-ω-OHC9), P(Me-ω-OHC13) and P(Me-ω-OHC18), respectively).

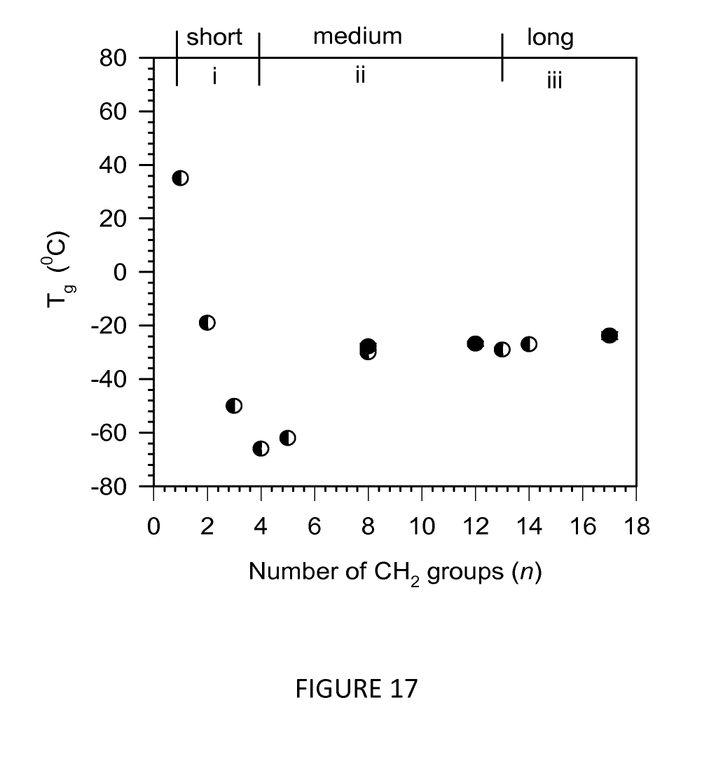

The fact that T_{g} is dependent on the technique employed for its determination as well as the thermal processing conditions (rate of cooling or heating), dictate that it is rather described by a range of temperatures. However, the plot of our T_{g} data with those reported in the literature for the different homologues, showed a clear trend. The variation of T_{g} of polyesters of the [—(CH₂)ₙ—COO—] homologous series shown in FIG. 17, for instance, is remarkably similar to Tₘ. The three regions observed in the variation of Tₘ with n (FIG. 16) can also be identified. Recognizing that the increase of T_{g} with increasing n (˜±5° C., see Table 9) is within the uncertainty level for such comparison, one can locate the plateau reached by T_{g} for the relatively long chain polyester homologues.

Furthermore, T_{g}/Tₘ of the P(Me-ω-OHFA)s varied between 0.6-0.7 (Table 9) in very good agreement with the empirical Boyer-Beaman rule (Equation 5),

T_{g}=(0.5 to 0.7)×Tₘ (5)

For isothermal crystallization, T_{g}/Tₘ is directly correlated to the maximum attainable crystalline fraction, X_{C}, max, which is a rough indicator of intrinsic crystallizability of polymers.

A similar approach based on the balance of competing effects can be brought forward to explain both T_{g} and Tₘ in regards to chain length of the monomeric unit since the same factors, namely, chain stiffness and inter-chain cohesive forces, affecting Tₘ also influence T_{g}. For the short chain polyesters (n=1 to 5), the observed initial decrease of T_{g} with increasing n (FIG. 17) could be explained by the decreasing amorphous chain cohesive energies due to the ester groups similarly to Tₘ. The increase observed for medium chain polyesters (n=5-13) is attributable to the topological constraints imposed on these amorphous chains due to predominant crystallization effects from the methylene group (which increase with increasing n). For the long chain polyesters (n≧13), T_{g} plateaued at ˜−24° C. probably because crystallinity effects due to the “strength” of the crystallites (defined by Tₘ which also plateaued in this region) fail to induce any detectable variation of the segmental motions of the amorphous polyester chains. Furthermore, the inter chain cohesive forces due to the ester groups in the amorphous chains of the long chain polyesters were probably not sufficient to alter T_{g}.

### Thermal Decomposition Properties of P(Me-ω-OHFA)s:

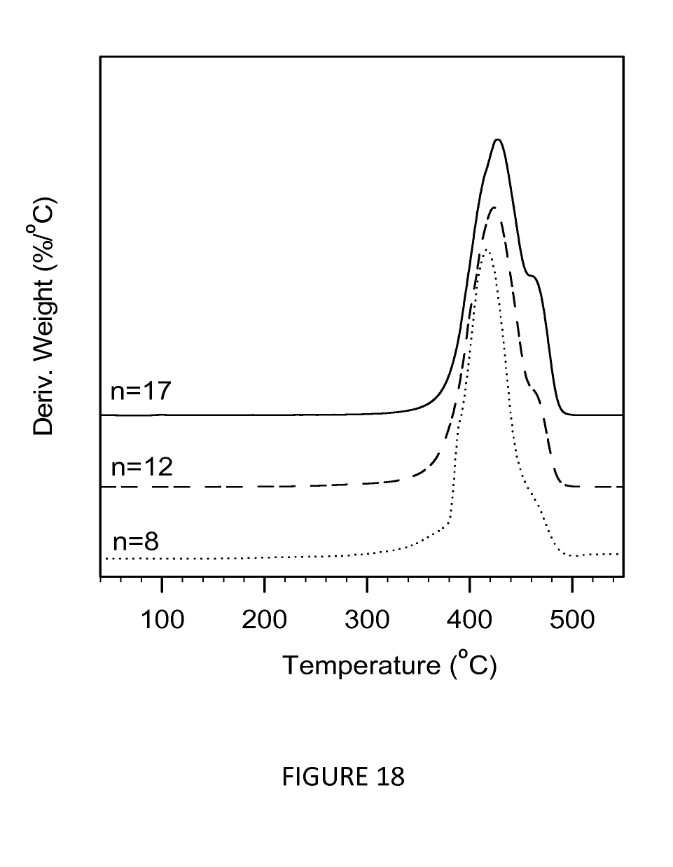

The thermal decomposition of P(Me-ω-OHFA) samples was investigated by TGA. FIG. 18 displays the TGA derivative (DTG) of P(Me-ω-OHC9)_{28.4k} (n=8), P(Me-ω-OHC13)_{30.3k} (n=12) and P(Me-ω-OHC18)_{34.7k} (n=17). The single prominent peak in the DTG traces is evidence of a single step degradation process initiated by the random scission of the ester linkage at the alkyl-oxygen bonds at temperatures around 360° C.-440° C.

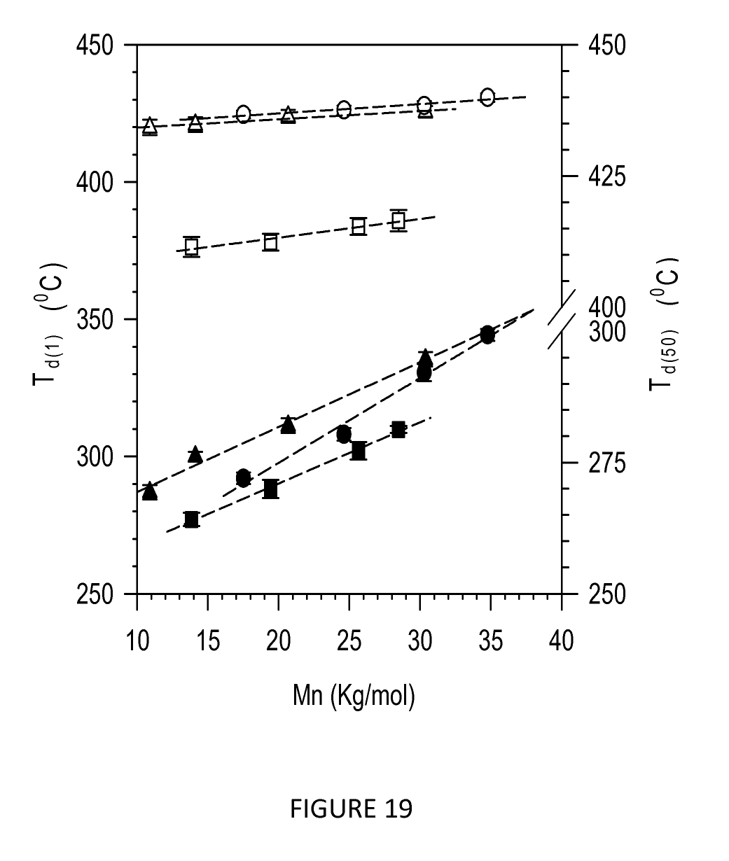

The onset degradation temperature, defined at 1% weight loss (T_{d(1)}), and the temperature at 50% weight losses (T_{d(50)}) are listed in Table 3. T_{d(1)} is a direct measure of thermal stability, and is a crucial parameter for the melt-processing of thermoplastics. The noticeable effects of M̅ₙ and n on T_{d(1)} and T_{d(50)} are illustrated in FIG. 19. T_{d(1)} (▪: n=8, ▴: 12 and : 17 in FIG. 19), and T_{d(50)} (□: n=8, Δ: 12 and ◯: 17 in FIG. 19) of the P(Me-ω-OHFA)s increased linearly with M̅ₙ in the 10-40 kg/mol range of molecular weight. For P(Me-ω-OHC9), P(Me-ω-OHC13) and P(Me-ω-OHC18), the fit to straight lines of T_{d(1)} data yielded slopes of 2.2±0.1, 2.4±0.2, and 3.1±0.3° C. per kg/mol, respectively, and that of T_{d(50)} data yielded slopes of 0.36±0.05, 0.30±0.05, and 0.34±0.06° C. per kg/mol, respectively. The variation of the rate of increase in thermal stability of P(ω-OHFA)s due to M̅ₙ can be directly related to the ester group content (20%, 14% and 10% for P(Me-ω-OHC9), P(Me-ω-OHC13) and P(Me-ω-OHC18), respectively). The lower slope values obtained for T_{d(50)} compared to T_{d(1)} indicates a lesser influence of M̅ₙ of the P(Me-ω-OHFA)s on T_{d(50)}. The average T_{d(50)} values calculated for P(Me-ω-OHC9), P(Me-ω-OHC13) and P(Me-ω-OHC18) are 413.9±1.2, 422.5±1.3, and 427.3±1.3° C., respectively.

T_{d(50)} can be related to the chemical structure of the polymer. Recent studies based on molar additive group contribution methods, established an empirical relationship between the temperature at half decomposition (T_{d(50)}) of the polymer and the [—(CH₂)ₙ—COO—] repeat unit molecular weight (M) through a molar thermal decomposition function (Y_{d(50)}) (Equation 6),

$${T}_{d ( 50 )} = \frac{{Y}_{d ( 50 )}}{M} \qquad ( 6 )$$

As is the case with aliphatic polyesters, T_{d(50)} values of the P(Me-ω-OHFA)s coincided with their maximum decomposition temperature (T_{d(max)}, from DTG). The actual T_{d(max)} values are of major practical importance as the aliphatic polyesters of the ([—(CH₂)ₙ—COO—]) homologous series are rarely intended for high temperature applications. T_{d(max)}, however, being independent of molecular effects, is a good indicator of the effect of n on the thermal decomposition.

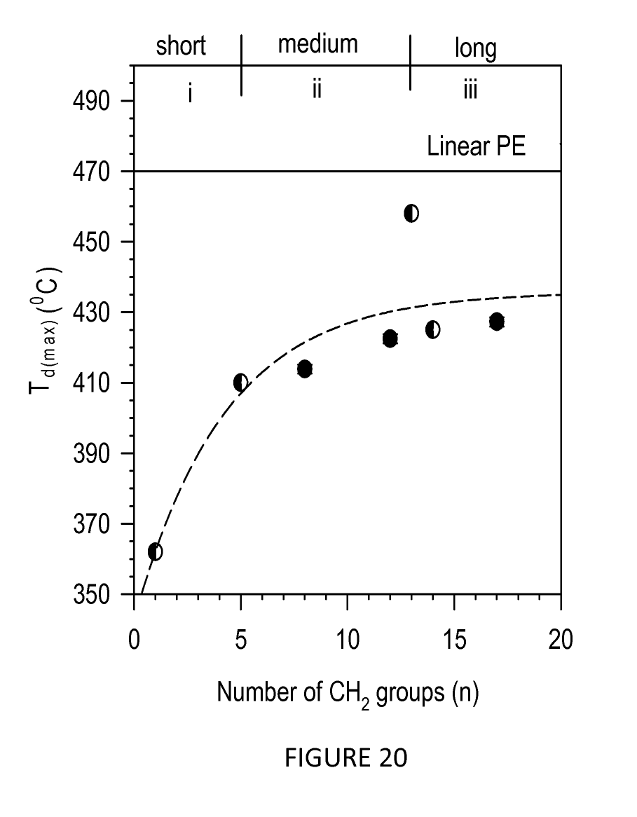

FIG. 20 compares T_{d(max)} reported for industrially relevant polyester homologues, such as n=1[PGA], n=5 [PCL], n=13 [P(ω-OHC14)], n=14 [PPDL], =15 [HPDL] (half-filled symbols), with P(Me-ω-OHFA)s (filled symbols) of the present study. The three temperature regions that were identified in the variation of T_{g} and Tₘ with n (FIGS. 14 and 17) are reported in FIG. 20. T_{d(max)} versus n curve can be depicted by an exponential rise to a maximum of ˜430° C. This plateau is slightly lower than the decomposition temperature of HDPE (horizontal line at ˜470° C. in FIG. 20). The plateauing of T_{d(max)} for the long chain polyesters ([—(CH₂)ₙ—COO—]ₓ) (n>13) indicates a balancing of the competing thermal stability effects between the strong C—C bonds due to aliphatic methylene groups (n), and the weak hetero atomic C—O bond of the ester moiety. There is no T_{d(max)} data for polyesters with chains longer than n=17 and no evidence that the balance of interactions at the origin of the plateau holds beyond.

### Mechanical Properties of P(Me-ω-OHFA)s:

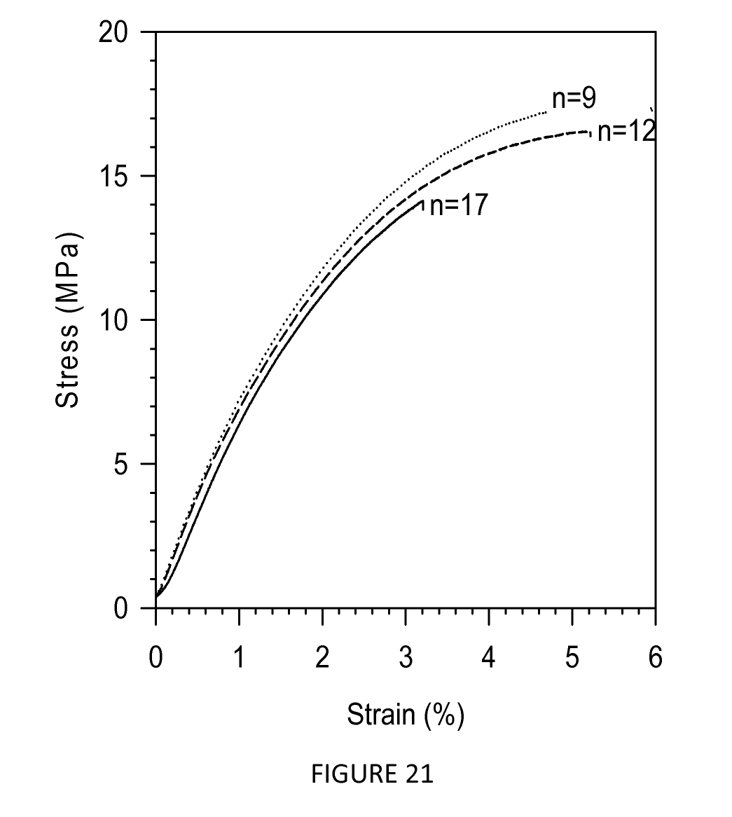

P(Me-ω-OHFA)s exhibited a stress-strain behavior typical of high modulus and brittle plastics, irrespective of M̅ₙ and n. FIG. 21 shows the stress-strain curves for P(Me-ω-OHC9)_{28.4k}, P(Me-ω-OHC13)_{30.3k} and P(Me-ω-OHC18)_{34.7k}. For all three samples, stress varied rapidly with strain prior to a brittle fracture at percentage strain values of less than 10%.

The various mechanical properties of the P(Me-ω-OHFA)s are listed in Table 10. The stiffness of P(Me-ω-OHFA)s, as represented by Young's modulus (YM), decreased with increasing M̅ₙ (Table 10). These are good values and are particularly acceptable for medical grade applications.

TABLE 10
Tensile properties of P(Me-ω- OHFA)s. Elongation at break
(EB), Ultimate strength (TS) and Young's modulus (YM).

| | EB | TS | YM |
|---|---|---|---|
| Sample | (%) | (MPa) | (MPa) |
| P(Me-ω-OHC9)_{13.8k} | 1.4 ± 0.2 | 10.3 ± 1.1 | 653 ± 11 |
| P(Me-ω-OHC9)_{19.4k} | 1.9 ± 0.5 | 13.6 ± 1.0 | 641 ± 10 |
| P(Me-ω-OHC9)_{25.6k} | 3.3 ± 0.3 | 14.4 ± 1.3 | 613 ± 9 |
| P(Me-ω-OHC9)_{28.4k} | 4.1 ± 0.5 | 18.4 ± 0.5 | 593 ± 14 |
| P(vω-OHC13)_{10.8k} | 3.4 ± 0.3 | 13.1 ± 0.7 | 668 ± 12 |
| P(Me-ω-OHC13)_{14.1k} | 4.1 ± 0.4 | 15.1 ± 0.9 | 671 ± 9 |
| P(Me-ω-OHC13)_{20.6k} | 5.4 ± 0.3 | 16.2 ± 0.7 | 645 ± 11 |
| P(Me-ω-OHC13)_{30.3k} | 5.9 ± 0.2 | 18.4 ± 0.5 | 629 ± 13 |
| P(Me-ω-OHC18)_{17.5k} | 1.3 ± 0.1 | 9.2 ± 1.7 | 693 ± 18 |
| P(Me-ω-OHC18)_{24.6k} | 1.7 ± 0.2 | 12.0 ± 1.6 | 680 ± 8 |
| P(Me-ω-OHC18)_{30.2k} | 2.3 ± 0.4 | 16.2 ± 0.9 | 665 ± 9 |
| P(Me-ω-OHC18)_{34.7k} | 3.0 ± 0.3 | 18.1 ± 1.2 | 646 ± 10 |

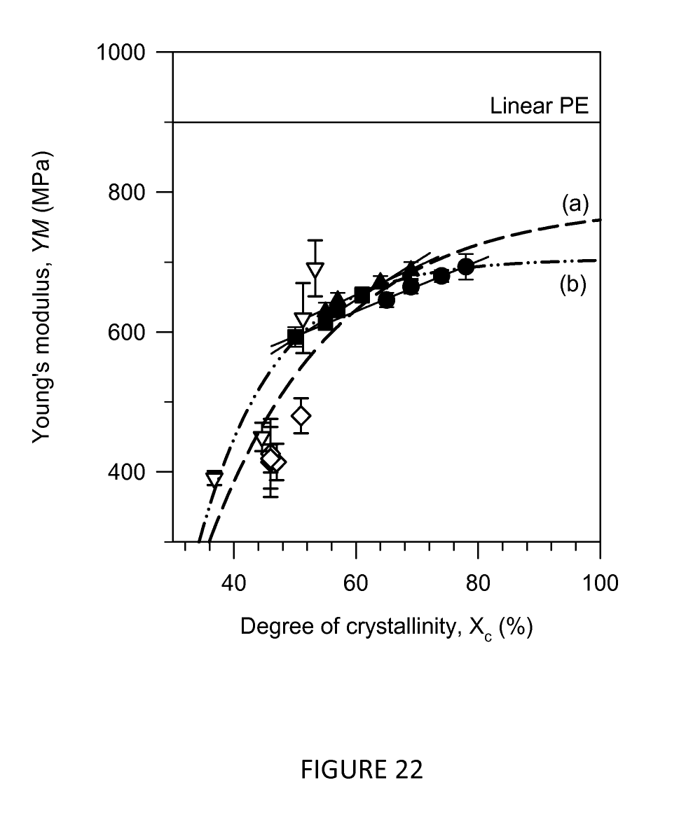

Several studies have indicated that the degree of crystallinity is the primary factor affecting YM of semi-crystalline polymers, including linear PE. FIG. 22 illustrates the dependence of YM on X_{C} for P(Me-ω-OHFA)s of the present study (filled symbols), and for similar long chain aliphatic polyesters [—(CH₂)ₙ—COO—], such as PPDL (n=14), P(ω-OHC14) (n=13) (open symbols).

YM of the P(Me-ω-OHFA)s, increased linearly with X_{C} (solid lines in FIG. 22). Furthermore, the linear relationship established earlier between M̅ₙ and X_{C} (FIG. 11) suggest that YM decreased with increasing M̅ₙ in the studied 10-40 kg/mol range of molecular weight. The effect of M̅ₙ and X_{C} on YM is similar to that observed for linear PE. Comparatively, the stiffness of the P(Me-ω-OHFA)s of the present study varied only marginally (within 100 MPa) in the available range of X_{C} (45-80%).

The behavior of YM of the P(Me-ω-OHFA)s is also consistent with the trend exhibited by other long chain polyesters such as P(Me-ω-OHFC14) (n=13) and PPDL (n=14) reported in the literature. Interestingly, when the data from the literature is included, the general trend suggested by YM versus X_{C} (FIG. 22), points to a rise to a maximum function. Tentative fits of all the data in FIG. 22 to an exponential rise to a maximum function yielded asymptotic values between ˜700 to 770 MPa. This range of maximum value is due to the large uncertainties attached to YM and to the relatively small windows of crystallinity provided in the literature for P(Me-ω-OHFC14) (n=13) and PPDL (n=14). However, these are still lower than IM of HDPE which varies between 900-1200 MPa depending on molecular weight.

This type of correlation (represented in FIG. 22) is of noticeable significance as it allows for a good estimation of the stiffness of polyesters of the [—(CH₂)ₙ—COO—] homologous series and its control based on chain length.

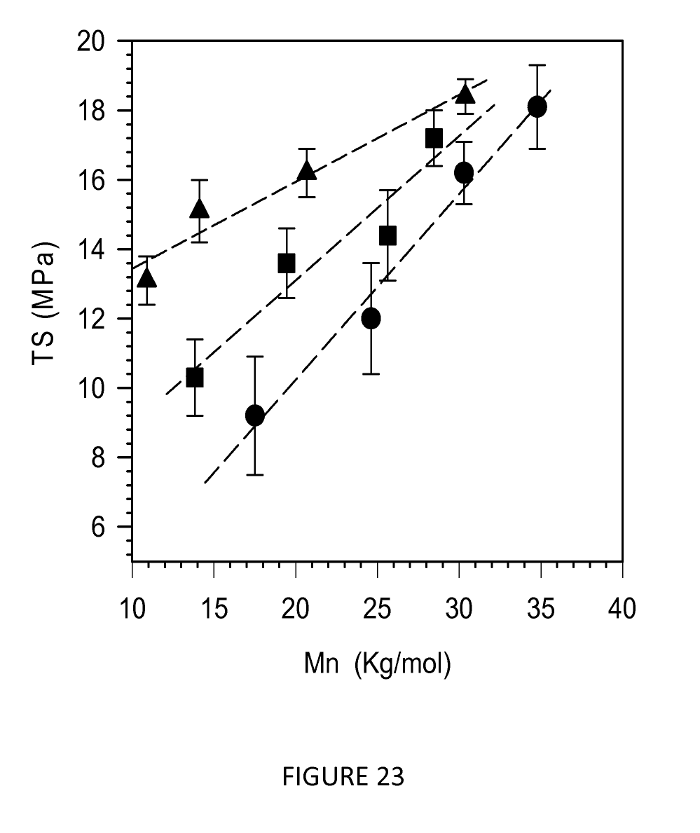

It is interesting to note (Table 10) that elongation at break (EB) and ultimate strength (TS) of P(Me-ω-OHC9)_{28.4k}, P(Me-ω-OHC13)_{30.3k} and P(Me-ω-OHC18)_{34.7k}, which have similar M̅ₙ but varying “strength” (Tₘ, Table 10) and varying crystalline fraction (X_{C}, Table 8), remained significantly constant. TS and EB, however, increased with M̅ₙ. TS of the P(ω-OHFA)s displayed a linear increase as a function of M̅ₙ in the studied 10-40 kg/mol range of molecular weight (dashed lines in FIG. 23). This is attributed to the increasing number of interlamellar connections (tie molecules) available for transmitting forces between the rigid crystallites as M̅ₙ is increased. The amount of tie molecules, however, is not high enough to sustain a ductile failure in the range of the crystallinities of the polyesters studied here, as is evident from the increasing, but still lower EB values (<10%) of the higher molecular weight P(Me-ω-OHFA)s. It is clear that similar to linear PE, the high strain properties of brittle P(Me-ω-OHFA)s, such as TS and EB, are predominantly governed by the molecular parameters ( M̅ₙ and PDI) rather than the crystalline structure.

As a general recap, renewable poly(ω-hydoxyfatty ester)s (P(Me-ω-OHFA)s) with medium (n=8, 12) and long methylene chain lengths (n=17) and varying molecular weight ( M̅ₙ: 10000 to 40000 g/mol) were successfully prepared by the melt polycondensation of ω-hydroxy fatty ester monomers derived from vegetable oil. The thermal stability, transition behavior, mechanical properties and crystallinity, examined by TGA, DSC, DMA and tensile analysis, and WAXD, respectively, were related in a predictive manner to chemical (n) and molecular ( M̅ₙ and PDI) structure. The physical properties of the P(Me-ω-OHFA)s were discussed in the context of the [—(CH₂)ₙ—COO—]ₓ polyester homologous series and contrasted with linear PE.

All the P(Me-ω-OHFA)s presented an orthorhombic crystal phase reminiscent of linear PE with crystallinity (X_{C}) depending strongly on M̅ₙ. The polymers with larger n presented thermodynamically more stable and thicker crystals as clearly indicated by the significant increase observed in Tₘ. As expected, and for similar Mₙ, X_{C} was higher for the longer chains, corroborating the variation of enthalpy of melting. X_{C} was proven to be a crucial parameter in determining the physical properties of the polyesters. For the samples examined in this study, strong correlations were established between the glass transition temperature (T_{g}) and Young's modulus (YM) and X_{C}. Elongation at break (EB) and ultimate strength (IS) increased with increasing M̅ₙ. EB and TS increased with n and tended to significantly similar values for the highest molecular weights, indicating the brittle nature of the samples.

The variations of Tₘ and T_{g} of the P(Me-ω-OHFA)s, including data of polyesters of the [—(CH₂)ₙ—COO—] homologous series mined from the literature, as a function of n are remarkably similar. After an initial steep decrease observed for the short aliphatic polyesters (n≦5), both Tₘ and T_{g} reached a minimum then increased gradually with n for the medium chains (n=5-13) and reached a plateau for longer chain polymers (n≦13). Similar arguments based on the balance of competing effects were invoked to explain this trend. The variation of Tₘ is attributable to the competition between the cohesive energies due to the ester groups, which decrease with increasing n, and the chain stiffness as well as inter-chain packing efficiencies, which increases with increasing n, as the polymer chains become more “PE-like”. The trend observed for T_{g} is the result of a competition between the contributions of the amorphous inter-chain cohesive energies, the topological constraints imposed on the amorphous chains due to predominant crystallization effects from the methylene group and their impact on the “magnitude” of the segmental motions of the amorphous polyester chains.

The thermal stability of the P(Me-ω-OHFA)s, as directly measured by the onset degradation temperature (T_{d(1)}), was noticeably affected by M̅ₙ and n. The variation of the rate of increase in thermal stability due to M̅ₙ has been directly related to the decrease in ester group content. The temperature at which the degradation was fastest (T_{d(max)}) coincided very well with the degradation temperature measured at 50% weight loss, a parameter usually linked to the chemical structure of the material. T_{d(max)} versus n curve demonstrated an exponential rise to a maximum function with a plateau that is slightly lower than the decomposition temperature of linear PE. The plateau is thought to be achieved through a balance between competing thermal stability effects, i.e., the strong C—C bonds, due to aliphatic methylene groups, and the weak hetero atomic C—O bond of the ester moiety.

Medium and long chain polyesters made from renewable feedstock such as the P(Me-ω-OHFA)s of the present study have a great potential for many targeted industrial applications, particularly those requiring biodegradability and biocompatibility such as biomedical implants and scaffolds. Furthermore, the predictive structure-relationships established in this study can be used to easily custom engineer such materials.

Co-Polymerization of Certain P(Me-ω-OHFA)s:

The present effort also focused on the preparation and solid-state characterization of certain copolyesters, such as poly(ω-hydroxy nonanoate/ω-hydroxy tridecanoate) [—(CH₂)₁₃—COO—/—(CH₂)₈—COO—]ₓ random co-polyesters derived from vegetable oil. Poly(ω-hydroxy nonanoate/ω-hydroxy tridecanoate) were obtained by the melt polycondensation of methyl-13-hydroxytridecanoate (Me-ω-OHC13) and methyl 9-hydroxynonanoate (Me-ω-OHC9) synthesized from unsaturated fatty acids. The various physical properties of co-polyesters were investigated as a function of co-polyester composition.

### General Materials and Preparation:

Ti(IV) isopropoxide (99.99% purity), 1-butanol (99.98% purity) and [(Methoxycarbonyl)methyl]phosphonic acid diethyl ester (MDPA) (99.99% purity) were purchased from Sigma-Aldrich. The reagents were used without further purification. The monomers (Me-ω-OHC9) (96.5% purity), (Me-ω-OHC13) (97% purity) were synthesized in our laboratories.

Poly(ω-hydroxy nonanoate/ω-hydroxy tridecanoate) P(-Me-ω-OHC13-/-Me-ω-OHC9-) random copolyesters with varying molar compositions were prepared from (Me-ω-OHC9) and (Me-ω-OHC13) using a two-step melt condensation procedure. The co-polymerization was conducted in a stainless steel reactor equipped with a mechanical stirrer, nitrogen inlet, gas outlet, a thermocouple, and pressure gauge. 50 mmol of the monomer mixture with varying (Me-ω-OHC9): (Me-ω-OHC13) ratios were mixed with 300 ppm of catalyst solution (10 mg/mL Ti(OiPr)₄ in 1-butanol) in the reactor. The reaction mixture was initially heated at 130° C. for 1 hour with continuous stirring under N₂ flow at atmospheric pressure. The temperature was subsequently raised and maintained at 160° C. for 2 hours, followed by another 3 hours at 180° C. under the same reaction conditions. MDPA (0.005 moles/moles of ester monomer) was added at this stage. The reaction mixture was further heated at 210° C. under reduced pressure (<0.1 torr) for 1 h followed by another 30 minutes at 220° C. so as to remove traces of methanol by-product. The solid samples were molded to films on a Carver 12-ton hydraulic heated bench press (Model 3851-0, Wabash, Ind., USA) at a controlled cooling rate of 5° C./minute. Selected copolymer compositions were further polymerized at 230° C. for 30 minutes to increase the PDI so that films suitable for tensile analysis could be molded.

### Characterization Techniques:

¹H NMR was used to determine the co-polyester structure and molar compositions. The spectra were recorded at a Larmor frequency of 400 MHz, using a Varian Unity 400 NMR spectrometer (Varian, Inc., Walnut Creek, Calif., USA). Gel Permeation Chromatography (GPC) was used to determine the number average molecular weight (Mn), weight-average molecular weight (Mw) and polydispersity index (the distribution of molecular mass, PDI=Mw/Mn). GPC tests were carried out on a Waters Alliance (Milford, Mass., USA) e2695 pump, Waters 2414 refractive index detector and a Styragel HR5E column (5 μm). Chloroform was used as eluent with a flow rate of 0.5 mL/min. The sample was made with a concentration of 2 mg/mL, and the injection volume was 30 ul for each sample. Polystyrene (PS, #140) Standards were used to calibrate the curve.

Calorimetric studies of the synthesized co-polymers were performed on a DSC Q200 (TA instrument, Newcastle, Del., USA) following the ASTM E1356-03 standard procedure under a dry nitrogen gas atmosphere. The sample was first heated to 110° C. (referred to as the first heating cycle), and held at that temperature for 5 min to erase the thermal history; then cooled down to −50° C. with a cooling rate of 5° C./minute. The sample was heated again (referred to as the second heating cycle) with a constant heating rate of 3° C./minute from −50° C. to 160° C. During the second heating cycle, measurements were performed with modulation amplitude of 1° C./minute and a modulation period of 60 seconds.

Thermogravimetric Analysis was carried out using a TGA Q500 (TA instrument, Newcastle, Del., USA.). Samples were heated from room temperature to 600° C. under dry nitrogen at constant heating rate of 10° C./minute.

Viscoelastic behavior of the PEUs was studied by performing dynamic temperature sweeps in a dynamic mechanical analyzer (TA instrument, DMA Q800) equipped with a liquid nitrogen cooling system. Rectangular polymer films (17.5 mm×12 mm×0.6 mm) were analyzed in a dual cantilever-bending mode following the ASTM D7028 standard procedure at a frequency of 1 Hz and fixed oscillation displacement of 15 μm. The samples were heated under a constant rate of 1° C./minute over a temperature range of −90° C. to 80° C.

The static mechanical properties of the synthesized polymer films were determined at room temperature using a Texture Analyzer (Texture Technologies Corp, NJ, USA) following the ASTM D882 procedure. The sample was stretched at a rate of 5 mm/minute from a gauge of 35 mm.

The crystalline structure of co-polyesters was examined by wide-angle X-ray diffraction (WAXD) on an EMPYREAN diffractometer system (PANanalytical, The Netherlands) equipped with a filtered Cu-Kα radiation source (λ=1.540598 Å) and a PIXcel^{3D} area detector. Copolyester samples were crystallized from the melt at a controlled cooling rate of 5° C./minute. The scanning range was from 3.3° to 35° (2θ) with a step size of 0.013°; 2414 points were collected in this process. The deconvolution of the spectra, and data analysis were performed using PANanalytical's X'Pert HighScore 3.0.4 software. The degree of crystallinity was estimated according to a well-established procedure. The percentage degree of crystallinity (X_{C}) is given by equation (7),

$${X}_{C} = 100 \times \frac{{A}_{C}}{{A}_{C} + {A}_{A}} \qquad ( 7 )$$

where A_{C} is the area under the resolved crystal diffraction peaks and A_{A}, the area of the amorphous contribution halo.

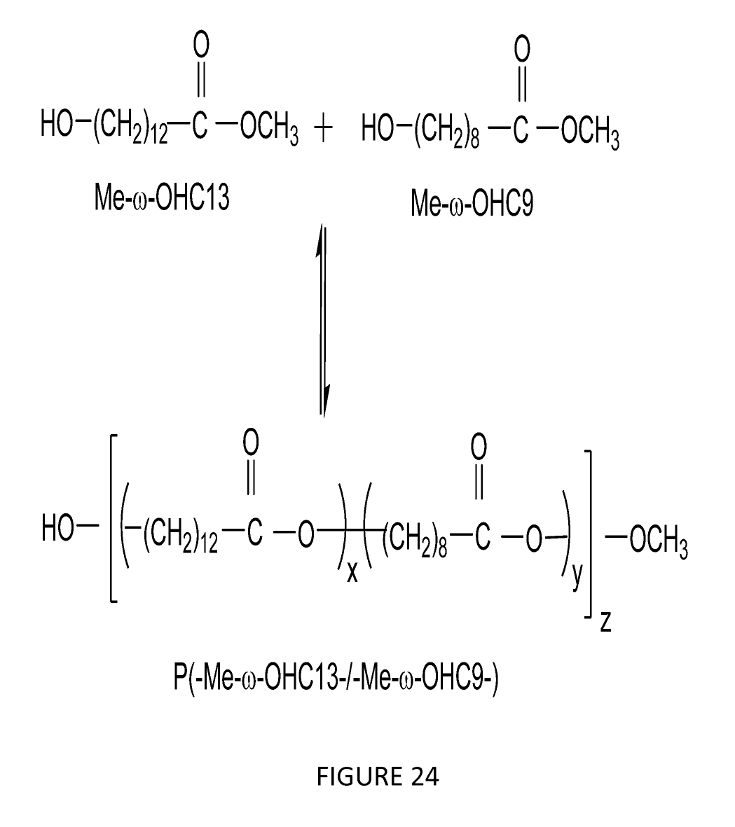

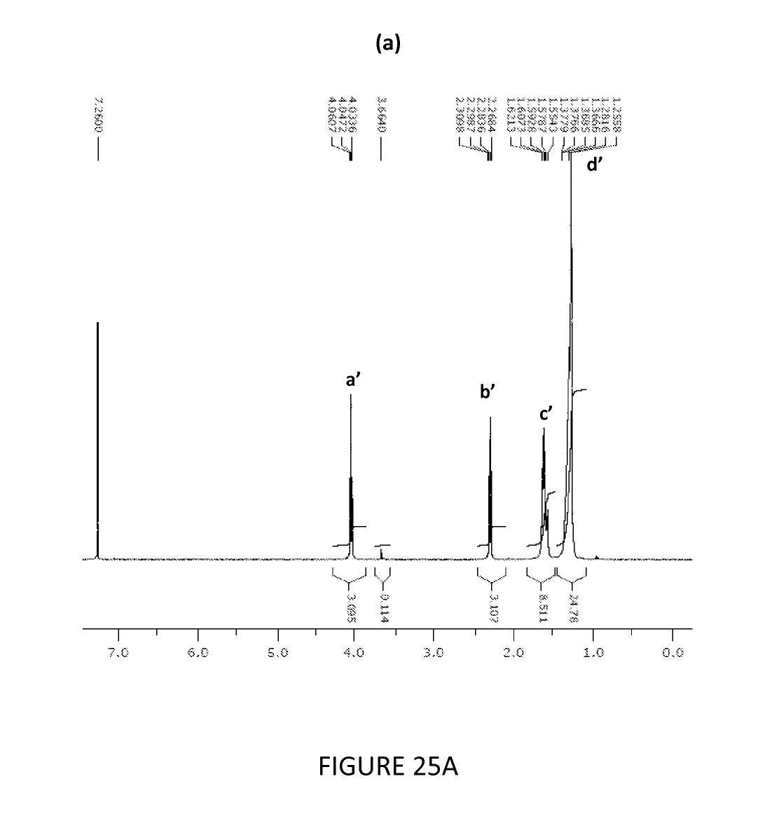

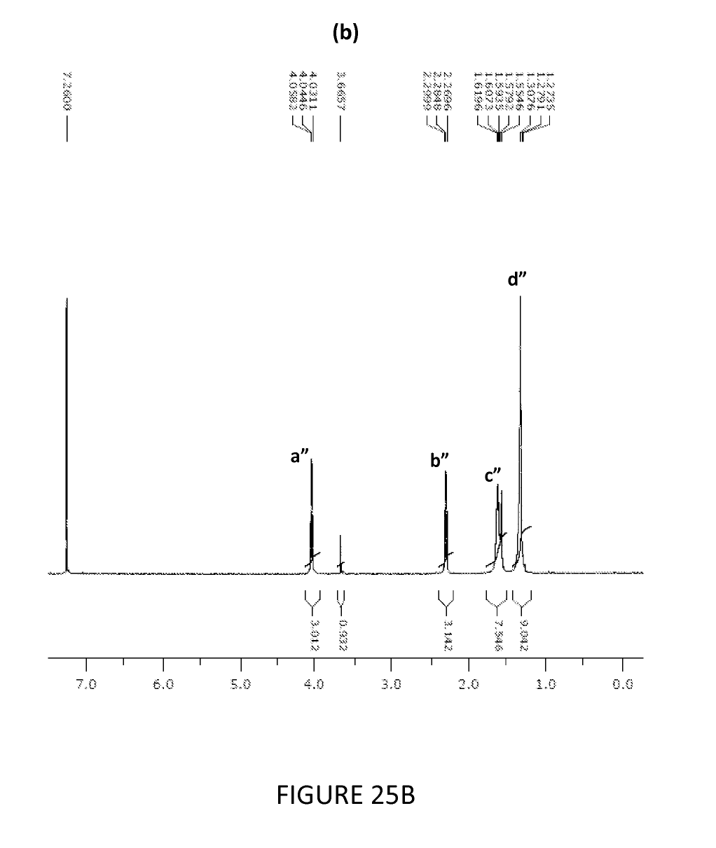

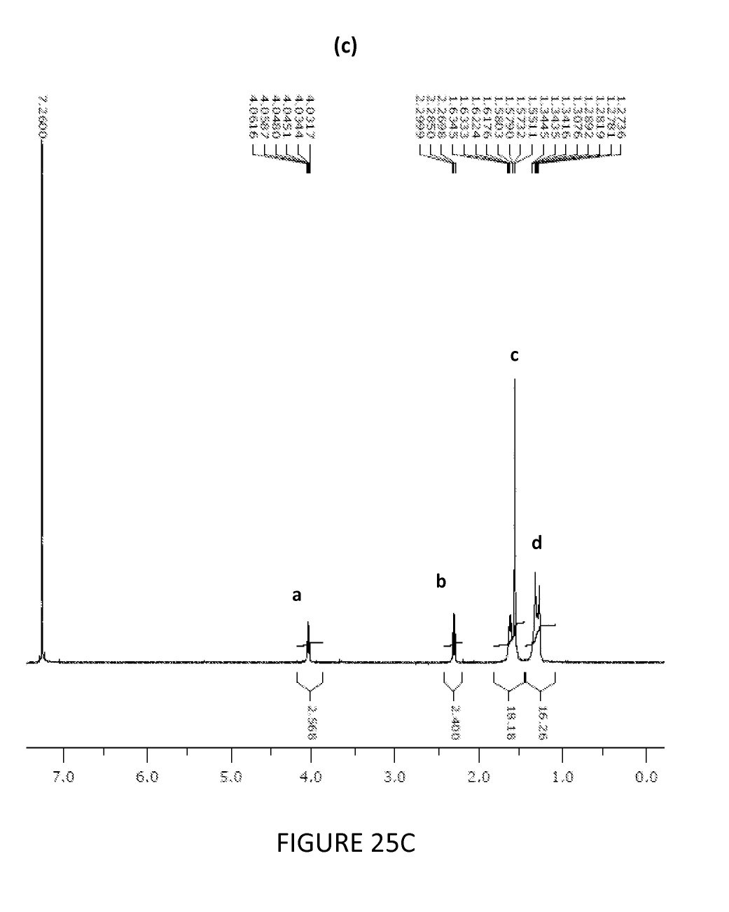

The general reaction scheme for the polycondensation of (Me-ω-OHC13) and (Me-ω-OHC9) monomers is shown in FIG. 24. The composition of the co-polyesters was estimated from ¹HNMR using the relative intensities of the proton peaks arising from (Me-ω-OHC13) and (Me-ω-OHC9) comonomer units. FIGS. 25A, 25B, and 25C show the ¹HNMR spectra for the two homopolymers, P(Me-ω-OHC9) and P(Me-ω-OHC13), and 50/50 w/w copolymer (reactor feed composition). The spectra of P(Me-ω-OHC9) and P(Me-ω-OHC13) are similar, i.e., they showed a triple peak at 4.06-4.09 ppm attributed to the 2 protons of Me-ω-OHC9 and Me-ω-OHC13 (FIG. 25A and FIG. 25B). The triple peak at 2.28-2.36 ppm is attributed to the 2 protons marked as b′ and b″ in FIGS. 25A and 25B. Another triple peak at 1.6-1.64 ppm is attributed to the 2 protons marked as c′ and c″ in FIGS. 25A and 25B, and the multiple peak between 1.20-1.34 ppm corresponding to 10 and 18 protons are marked as d′ and d″ in FIGS. 25A and 25B. The peak positions in the ¹HNMR spectra for co-polymers (example, FIG. 25C) were identical to those for the homopolymers. The mole fractions of Me-ω-OHC9 (X) and Me-ω-OHC13 (Y) units in the copolymer were then determined using equation 8 by considering X+Y=1.

$$( \frac{{d}^{′}}{{a}^{′} + {b}^{′}} ) X + ( \frac{{d}^{″}}{{a}^{″} + {b}^{″}} ) Y = \frac{d}{a + b} \qquad ( 8 )$$

where a′-d′, a″-d″ and a-d also represent the areas of corresponding peaks for P(Me-ω-OHC9), P(Me-ω-OHC13) and the 50/50 w/w co-polyester, respectively (FIGS. 25A, 25B, and 25C). The results are summarized in Table 11. There is a significant deviation from the feed composition. This is probably caused by the relatively high volatility of Me-ω-OHC9 compared to Me-ω-OHC13 during polycondensation performed under high vacuum conditions.

The molecular weight distribution for homopolyesters and P(-Me-ω-OHC13-/-Me-ω-OHC9-) copolyesters were determined by GPC (Table 11). The co-polyesters exhibited comparable molar masses in the range of 9000-19000 g/mol ( M̅ₙ).

TABLE 11
Composition of the fatty acid mixture in reactor feed, copolymer
composition determined by ¹H-NMR, number average ( M̅_{w}), weight average ( M̅ₙ)
molecular weights and PDI for copolymers determined from GPC.

| | | Me-ω-OHC13/Me- | | | | |
|---|---|---|---|---|---|---|
| | | ω-OHC9 | | | | |
| | Me-ω-OHC13/Me- | molar ratio in | | | | % COO |
| Sample | ω-OHC9 | co-polymer | M̅_{w} | M̅ₙ | | content |
| code | molar ratio in feed | (from ¹H-NMR) | (g/mol) | (g/mol) | PDI | (wt) |
| A1 | 100:0 | 100:0 | 24830 | 14606 | 1.7 | 13 |
| A2 | 80:20 | 94:6 | 32726 | 18408 | 1.8 | 13 |
| A3 | 70:30 | 85:15 | 20558 | 11742 | 1.8 | 14 |
| A4 | 50:50 | 71:29 | 24806 | 13255 | 1.9 | 14 |
| A5 | 30:70 | 48:52 | 18688 | 11934 | 1.6 | 15 |
| A6 | 20:80 | 43:57 | 20019 | 12059 | 1.7 | 16 |
| A7 | 0:100 | 0:100 | 15712 | 9936 | 1.6 | 17 |

### Physical Properties of Certain Copolyesters:

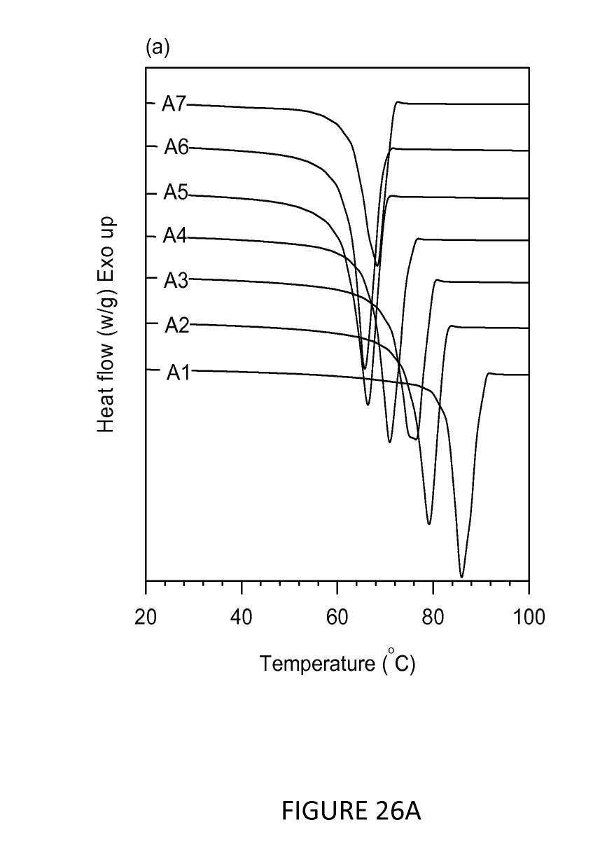

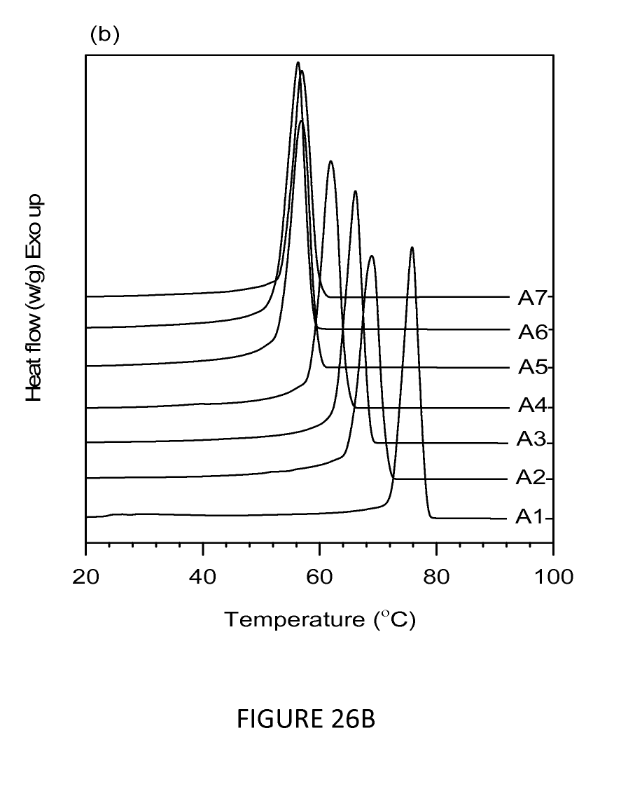

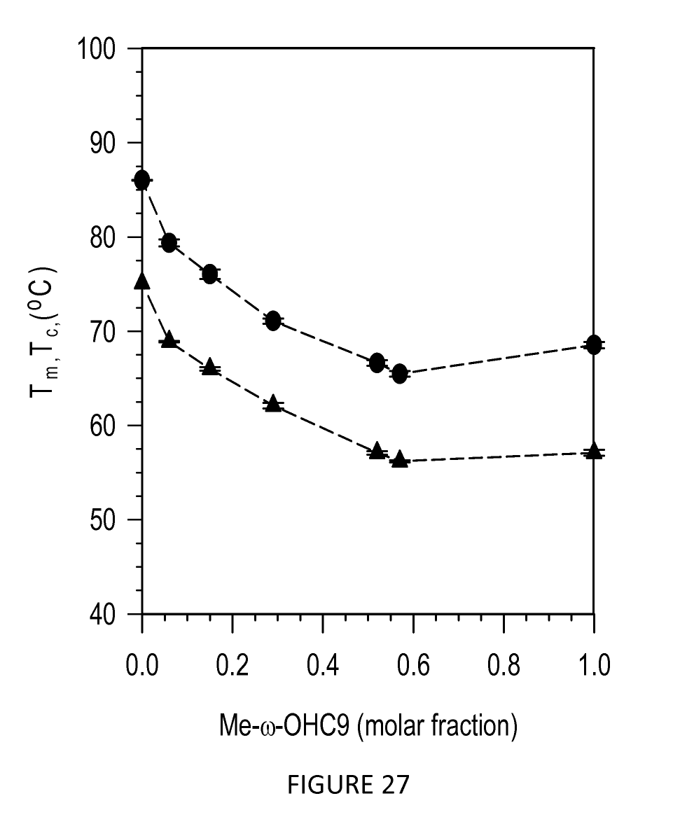

Melt transition behavior of random P(-Me-ω-OHC13-/-Me-ω-OHC9-) co-polyesters are described herein. The heating and cooling thermograms for the copolymer systems are shown in FIGS. 26A and 26B. All samples exhibited sharp single melting and crystallization peak, which may be a strong evidence of co-crystallization. The peak maxima for the highest melting P(Me-ω-OHC13) homopolymer (A1) shifted to lower temperature with the addition of increasing amounts of (Me-ω-OHC9) comonomer units (samples A2 to A7, FIG. 26A). The characteristic parameters obtained from DSC are summarized in Table 12. The copolyesters (A2-A6) melt at temperatures that are intermediate between their homopolymers. The melting point (Tₘ) of P(-Me-ω-OHC13-/-Me-ω-OHC9-) co-polyesters varied between 66 to 88° C. depending on molar composition. FIG. 27 displays the composition dependence of melting and crystallization temperatures for the co-polyesters. For P(-Me-ω-OHC13-/-Me-ω-OHC9-) samples (A5 and A6), with a 50:50 ratio of (Me-ω-OHC13): (Me-ω-OHC9) comonomer units, Tₘ differed only slightly (±5° C.) from that of P(Me-ω-OHC13) homopolymer (FIG. 27).

TABLE 12
Characteristic parameters of P(—Me-ω-OHC13—/—Me-ω-OHC9—)
copolymers obtained by DSC and WAXD. Onset, Tₒₙ, offset, T_{off} , peak temperature
of melting, Tₘ, and enthalpy of melting, ΔHₘ obtained from the second heating cycle,
degree of crystallinity, X_{C}, estimated from WAXD, and ΔH_{m(cryst)}, melting enthalpy per
gram of the crystal phase. The uncertainties attached to the characteristic
temperatures, enthalpies and degree of crystallinity are better than 0.5° C., 8 J/g and
5% respectively.

| | Cooling | | Second melting | | | |
|---|---|---|---|---|---|---|
| Sample | T_{c} | ΔH_{c} | Tₘ | | X_{c} | ΔH_{m(cryst)} |
| code | (° C.) | (J /g) | (° C.) | ΔHₘ (J/g) | (%) | (J/g_{cryst}) |
| A1 | 75.1 ± 0.0 | 139 ± 4 | 86.0 ± 0.0 | 158 ± 8 | 75 | 170 |
| A2 | 68.9 ± 0.1 | 128 ± 1 | 79.4 ± 0.4 | 140 ± 8 | 68 | 170 |
| A3 | 66.0 ± 0.2 | 130 ± 3 | 76.1 ± 0.5 | 126 ± 4 | 77 | 183 |
| A4 | 62.1 ± 0.3 | 131 ± 5 | 71.1 ± 0.2 | 134 ± 2 | 76 | 176 |
| A5 | 57.1 ± 0.2 | 128 ± 8 | 66.6 ± 0.3 | 132 ± 8 | 72 | 167 |
| A6 | 56.2 ± 0.1 | 126 ± 7 | 65.5 ± 0.3 | 131 ± 5 | 77 | 211 |
| A7 | 57.1 ± 0.3 | 97 ± 1 | 68.5 ± 0.3 | 115 ± 8 | 67 | 210 |

### Crystalline Structure of Co-Polyesters:

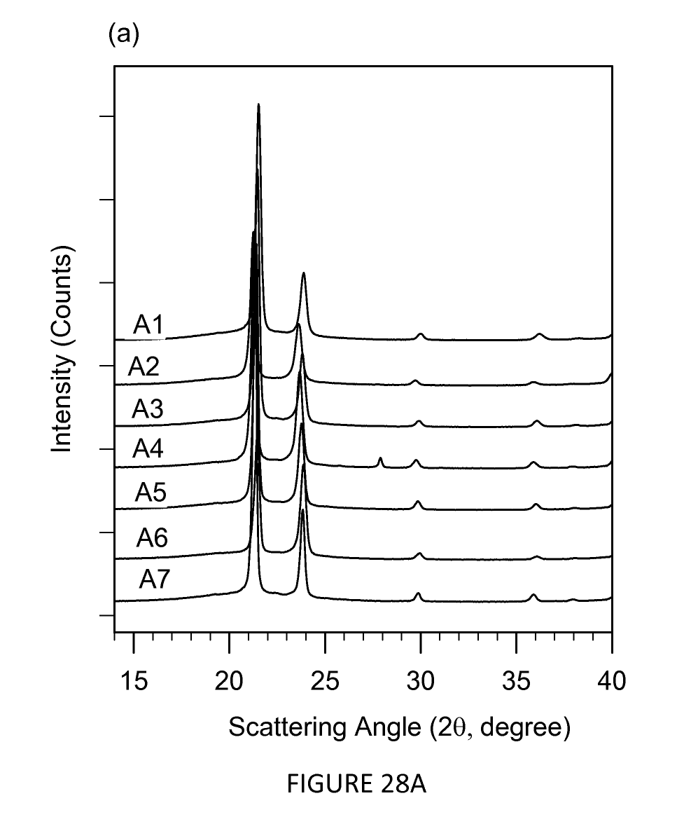

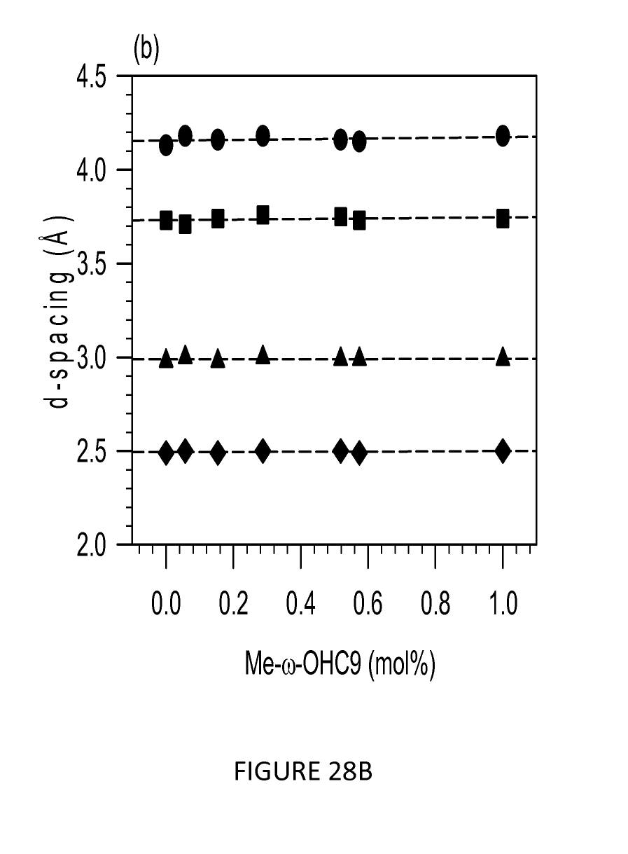

FIG. 28A shows the crystalline structures of P(ω-OHC9), P(ω-OHC13) homopolymers and P(-Me-ω-OHC13-/-Me-ω-OHC9-) copolymers investigated by wide-angle X-ray diffraction (WAXD). The analysis of the WAXD patterns was performed using a fitting module of HighScore Version 3.0. The amorphous contribution was added in the form of two wide lines (centered at ˜3.8 and 4.6 Å) as typically done for semi-crystalline polymers. The observed intensities were evaluated by integrating the crystalline peaks observed in the WAXD profiles. All samples exhibited sharp diffraction peaks over the entire copolymer composition range (FIG. 28A). The experimental WAXD profiles consisted of four resolved diffraction peaks, which are characteristic of a large crystalline phase, superimposed to a relatively small wide halo which are indicative of the presence of an amorphous phase. The homopolymers P(Me-ω-OHC9) and P(Me-ω-OHC13), as well as co-polyesters demonstrated similar WAXD spectra indicating that they crystallized in similar crystal forms. The sharp diffraction peaks observed in the WAXD patterns (FIG. 28A) are characteristic of the common orthorhombic methylene subcell packing and are reminiscent of that obtained for melt crystallized polyethylene (PE). The two very strong lines at 21.30-21.5 ° [2θ] and 23.89-24.02° [2θ] (d-spacing of 4.16±0.02 Å and 3.74±0.02 Å, respectively) originated from the 110 and 200 reflections of the orthorhombic subcell, respectively. The weaker peaks at d-spacing of 2.99±0.01 Å and 2.50±0.02 Å originated from the 210 and 020 reflections of the orthorhombic symmetry, respectively.

The variation of the d-spacing as a function of co-polyester composition is presented in FIG. 28B. For P(-Me-ω-OHC13-/-Me-ω-OHC9-)s (A2-A6) the d-spacing changes in a linear continuous manner with increasing content of (ω-OHC9) comonomer units. This is rather expected for co-crystallized systems where the repeating units of two homopolymers have similar crystal structure and their copolymers form a crystal phase whose lattice parameters gradually change with the composition from unit cell of one of the homopolymer to that of the other. The close similarity of crystal structure for (Me-ω-OHC9) and (Me-ω-OHC13) induces P(-Me-ω-OHC13-/-Me-ω-OHC9-)s to adopt polyethylene-like crystal structure, in agreement with early observations for poly (ε-caprolactone/ω-pentadecalactone) [—(CH₂)₅—COO—/—(CH₂)₁₄—COO—]ₓ random co-polyesters, which also co-crystallize into a common crystal lattice. The degree of crystallinity, X_{C} estimated for the copolyesters were high, ranging from 68% to 77% (Table 12).

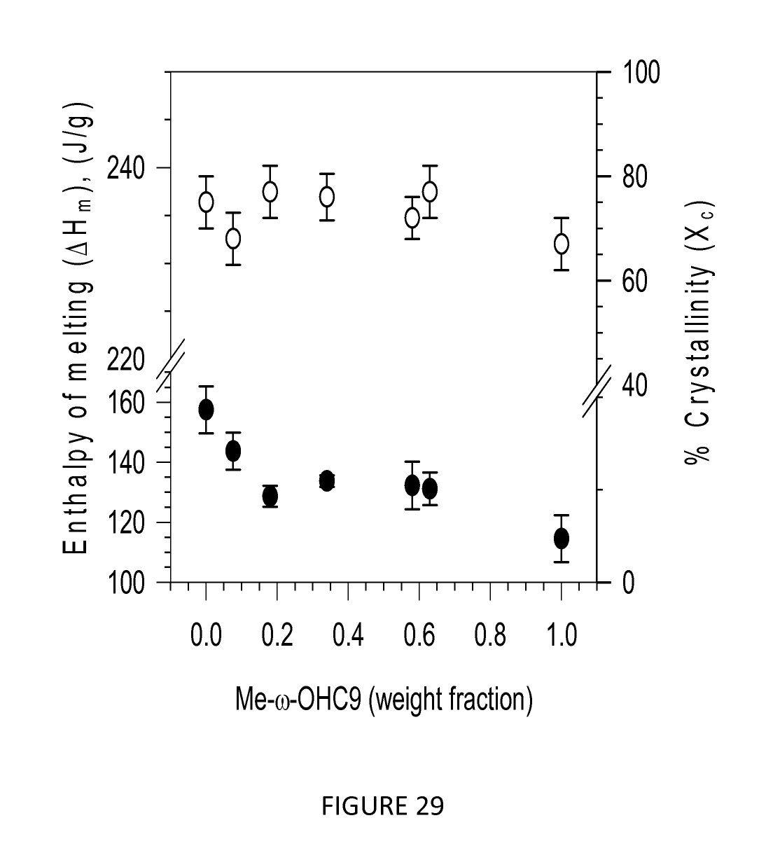

FIG. 29 displays the variation of X_{C} (estimated from WAXD) and ΔHₘ (determined from DSC data) as a function of composition (expressed on a weight basis since results from both techniques depend on the mass of analyzed sample). The experimental data are shown to follow the additive line, indicating the good crystallizing ability of Me-ω-OHC13-/-Me-ω-OHC9 co-polyesters. The value of melting enthalpy per gram of the crystal phase (listed in Table 12) for copolyesters was calculated as the ratio of ΔHₘ (per gram of whole sample, from DSC) to the fractional crystallinity (X_{C}, from WAXD). The enthalpy of fusion of P(-Me-ω-OHC13-/-Me-ω-OHC9-) crystals tends to decrease with increasing (Me-ω-OHC9) comonomer content, as a result of the incorporation of foreign units in the (Me-ω-OHC13) lattice. Upon random copolymerization of (Me-ω-OHC13) with (Me-ω-OHC9), the crystal chain packing remains practically undisturbed. The only relevant effect from a structural viewpoint would be the randomization of the ester group alignment with gradual loss of chain periodicity.

### Thermal Stabilities of Copolyesters:

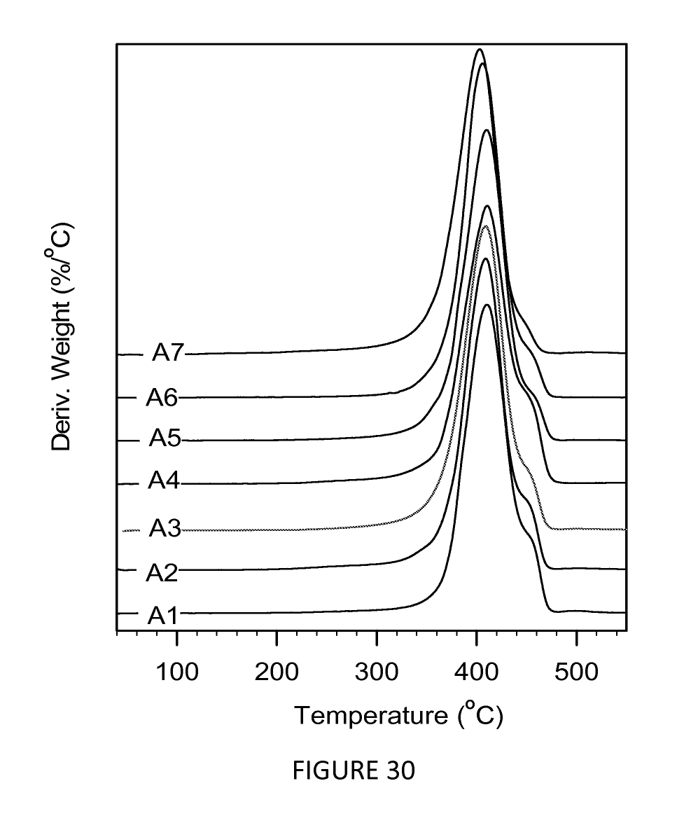

The TGA derivative (DTG) of the homopolymers (A1 and A7) as well as the P(-Me-ω-OHC13-/-Me-ω-OHC9-) co-polymers (A2-A6) displayed (FIG. 30) one prominent peak at around 340° C.-460° C. indicative of a single step degradation process initiated by the random scission of the ester linkage at the alkyl-oxygen bonds.

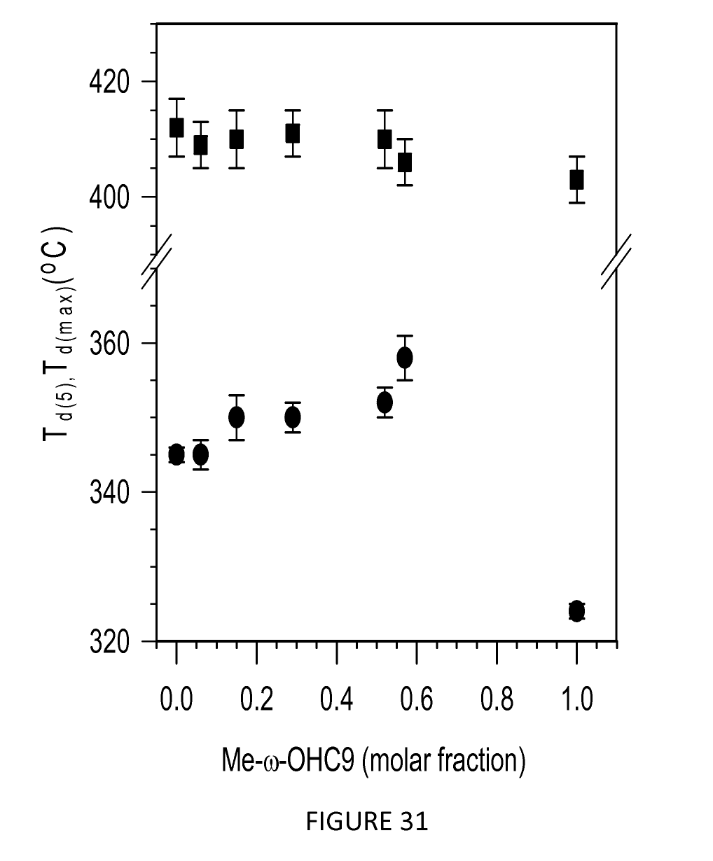

The onset degradation temperature, defined at 5% weight loss (Tₒ)), and the temperature at maximum degradation rate (T_{d(max)}) are listed in Table 13. The onset degradation temperature is a direct measure of thermal stability, and is a crucial parameter for the melt-processing of thermoplastics. The noticeable effect of copolymer composition on T_{d(5)} and T_{d(max)} is illustrated in FIG. 31. The ester group content for the co-polyesters varied from 13% to 17%, i.e. between those of the homopolymers A1 and A7 (Table 11). P(-Me-ω-OHC13-/-Me-ω-OHC9-)s (A2-A6) exhibited higher T_{d(5)} than their respective homopolymers with A6, the polymer having 50% of (Me-ω-OHC9) and 50% of (Me-ω-OHC13) comonomer units, presenting a maximum value (FIG. 31). This is attributable to the randomization effect by ester groups in P(-Me-ω-OHC13-/-Me-ω-OHC9-)s.

TABLE 13
Glass transition temperature (T_{g}) obtained from DMA,
onset temperature of degradation determined at 5% weight
loss from TGA, T_{d(5)}, and peak decomposition temperature
(T_{d(max)}) obtained from the DTG curves for P(—Me-ω-
OHC13—/—Me-ω-OHC9—)copolymers.

| | T_{d (5)} | T_{d (max)} | T_{g} |
|---|---|---|---|
| Sample | (±5° C.) | (±5° C.) | (±2° C.) |
| A1 | 345 | 412 | −36.2 |
| A2 | 345 | 409 | −35.7 |
| A3 | 350 | 410 | −32.9 |
| A4 | 350 | 411 | −31.50 |
| A5 | 352 | 410 | −28.80 |
| A6 | 358 | 406 | −25.6 |
| A7 | 324 | 403 | — |

### Mechanical and Dynamic Mechanical Properties of Copolyesters:

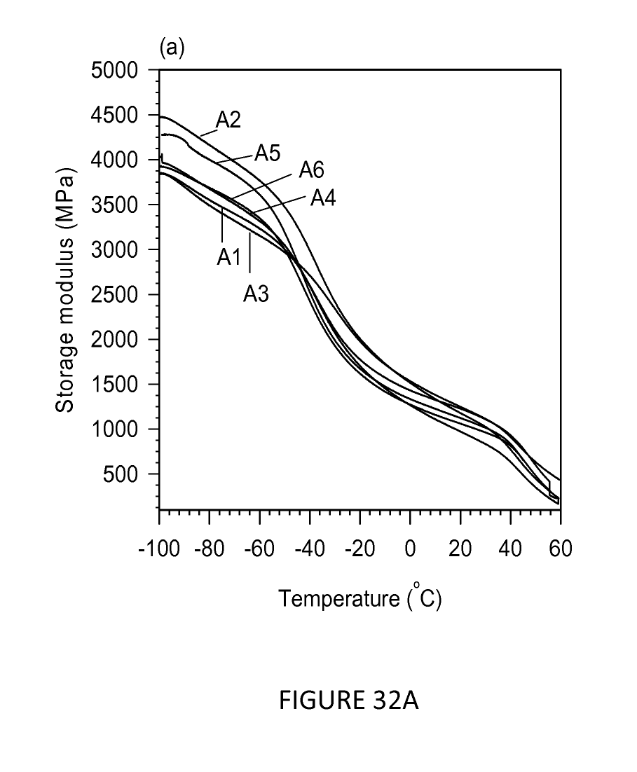

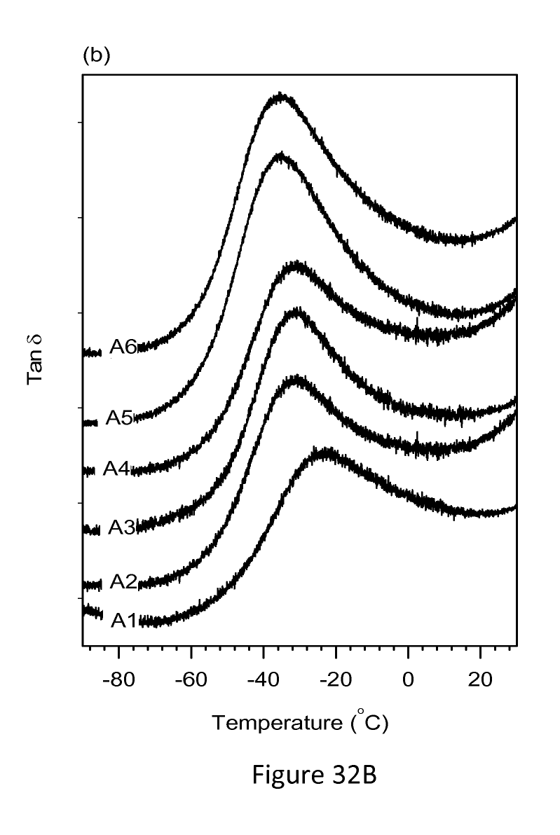

Viscoelastic response, obtained by DMA was used to classify the glass transition temperature of co-polyesters. FIGS. 32A and 32B display the loss modulus and tan δ versus temperature curves, respectively, for P(Me-ω-OHC13) (A1) homopolymer and the P(-Me-ω-OHC13-/-Me-ω-OHC9-) (A2-A6) co-polyesters. P(Me-ω-OHC9) (A7) homopolymer was too brittle to give suitable test specimens.

DMA analysis of the co-polyesters revealed a sharp single glass transition marked by an abrupt decrease of ˜3 GPa in elastic modulus observable between −50 and 0° C. as well as pronounced peaks in tan 6 curves (FIGS. 32A and B).

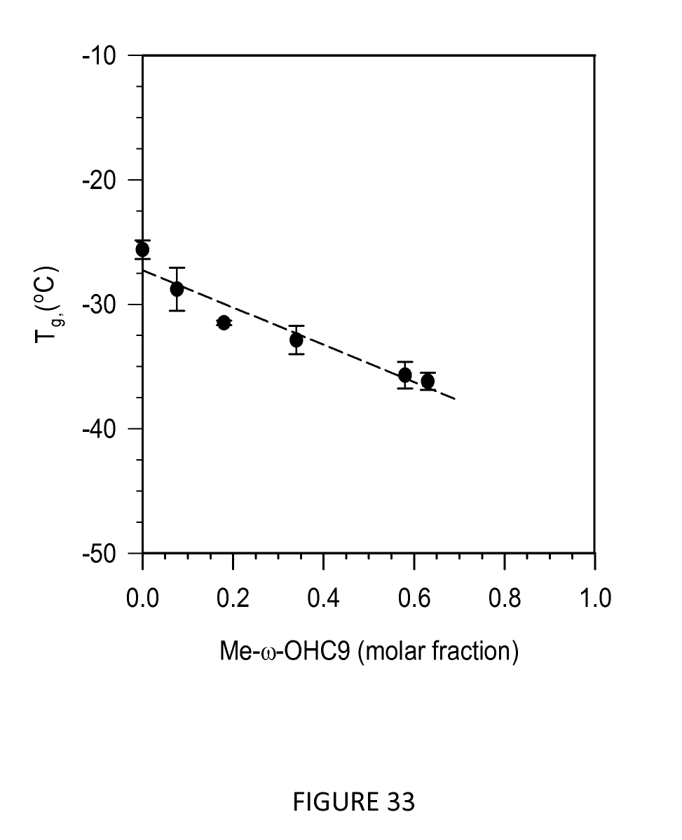

The glass transition temperature (T_{g}) of the co-polyesters determined from the peak value of tan δ curves are listed in Table 3. The T_{g} of copolyesters are in the range of −36° C. to −25° C. (Table 13) indicating that the amorphous regions remain in the ductile state at temperatures very favorable for a large set of high end applications, especially at service temperatures which are required for biomedical polymers. T_{g} of the copolyester decreased linearly with increasing (Me-ω-OHC9) comonomer content (FIG. 33). This is due to the well-known flexibility effect imparted by the increasing number of ester (O—CO) groups. The increase in COO content (wt %) with increasing (Me-ω-OHC9) comonomer concentration in P(-Me-ω-OHC13-/-Me-ω-OHC9-) (Table 11) accounts for the observed variation in T_{g} (FIG. 33).

Low molecular weight P(-Me-ω-OHC13-/-Me-ω-OHC9-) co-polyester samples (A1-A7 with M̅ₙ=9000-19000 g/mol, Table 11) were too brittle to make films suitable for tensile testing. Moldable dumbbell shaped films of P(Me-ω-OHC13)(B1), P(Me-ω-OHC9)(B7) and P(-Me-ω-OHC13-/-Me-ω-OHC9-) (B4) were therefore prepared from samples with a larger chain length distribution (PDI) than the A1-A7 series, and were investigated for mechanical properties (Table 14).

TABLE 14
Physical properties of co-polyesters: composition of the fatty acid mixture in
reactor feed, copolymer composition determined by ¹H-NMR, number average
molecular weight ( M̅_{w}), weight average molecular weight ( M̅ₙ) and PDI of the
copolymers determined from GPC. T_{g} obtained from DMA, X_{C}, estimated from
WAXD, elongation at break (EB), ultimate strength (TS) and Young's modulus (YM)
obtained from tensile analysis.

| | | C13/C9 | | | | | | | | |
|---|---|---|---|---|---|---|---|---|---|---|
| | | molar | | | | | | | | |
| | C13/C9 | ratio in co- | | | | | | | | |
| | molar | polymer | | | | | T_{g} | TS | YM | |
| | ratio in | (from ¹H- | M̅_{w} | M̅ₙ | | X_{C} | (±2° | (±1.5 | (±50 | EB |
| code | feed | NMR) | (g/mol) | (g/mol) | PDI | (±5%) | C.) | MPa) | MPa) | (±1%) |
| B1 | 100:0 | 100:0 | 72604 | 28470 | 2.5 | 51 | −27.8 | 18.3 | 593 | 4.1 |
| B4 | 50:50 | 71:29 | 67717 | 19492 | 3.5 | 68 | −33.5 | 10.3 | 537 | 2.4 |
| B7 | 0:100 | 0:100 | 72147 | 30377 | 2.4 | 55 | −26.8 | 18.4 | 629 | 5.9 |

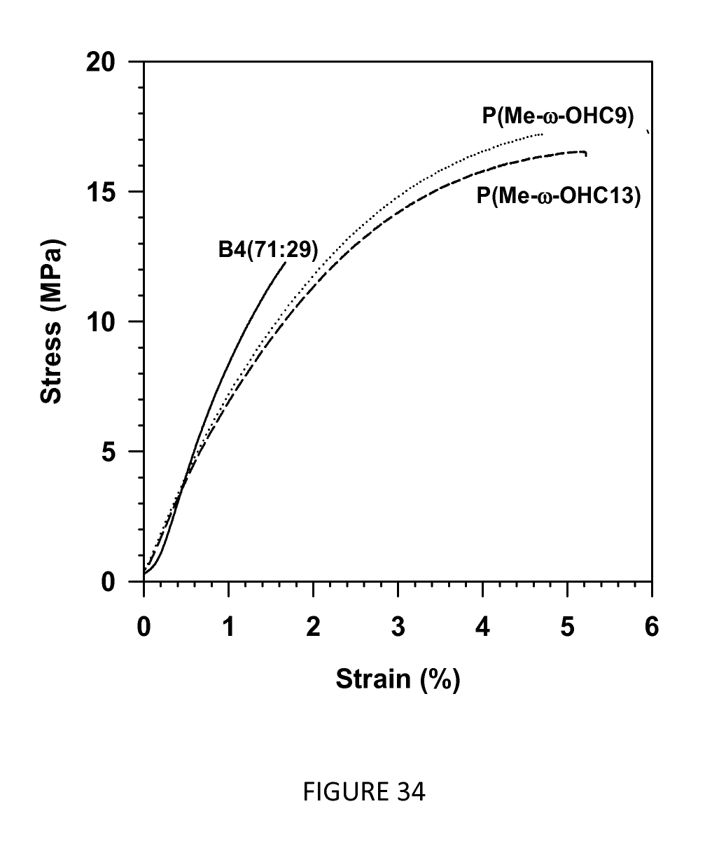

FIG. 34 displays the stress-strain curves of P(Me-ω-OHC9), P(Me-ω-OHC13) homopolymers compared with P(-Me-ω-OHC13-/-Me-ω-OHC9-) (B4). Both the homopolymers, as well as the co-polyester, (B4) exhibited similar stress-strain behavior typical of high modulus and brittle plastics. The stiffness of the co-polyester (B4), represented by its Young's modulus is comparable to that of the homopolymers (±80 MPa) (Table 14). This is explained by the comparable degree of crystallinity (X_{C}) observed for B1, B2 and the B4 co-polyester.

As a general recap, renewable poly(ω-hydroxy nonanoate/ω-hydroxy tridecanoate) [P(-Me-ω-OHC13-/-Me-ω-OHC9-)] random co-polyesters with varying ratios of (Me-ω-OHC13):(Me-ω-OHC9) comonomer units were successfully prepared by melt polycondensation of ω-hydroxy fatty ester monomers derived from vegetable oil. The thermal stability, transition behavior, mechanical properties, and crystallinity, examined by TGA, DSC, DMA and tensile analysis, and WAXD, respectively, were related to the composition of the co-polyesters. Investigation of structure-function relationships revealed composition dependent melting, glass transition and thermal decomposition behavior for P(-Me-ω-OHC13-/-Me-ω-OHC9-)s. These co-polyester systems presents excellent examples of thermally stable random copolymers where the density of hydrolyzable ester groups can be freely changed with varying composition without inducing dramatic changes to crystallinity and the related physical properties.

The above polyesters and copolyesters may be utilized independently and/or incorporated into various formulations and used as functional ingredients in dimethicone replacements, laundry detergents, fabric softeners, personal care applications, such as emollients, hair fixative polymers, rheology modifiers, specialty conditioning polymers, surfactants, UV absorbers, solvents, humectants, occlusives, film formers, or as end use personal care applications, such as cosmetics, lip balms, lipsticks, hair dressings, sun care products, moisturizer, fragrance sticks, perfume carriers, skin feel agents, shampoos/conditioners, bar soaps, hand soaps/washes, bubble baths, body washes, facial cleansers, shower gels, wipes, baby cleansing products, creams/lotions, and antiperspirants/deodorants. The polyesters and copolyesters may also be incorporated into various formulations and used as functional ingredients in lubricants, functional fluids, fuels and fuel additives, additives for such lubricants, functional fluids and fuels, plasticizers, asphalt additives, friction reducing agents, antistatic agents in the textile and plastics industries, flotation agents, gelling agents, epoxy curing agents, corrosion inhibitors, pigment wetting agents, in cleaning compositions, plastics, coatings, adhesives, skin feel agents, film formers, rheological modifiers, release agents, conditioners dispersants, hydrotropes, industrial and institutional cleaning products, floor waxes, oil field applications, gypsum foamers, sealants, agricultural formulations, enhanced oil recovery compositions, solvent products, gypsum products, gels, semi-solids, detergents, heavy duty liquid detergents (HDL), light duty liquid detergents (LDL), liquid detergent softeners, antistat formulations, dryer softeners, hard surface cleaners (HSC) for household, autodishes, rinse aids, laundry additives, carpet cleaners, softergents, single rinse fabric softeners, I&I laundry, oven cleaners, car washes, transportation cleaners, drain cleaners, defoamers, anti-foamers, foam boosters, anti-dust/dust repellants, industrial cleaners, institutional cleaners, janitorial cleaners, glass cleaners, graffiti removers, concrete cleaners, metal/machine parts cleaners, pesticides, agricultural formulations and food service cleaners, plasticizers, asphalt additives and emulsifiers, friction reducing agents, film formers, rheological modifiers, biocides, biocide potentiators, release agents, household cleaning products, including liquid and powdered laundry detergents, liquid and sheet fabric softeners, hard and soft surface cleaners, sanitizers and disinfectants, and industrial cleaning products, emulsion polymerization, including processes for the manufacture of latex and for use as surfactants as wetting agents, and in agriculture applications as formulation inerts in pesticide applications or as adjuvants used in conjunction with the delivery of pesticides including agricultural crop protection turf and ornamental, home and garden, and professional applications, and institutional cleaning products, oil field applications, including oil and gas transport, production, stimulation and drilling chemicals and reservoir conformance and enhancement, organoclays for drilling muds, specialty foamers for foam control or dispersancy in the manufacturing process of gypsum, cement wall board, concrete additives and firefighting foams, paints and coalescing agents, paint thickeners, or other applications requiring cold tolerance performance or winterization (e.g., applications requiring cold weather performance without the inclusion of additional volatile components).

The foregoing detailed description and accompanying figures have been provided by way of explanation and illustration, and are not intended to limit the scope of the invention or the appended claims. Many variations in the present embodiments illustrated herein will be apparent to one of ordinary skill in the art, and remain within the scope of the invention and their equivalents.

What is claimed is:

1. A monomer composition comprising ω-hydroxy esters having the formula of HO—(CH₂)ₙ—COOCH₃, wherein n is between 12 and 17, and further wherein the w-hydroxy esters are selected from the group consisting of methyl-13-hydroxytridecanoate, and methyl-18-hydroxyoctadecanoate.

2. The monomer composition of claim 1, wherein the ω-hydroxy esters may be produced via cross metathesis of an unsaturated fatty acid methyl ester having between 6 and 24 carbon atoms and an unsaturated fatty alcohol having between 8 and 24 carbon atoms.

3. The monomer composition of claim 2, wherein the ω-hydroxy esters comprise methyl-18-hydroxyoctadecanoate produced via the cross metathesis of the unsaturated fatty acid methyl ester comprising methyl oleate and the unsaturated fatty alcohol comprising oleyl alcohol.

4. A monomer composition comprising ω-hydroxy fatty acids having the formula of HO—(CH₂)ₙ—COOH, wherein n is between 12 and 17, and further wherein the ω-hydroxy fatty acids are selected from the group consisting of 13-hydroxytridecanoic acid and 18-hydroxyoctadecanoic acid.

5. A polymer composition derived from monomer units comprising ω-hydroxy esters having the formula of HO—(CH₂)ₙ—COOCH₃, wherein n is between 8 and 17, and further wherein the ω-hydroxy esters are selected from the group consisting of methyl-9-hydroxynonanoate methyl-13-hydroxytridecanoate, and methyl-18-hydroxyoctadecanoate.

6. The polymer composition of claim 5, wherein the composition has a number average molecular weight in the range from about 10,000 g/mol to about 40,000 g/mol, a weight average molecular weight in the range from about 11,000 g/mol to about 85,000 g/mol, and a polydispersity index of about 1 to about 3.

7. The polymer composition of claim 6 comprising the following: (i) a catalyst loading between about 50 to about 500 ppm catalyst, (ii) a polymerization reaction temperature of about 150° C. to about 250° C., and (iii) a polymerization reaction time of about 1 to about 6 hours.

8. A polymer composition derived from monomer units comprising ω-hydroxy fatty acids having the formula of HO—(CH₂)ₙ—COOH, wherein the ω-hydroxy fatty acids are selected from the group consisting of 13-hydroxytridecanoic acid and 18-hydroxyoctadecanoic acid.

9. The polymer composition of claim 8, wherein the composition has a has a number average molecular weight in the range from about 19,000 g/mol to about 31,000 g/mol, and a polydispersity index of about 3 to about 7.

10. The polymer composition of claim 8 comprising the following: (i) a catalyst loading is between about 50 to about 500 ppm catalyst, (ii) a polymerization reaction temperature of about 150° C. to about 250° C., and (iii) a polymerization reaction time of about 1 to about 6 hours.

11. The polymer composition of claim 5, wherein the polymer composition exhibits a WAXD pattern comprising four diffraction peaks, wherein such peaks are characteristic of a crystalline phase and an amorphous phase.

12. The polymer composition of claim 5, wherein the polymer composition comprises: (i) a crystallization onset temperature of between about 60° C. and about 85° C.; (ii) a crystallization offset temperature of between about 69° C. and about 93° C.; (iii) a peak temperature of melting of between about 66° C. and about 91° C.; (iv) an enthalpy of melting of between about 129 J/g and about 183 J/g; and (v) a degree of crystallinity of between about 50% and about 79%.

13. The polymer composition of claim 12, wherein the polymer composition comprises a linear relationship between the degree of crystallinity and the number average molecular weight.

14. The polymer composition of claim 12, wherein when n increases from 8 to 17, the peak temperature of melting increases, to form a stable and thicker crystallization product.

15. The polymer composition of claim 5, wherein the polymer composition comprises: (i) a glass transition temperature of between about −29° C. and about −14° C.; (ii) a glass transition temperature to a peak temperature of melting ratio of between about 0.68 to about 0.73; (iii) a crystallization onset degradation temperature of degradation obtained at 1% weight loss of between about 274° C. and about 346° C.; and (v) a crystallization onset degradation temperature of degradation obtained at 50% weight loss of between about 409° C. and about 433° C.

16. The polymer composition of claim 5, wherein the polymer composition comprises: (i) an elongation at break of between about 1% to about 6%; (ii) an ultimate strength of between about 7 MPa and about 19 MPa; and (iii) a Young's modulus of between about 580 MPa and about 715 MPa.

17. A copolymer composition derived from monomer units comprising ω-hydroxy esters having the formula of HO—(CH₂)ₙ—COOCH₃, wherein n is between 8 and 12, and further wherein the ω-hydroxy esters are selected from the group consisting of methyl 9-hydroxynonanoate and methyl-13-hydroxytridecanoate, individually or in combinations thereof.

18. The copolymer composition of claim 17, wherein the composition has a number average molecular weight in the range from about 9,000 g/mol to about 19,000 g/mol, a weight average molecular weight in the range from about 15,000 g/mol to about 33,000 g/mol, and a polydispersity index of about 1 to about 2.

19. The copolymer composition of claim 17, wherein the polymer composition comprises: (i) a crystallization onset temperature of between about 56° C. and about 76° C.; (ii) a peak temperature of melting of between about 65° C. and about 86° C.; (iii) an enthalpy of melting of between about 107 J/g and about 166 J/g; and (iv) a degree of crystallinity of between about 67% and 77%; and (v) an enthalpy of melting per gram of crystal phase of between about 167 J/g and about 211 J/g.

20. The copolymer composition of claim 17, wherein the polymer composition comprises: (i) an onset degradation temperature at 5% weight loss of between about 319° C. and about 363° C.; (ii) a peak decomposition temperature of between about 398° C. and about 417° C.; and (iii) a glass transition temperature of between about −23° C. and about −39° C.
